(19) United States
(12) Patent Application Publication
(10) Pub. No.: US 2024/0097109 A1
(43) Pub. Date: Mar. 21, 2024

(54) Bottom-Up, Scalable Synthesis Of Oxide-Based Sub-Nano And Nanofilaments And Nanofilament-Based Two-Dimensional Flakes And Mesoporous Powders

(71) Applicant: Drexel University, Philadelphia, PA (US)

(72) Inventors: Michel W Barsoum, Moorestown, NJ (US); Hussein Osama Badr, Philadelphia, PA (US)

(21) Appl. No.: 18/448,593

(22) Filed: Aug. 11, 2023

Related U.S. Application Data
(63) Continuation-in-part of application No. PCT/US2022/070644, filed on Feb. 11, 2022.
(60) Provisional application No. 63/398,782, filed on Aug. 17, 2022.
(60) Provisional application No. 63/373,490, filed on Aug. 25, 2022.
(60) Provisional application No. 63/148,348, filed on Feb. 11, 2021.
(60) Provisional application No. 63/167,197, filed on Mar. 29, 2021.
(60) Provisional application No. 63/171,293, filed on Apr. 6, 2021.
(60) Provisional application No. 63/275,631, filed on Nov. 4, 2021.

(51) Int. Cl. H01M 4/1397; H01M 4/136

(52) U.S. Cl. CPC H01M 4/1397; H01M 4/136; H01M 2004/021

(57) ABSTRACT

Provided are methods to convert—through a bottom-up approach—binary and ternary titanium carbides, nitrides, borides, phosphides, aluminides, and silicides into lepidocrocitic nanofilaments that in some cases self-assemble into 2D flakes by immersing them in a quaternary ammonium solution at moderate temperatures. The resulting flakes can comprise nanofilaments in cross-section, some of which nanofilaments can be few microns long in some instances.

### RELATED APPLICATIONS

The present application is a continuation-in-part of international patent application no. PCT/US2022/070644 (filed Feb. 11, 2022), which international patent application claims priority to and the benefit of U.S. patent application No. 63/148,348 (filed Feb. 11, 2021); U.S. patent application No. 63/167,197 (filed Mar. 29, 2021); U.S. patent application No. 63/171,293 (filed Apr. 6, 2021); and U.S. patent application No. 63/275,631 (filed Nov. 4, 2021). The present application also claims priority to and the benefit of U.S. patent application No. 63/398,782 (filed Aug. 17, 2022) and U.S. patent application No. 63/373,490 (filed Aug. 25, 2022). All foregoing applications are incorporated herein in their entireties for any and all purposes.

### TECHNICAL FIELD

The present disclosure relates to the field of 1D and 2D materials and to the field of metal oxide-based nanomaterials.

### BACKGROUND

One (1D) and two-dimensional (2D) materials offer advantages that their 3D counterparts do not. Historically, the starting point to synthesis of 2D materials in bulk has mostly been layered solids, such as clays, graphite or, more recently, MAX phases. The idea that one can synthesize 2D solids in bulk, from non-layered solids was deemed to be difficult or even impossible. Accordingly, there is a need for 1D and 2D solids, especially for such solids synthesized in bulk from non-layered solids.

### SUMMARY

As an illustration of the disclosed technology, we convert—through a bottom-up approach—example binary and ternary titanium carbides, nitrides, borides, phosphides, and silicides into 2D flakes by immersing them in a tetramethylammonium hydroxide (TMAH) solution at temperatures in, for example, the 25 to 85° C. range. Based on one or more of X-ray diffraction, density functional theory, X-ray photoelectron, electron energy loss, Raman, X-ray absorption near edge structure spectroscopies, transmission and scanning electron microscope images and selected area diffraction, one may conclude that the resulting flakes are C-containing layers that can be comprised of ≈6×10 Å² nanofilaments (in some embodiments) in cross-section, some of which filaments are few microns long. Electrodes made from some of these films performed well in lithium-ion and lithium-sulphur systems. These materials also reduce the viability of cancer cells, thereby establishing use in biomedical applications. Synthesizing two-dimensional (2D) materials that are in turn comprised of 1D entities, at near ambient conditions, with non-layered, inexpensive, precursors (for example, TiC, TiB₂, TiN, and the like) is paradigm-shifting and will provides new avenues of research and applications

In meeting the described long-felt needs, the present disclosure provides a composition, comprising: a plurality of metal oxide (for example, metal oxide-based) nanofilaments and/or subnanofilaments, and optionally an amount of carbon. (As described herein, the nanofilaments can comprise titanium.)

Also provided is a device, the device comprising a composition according to the present disclosure, for example, according to any one of the Aspects provided herein.

Additionally disclosed are methods, comprising operating a device according to the present disclosure, for example, a device according to any of the Aspects provided herein.

Also provided are methods, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting being performed under conditions sufficient to give rise to a nanofilamentous product.

Also disclosed are methods, comprising contacting particulate TiO₂ with a quaternary ammonium salt, the contacting being performed under conditions sufficient to give rise to a nanoparticulate product, the nanoparticulate product optionally at least some nanoparticles having a diameter of from about 2 nm to about 1000 nm, optionally from about 10 to about 100 nm.

Further provided are compositions, comprising a population of nanoparticles made according to the present disclosure.

Also disclosed are methods, comprising replacing TiO₂ with a population of nanoparticles made according to the present disclosure.

Also provided is a method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, and the contacting being performed under conditions sufficient to give rise to mesoporous particles.

Also disclosed is a method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, the contacting being followed by washing with at least one salt and performed under conditions sufficient to give rise to mesoporous particles.

Further provided is a method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting performed while shaking and at a temperature of from about 50 to about 95° C., followed by washing with LiCl to give rise to mesoporous particles.

Also provided are mesoporous particles made according to the present disclosure, for example, according to any one of Aspects 45-47.

Further provided is a composition, comprising mesoporous particles, wherein the mesoporous particles comprise titanium.

Also provided is a method, comprising effecting delivery of a therapeutic to a subject, the therapeutic comprising in a composition according to the present disclosure, for example, according to any one of Aspects 48-49.

Also disclosed is a method, comprising effecting delivery of a therapeutic to a subject, the therapeutic comprising in a composition according to the present disclosure, for example, according to any one of Aspects 48-49.

Further provided is an electrode, the electrode comprising a composition according to the present disclosure, for example, according to any one of Aspects 48-49.

Also disclosed is a device, the device comprising a composition according to the present disclosure, for example, according to any one of Aspects 48-49.

Also provided is a method, the method comprising operating a device according to the present disclosure, for example, according to of any one of Aspects 52-53.

### BRIEF DESCRIPTION OF THE DRAWINGS

The file of this patent or application contains at least one drawing/photograph executed in color. Copies of this patent or patent application publication with color drawing(s)/photograph(s) will be provided by the Office upon request and payment of the necessary fee.

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIGS. 1A-1D. Fabrication process, scanning electron microscope (SEM) micrographs and Density functional theory (DFT) structures. (FIG. 1A) Schematic of fabrication process, (FIG. 1B) Typical cross-sectional SEM micrograph of a TiC-derived filtered film (FF). Note undigested TiC particles in bottom right corner. Inset shows pictures of typical colloidal suspension. (FIG. 1C) Isometric side view of 4 Ti-layered 2D structure with Ti₄O₆C chemistry that best fits XRD and selected area diffraction (SAD) results. Blue, orange, red, and black spheres represent Ti, 2- and 3-fold coordinated 0, and C respectively. Vertical arrow on left denotes approximate dimension; (FIG. 1D) Top view of nanofilaments (nfs) growing in [200] (top) and [110] (bottom) directions. Inset in (FIG. 1D) compares experimental LPs (dashed lines) with DFT predictions (solid lines) as a function of number of Ti layers. Our coordinate system is shown in lower left in c and d.

FIGS. 2A-2D. Characterization of 2D material. (FIG. 2A) XRD patterns, on log scale, of filtered, vertically oriented, Ti₃AlC₂-derived film in transmission mode. Inset shows pattern of horizontally oriented film. 5° 2θ peak is due to Kapton tape. Blue squares are 2θ locations determined from TEM-SAD patterns (Table 3). (FIG. 2B) Raman spectrum of FF obtained from precursors indicated. All powders heated at 50° C. for 3 d and washed with ethanol and water, except the top TiB₂ one that treated at 80° C. for 2d. (FIG. 2C) Core loss electron energy loss spectroscopy (EELS) data measured from 5 individual particles. Graph shows carbon −K edge at ˜280 eV energy loss, titanium −L3,2 peaks at ˜450 eV energy loss and oxygen −K edge at ˜530 eV energy loss. All spectra are normalized to the Ti edge peak intensity and are vertically separated for clarity. (FIG. 2D) XANES results of TiC-derived films together with those for Ti₃AlC₂, TiC and TiCl₃. Both TiC samples were reacted in TMAH at 50° C. for 3d. Inset shows X-ray Absorption Near Edge Structure (XANES) derivative.

FIG. 3A-3D. Titanium carbo-oxide (TCO) Flake morphology. (FIG. 3A) Typical transmission electron microscope (TEM) image of TCO flake>4 μm in lateral size. SAD of area encircled in red is shown in top right inset. Two arcs indicate fiber texture along [110] and [200] directions. Bottom inset is a higher magnification of top left corner showing frayed nanofilaments in a direction that is in accordance with the arcs. (FIG. 3B) Scanning transmission electron microscope (STEM) showing individual filaments, the width of which is ≈10 Å. Bottom inset shows nanofilaments being chemically “drawn out” from a large central Ti₃AlC₂ particle. (FIG. 3C) Atomic force microscope (AFM) of TCO self-assembled nanofilaments derived from TiC heated in TMAH at 80° C. for 3d and washed with water. (FIG. 3D) Same as (FIG. 3C) but after diluting the colloidal suspension 500× and drop cast on glass slide. Inset shows height profile corresponding to blue line in (FIG. 3D); thinnest filaments are ≈1.5 nm high.

FIGS. 4A-4D. (FIG. 4A) Tauc plots of various precursor-derived films. Dashed lines model baseline due to Urbach tail absorption; solid lines are fits to linear parts. Charge-discharge curves of, (FIG. 4B) Voltage profile for Ti₃AlC₂-derived electrode material when tested in lithium-ion batteries (LIBs) at 20 mA g⁻¹; inset shows cyclic voltammogram at 0.1 mV s⁻¹ (FIG. 4C) Charge-discharge curves of TCO cathode at various current rates in lithium-sulfur (Li—S) cell. (FIG. 4D) Cancer cell (see text) viability. Values indicate mean±SD (n=3); *p<0.05.

FIGS. 5A-5F. SEM micrographs of FFs' cross sections after ethanol and LiCl washing made starting with, (FIG. 5A) Ti₃SiC₂, (FIG. 5B) Ti₃AlC₂, (FIG. 5C) Ti₂SbP, (FIG. 5D) TiN, (FIG. 5E) TiB₂, and (FIG. 5F) Ti₅Si₃. Insets show corresponding colloidal suspensions and FFs.

FIGS. 6A-6C. X-ray diffractograms (shifted vertically for clarity) of FF from (FIG. 6A) Parent TiC, Ti₃AlC₂, Ti₃SiC₂ precursors (black lines), and their derived 2D TCO films (red, blue, and green curves, respectively) after washing with ethanol and without sonication. (FIG. 6B) TiC (red, bottom), Ti₃AlC₂ (blue, middle), and Ti₃SiC₂ (green, top) derived films after washing with ethanol then LiCl solution. (FIG. 6C) TiB₂ (red, bottom), TiN (blue, middle), and Ti₅Si₃ (green, top), derived films after washing with ethanol then LiCl solution.

FIGS. 7A-7B. (FIG. 7A) Setup used to obtain XRD patterns from vertically oriented films in transmission mode. Inset shows Kapton tape with drop cast film taped to vertical aluminum sample holder. (FIG. 7B) XRD patterns (shifted vertically for clarity) of vertically aligned ethanol washed FF, derived from precursors indicated. Also shown is pattern of Kapton tape. Asterisks denote peaks belonging to unreacted precursors. In all but one case, precursors were heated in TMAH solution at 50° C. for 3d as described in the materials and methods section. In one case, the TiC powders were immersed in the TMAH at 50° C. for 11d (blue, top). For XRD characterization, 1-1.5 ml of colloidal suspension was drop cast on Kapton tape using a pipette then air dried. Black vertical line at 5° originated from the Kapton tape. Blue lines are guides to the eye to the 2D structure.

FIGS. 8A-8F. Typical TEM images of (FIG. 8A) and (FIG. 8B) TiC-derived flakes (50° C., 3d) (FIG. 8C) Same as (FIG. 8A) but TiC was heated to 80° C. for 3d emphasizing the fibrous nature of our TCO flakes. (FIG. 8D) nanofilaments crystallizing from an amorphous TCO background. Inset reveals high resolution image of crystalline nanofilaments 2-3 nm wide and few microns long. In earlier cases, reaction products were water washed. (FIG. 8E) Ti₃SiC₂-derived flakes (50° C. for 3d, washed with ethanol) captured from crushed FF. (FIG. 8F) Nanofilaments appearing to be chemically “drawn” from Ti₃AlC₂ phase (dark particle in center) (50° C., 3d; washed with ethanol and water). Insets show SAD pattern from area bounded by red circles. Inset in f show both faint rings (from TCO) and MAX phase spots.

FIGS. 9A-9B. (FIG. 9A) TEM and (FIG. 9B) AFM micrographs of TiC-derived material (80° C. for 5d and water washed). AFM samples were spin-coated on glass slides from initial suspension after dilution.

FIGS. 10A-10B. (FIG. 10A) 6-layered structure. Slab thickness is ≈8 Å. (FIG. 10B) Phonon density of states of 4-layered structure shown in FIG. 1c.

FIG. 11. Post LiCl-washed XPS spectra of Ti 2p region (1^{st} column), C 1s region (2^{nd} column), O 1s region (3^{rd} column) and Fermi edge (4^{th} column) obtained from TiC-(1^{st} row, top), Ti₃AlC₂-(2^{nd} row), Ti₃SiC₂-(3^{rd} row), TiN—(4^{th} row), TiB₂—(5^{th} row), and TiO₂-based (6^{th} row) films. Peak fits and results are summarized in Tables 4 and 7. Dashed vertical lines are guides to the eye.

FIGS. 12A-12B. XPS spectra as a function of processing in Ti 2p region (1^{st} column), C 1s region (second column), O 1s region (third column), and Fermi edge (last column) of, (FIG. 12A) Ti₃AlC₂-based and, (FIG. 12B) Ti₃SiC₂-based filtered films. Dashed vertical lines are guides to the eye. The positions of Ti peaks appear to be insensitive to solution used to wash the films and even after heating to 800° C. in Ar in the Ti₃AlC₂ case (compare top spectra in blue to those below them in a).

FIGS. 13A-13E. XPS spectra of TCO FF for (FIG. 13A) N 1s and, (FIG. 13B) Cl 2p regions derived from TiC (black, bottom), Ti₃AlC₂ (red, second from bottom) Ti₃SiC₂ (blue, third from bottom), TiN (green, third from top), TiB₂ (purple, second from top) and TiO₂ (yellow, top) powders, (FIG. 13C) Si 2p spectra the Ti₃SiC₂-derived FF, (FIG. 13D) Al 2p spectra for Ti₃AlC₂-derived FF, (FIG. 13E) B is spectra for TiB₂-derived FF. All samples were washed with ethanol and LiCl before filtration, followed by vacuum drying before XPS analysis.

FIGS. 14A-14B. Thermogravimetric plots for, (FIG. 14A) All samples, ramped at 10° C./min to 800° C. in Ar. Sample labeled ethanol was washed with ethanol; those labeled LiCl were first washed with ethanol and then with a LiCl solution. (FIG. 14B) TiC-derived film heated in air to 800° C.; c) Mass spectrometry results for b. Up to ≈400° C., most of gas released is water. After 400° C., CO₂ is released. Dashed black vertical line is a guide to the eye.

FIG. 15. Rietveld analysis of XRD diffractograms of LiCl washed filtered films heated to 800° C. in Ar. The χ² values are listed on figures. Results are summarized in Table 8. Purple lines are differences between fits in red and experimental results in black.

FIGS. 16A-16B. (FIG. 16A) XRD diffraction patterns of TiO₂-derived material heated in TMAH for times and temperatures indicated on figure. In the 2D the (104 and (105) peaks are absent and the 63° peak is shifted towards 60°. (FIG. 16B) TEM of nanoparticles in the range of 20 nm. Insets show high magnification image and SAD pattern of the obtained TiO₂ nanoparticles.

FIGS. 17A-17D. Electrochemical performance of Ti₃AlC₂-based TCO as electrode materials in Li-ion battery. (FIG. 17A) Electrochemical impedance spectroscopy Nyquist plot at open circuit potential, (FIG. 17B) specific capacity vs. cycle number and specific currents indicated. (FIG. 17C) Voltage profile at specific current of 100 mA g⁻¹. (FIG. 17D) Specific capacity and Coulombic efficiency vs. cycle number for cell shown in c.

FIGS. 18A-18B. Electrochemical characterization of TiC-based FF electrode in Li—S cell: (FIG. 18A) CV curves, (FIG. 18B) Cycling stability at 0.2 C. S-loading is 0.8 mg. Capacity was, more or less, constant at ≈1000 mAh/g for about 300 cycles before fading.

FIG. 19 provides images of exemplary mesoscopic materials according to the present disclosure.

FIGS. 20A-20C: FIG. 20A XRD patterns of 2 samples one washed with ethanol; the other washed with ethanol and then 0.5 M LiCl (see Methods Section). Positions of the (200) and (002) peaks at 2θ≈48° and ≈62° are crystallographic and not processing invariant. The positions of all other peaks are. Note log scale on y-axis. Yellow bands outline the three arcs/rings observed in SAD patterns of 2D flakes in TEM. FIG. 20B Schematic of DFT generated structure with TiO₂-ribbons stacked normal to b-axis. Also traced are all non-basal planes predicted. Rectangle on bottom right denotes a unit cell with lattice parameters a and b. Note while a is crystallographic, b is not and depends on spacing between ribbons here chosen to 7.5 Å. The same is true of stacking along 001. FIG. 20C provides a schematic of (001) plane assuming it is 2 Ti atoms wide. Spacing between 2 adjacent Ti atoms, along c, or d₀₀₂ is ≈1.5 Å, which gives rise to peak ≈62° 2θ seen in diffraction and SAD pattern. Also shown in b and c are the approximate “thicknesses”—measured from outermost O to outermost O—of 2-atom thick Ti ribbons.

FIG. 21: Raman spectra of 6 samples that were washed differently. In all cases the resulting spectra were consistent with those of lepidocrocite. Inset shows effect of laser power on spectra. At high power, the material transforms from lepidocrocite to anatase. The 10, 50 and 100% laser powers correspond to 6, 29 and 52 mWcm⁻², respectively.

FIG. 22: ABF TEM micrograph of a bundle of individual 1DL NFs oriented along the fiber axis. Lower left inset is FFT of region outlined by blue square. Superimposed on the FFT, as red circles, are the indices predicted after the spacing of layers along b was chosen to be 7.5 Å. Agreement is excellent. Lower right inset shows schematic of lepidocrocite layers (not to scale) stacked along the b-axis. Growth direction is along [200], which coincides with bundle axis. Inset top left is SAD pattern generated by software assuming distance between ribbons along b is 7.5 Å. Planes outlined in FIG. 20B are denoted by red arrow. Inset top right is HAADF image of region shown in figure. Precursor was TiB₂, reacted in TMAH for 5 days at 80° C.

FIGS. 23A-23B: Low angle annular dark field TEM micrograph of same sample as shown in FIG. 3 at, FIG. 23A low magnification, and FIG. 23B higher magnification of region enclosed in green square in a. Scale bar in 5 nm. Zig-zag nature of Ti atoms in the nanoribbons in area enclosed by red circle is obvious. Their 2-layered nature is also.

FIG. 24: ABF TEM micrograph of same sample as in FIG. 22, but focusing on different regions. Top inset is FFT produced from blue square showing diffuse rings with no clear diffraction spots. Lower inset is FFT taken from green square showing clear diffraction spots indicating the region is largely crystalline.

FIG. 25: LAADF TEM (left) of a loose NF bundle derived from TiC; (right) Magnified view of dashed regions in a shows crystalline contrast the NFs. A region of well-ordered NFs shows atomic column contrast consistent lepidocrocite oriented along [100].

FIG. 26: Tauc plots as a function of various washing procedures.

FIGS. 27A-27D: Scalable synthesis of nanofilaments-based mesoporous particles. FIG. 27A—Schematic of (a) Temperature-controlled shaking incubator used to convert TiB2 precursor powder into nanofilaments-based mesoporous particles. FIG. 27B—Washing protocol followed to remove any unreacted TMAH salt. FIG. 27C—DFT-generated lepidocrocite structure showing 2 Ti atoms-thick ribbons growing along [100] and stacking along [010] (viz., a and b crystallographic directions, respectively). FIG. 27D—Various cations (both mono and divalent ones) intercalation in the interfilamentous gallery.

FIGS. 28A-28D: 28A XRD patterns—on log scale—of TiB2 precursor powder (top black curve), as well as samples reacted for 1 d to 5 d then washed with ethanol before they were dried at 50° C. in air overnight. The peaks at ≈26°, 48° and 62° 2 θ correspond to 110, 200 and 002 planes of lepidocrocite, respectively. These values correspond 3 arcs/rings observed in SAD patterns of 1DLs in TEM. The 0k0 peaks are denoted by asterisks. Dashed black lines denote TiB2 diffraction peaks. FIG. 28B-FIG. 28D SEM micrographs—at various magnifications—of mesoporous particles after 5 d of reaction. Inset in (b) shows MPPs size distribution obtained using ImageJ from the micrograph. FIGS. 34A-34F show more SEM images.

FIGS. 29A-29H: 29A STEM imaging of mesoscopic particle from TiB2-derived sample shook in TMAH at 80° C. for 5 d, washed with ethanol, then dehydrated at 50° C. overnight in open air. FIG. 29B and FIG. 29C LAADF STEM micrographs—at various magnification—of bundles of 1DL nanofilaments oriented along the fiber axis. Inset in FIG. 29B shows FFT of produced from area bounded by yellow square. FIG. 29D FIG. 29H provide an EDX elemental map of mesoscopic particle shown in inset in FIG. 29A.

FIGS. 30A-30K: Characterization of mesoporous particles, FIG. 30A FIG. 30C XRD patterns and FIG. 30D-FIG. 30K provide SEM micrographs, prepared by shaking TiB2 precursor powder in TMAH solution at 80° C. for 5 d, washing with solvent/solutions labeled on the panels, then letting to dry at 50° C. in open air.

FIG. 31: ζ-Potential (left y-axis) and average hydrodynamic size (right y-axis) of TiB2-derived samples shook in TMAH at 80° C. for 5d then washed with solvents/solutions labeled on panel.

FIGS. 32A-32F: SEM micrographs, at various magnifications, of samples after reaction for (FIG. 32A, FIG. 32B, FIG. 32C) 1 day, and (FIG. 32D, FIG. 32E, FIG. 32F) 5 days. Samples were reacted in TMAH at 80° C. then washed with ethanol before drying at 50° C. in ambient air. Micrographs after reaction for 2, 3 and 4 d are shown in FIG. 44 and are no different than the ones shown here.

FIGS. 33A-33B: Location of reaction and morphology. FIG. 33A NFs form at the solid/liquid interface by the formation of TiO₆ octahedra and their attachment to the bottom of the growing NF. FIG. 33B Effect of washing procedures on final morphology.

FIGS. 34A-34F: SEM micrographs, at various magnifications, of samples washed with ethanol, then dried overnight in open air at 50° C. All samples were reacted for 5 d at 80° C. in shaker.

FIGS. 35A-35F: SEM micrographs, at various magnifications, of samples washed with ethanol, then a LiCl 0.5 M aqueous solution and lastly water, before allowing them to dry in open air at 50° C. overnight. All samples were reacted for 5 d at 80° C. in shaker.

FIGS. 36A-36F: SEM micrographs, at different magnifications, of samples washed with ethanol, then immersed in 5M NaCl aqueous solution, and water, before allowing them to dry in open air at 50° C. overnight. All samples were reacted for 5 d at 80° C. in shaker.

FIGS. 37A-37G: HAADF imaging and EELS elemental mapping of MPPs obtained after ethanol washing. FIG. 37A HAADF imaging of bundles of NFs from which EELS maps were acquired. 37B HAADF image acquired simultaneously with the element maps. No observable changes in the morphology were observed in subsequent scans. FIG. 37C Elemental composition collected from area outlined with dashed box in (b) and were calculated using a Hartree-Slater model. FIG. 37D-37G EELS elemental maps of Ti, O, C, and N respectively.

FIGS. 38A-38C: 38A XRD patterns of samples before and after ion exchange with salt aqueous solutions labeled on panels. FIG. 38B-38C same as FIG. 38A, but after ethanol washing the powders were further treated in LiCl aqueous solution, then stirred in aqueous solutions of salts labeled on panels. Vertical dashed blue line aligned—across panels—at ˜9.5 Å designating d-spacing of the LiCl washed sample. Vertical dashed black lines/grey band designate the lowest and highest d-spacing values for the 110 non-basal reflection with respect to various intercalants between the NFs. Vertical red dashed lines/bands refer to the 200 and 002 lepidocrocite reflections at 2θ values of ˜48° and 62°, respectively. Asterisks denote peaks of unreacted TiB2 that we use as internal standard to align the XRD patterns.

FIGS. 39A-39B: Characterization of mesoporous particles, FIG. 39A XRD patterns and FIG. 39B SEM micrograph, prepared by shaking TiB2 precursor powder in TMAH solution at 80° C. for 5d, washed with ethanol till neutralization, stirred directly in solutions labeled on the panels, then let to dry at 50° C. in open air. Note log scale on the y-axis.

FIGS. 40A-40C: FIG. 40A and FIG. 40B Still frames of ethanol washed powders that are dispersed in ethanol and water, respectively. FIG. 40C Same as FIG. 40A but for powders that were treated in LiCl aqueous solution then dispersed in water.

FIGS. 41A-41B. FIG. 41A and FIG. 41B AFM scans of colloidal suspensions (obtained by heating TiC in TMAH at 80° C. for 3 d, washed with ethanol till neutralization, then dispersed in water before and after dilution 500×, respectively, then drop casting on a glass slide. Inset shows height profile corresponding to blue line in (d); thinnest filaments are 1.5 nm high. The figure is reproduced from Mat. Today, Elsevier with permission (license number 5591960829133).F

FIGS. 42A-42C. 4 FIG. 2A Thermogravimetric plots for MPPs prepared by shaking TiB2 in TMAH solution at 80° C. for 5d, then washed with ethanol till neutralization. Some samples were further treated in LiCl or NaCl solution then rinsed with water. All powders were let to dry at 50° C. in open air. Vertical dashed lines are guides to 200° C. and 400° C. FIG. 42B-42C XRD patterns for MPPs processed with conditions labeled on the panels. All TGA powders ramped at 10° C./min to 800° C. in Ar. Black and blue asterisks in FIG. 42B and FIG. 42C denote anatase and rutile, respectively, obtained after TGA. Vertical arrows on middle green line in 42C denotes Li2Ti2O4, while those on bottom red line denotes Na₂Ti₆O₁₃ obtained after TGA.

FIGS. 43A-43F: FIG. 43A-43C SEM micrographs of TiB2-derived mesoporous particles (washed with ethanol and dried at 50° C. in open air) heated under Ar up to 200° C. (denoted by red curve in FIG. 42B. FIG. 43D-43F Same as FIG. 43A-43C but for powders heated up to 800° C. (denoted by green curve in FIG. 42B).

FIGS. 44A-44I: SEM micrographs, at various magnifications, of samples after reaction for (FIG. 44A, 44B, 44C) 2 day, (FIG. 44D, 44E, 44F) 3 days, and (FIG. 44G, 44H, 44I) 4 days. Samples were reacted in TMAH at 80° C. then washed with ethanol before drying at 50° C. in ambient air.

FIGS. 45A-45B: SEM micrographs revealing TiB2 particles transforming into 1DL NFs via localized corrosion. Samples were reacted in TMAH at 80° C. for 3d then washed with ethanol before drying at 50° C. in ambient air.

Table 1 provides sources of example powders and reagents used in this work.

Table 2 provides a summary of example precursors, Ti:TMAH mole ratios, and synthesis conditions.

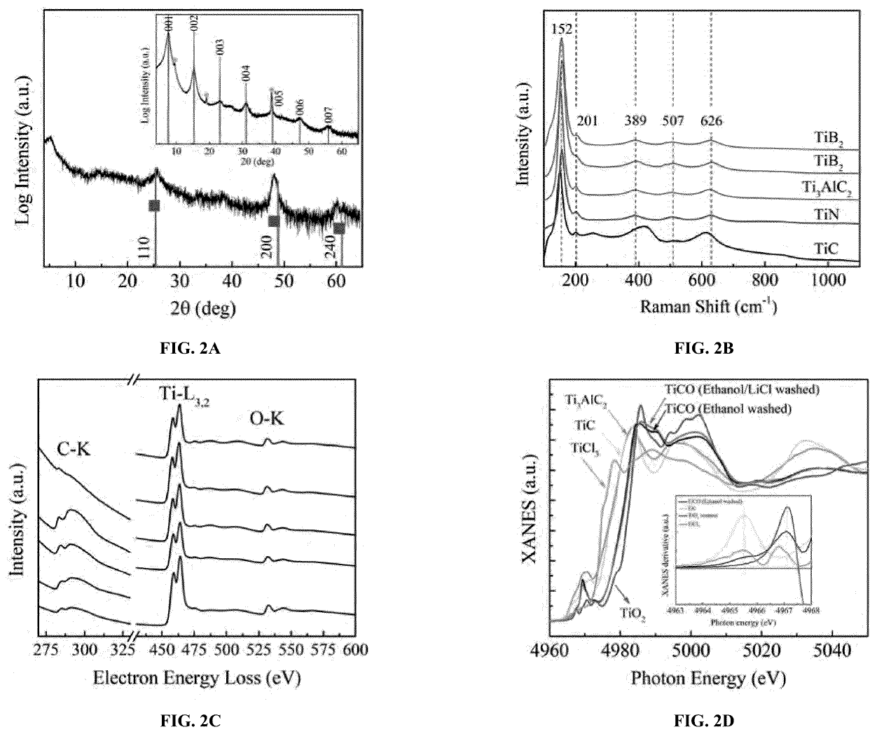

Table 3 provides a summary of interlayer spacing (d) values and the corresponding diffraction angle (2θ) acquired from XRD pattern shown in FIG. 2A and their comparison to those obtained from 7 different SAD patterns obtained from 5 different samples. All samples derived from parent TiC heated at 50° C. then washed with ethanol and water.

Table 4 provides a summary of fitting of XPS results shown in FIG. 11.

Table 5 provides chemistries of 5 different flakes deduced from EELS measurements shown in FIG. 2C. Last row suggests possible chemistries where X sum of O, C and N. Flakes were prepared by dry rubbing filtered films made by heating TiC powders in TMAH for 3d at 50° C., then washed with ethanol.

Table 6 provides chemistries of number of flakes from different precursors deduced from EDS measurements. Last row suggests possible Ti:O ratios of these samples. SEM-EDS measurements were obtained from cross-sections of filtered films made of the precursor Ti₃AlC₂, Ti₃SiC₂, Ti₃GaC₂ powders reacted with TMAH at 50° C. for 72 h and washed with ethanol then a LiCl solution. TEM-EDS measurements were conducted on samples prepared by dry rubbing Ti₃SiC₂- and TiB₂-derived filtered films made by reacting the powder with TMAH at 50° C. for 72 h and washing with ethanol.

Table 7 provides Ti:O chemistries obtained from the Ti area under ≈459 eV peak and O under ≈530 eV peak shown in FIG. 11.

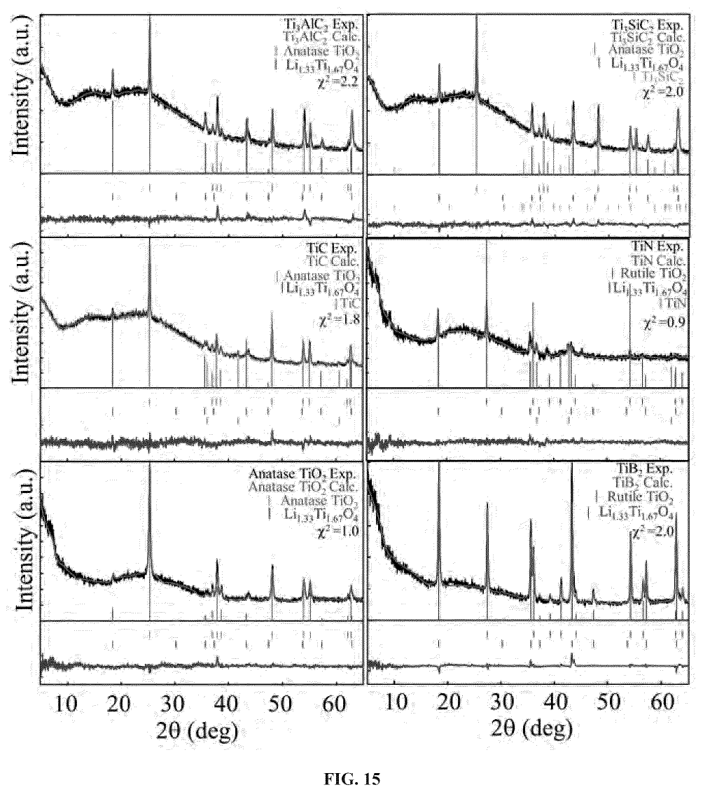

Table 8 provides a summary of Rietveld analyses of filtered films after heating in Ar to 800° C. Corresponding XRD patterns are plotted in FIG. 15.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (for example, “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

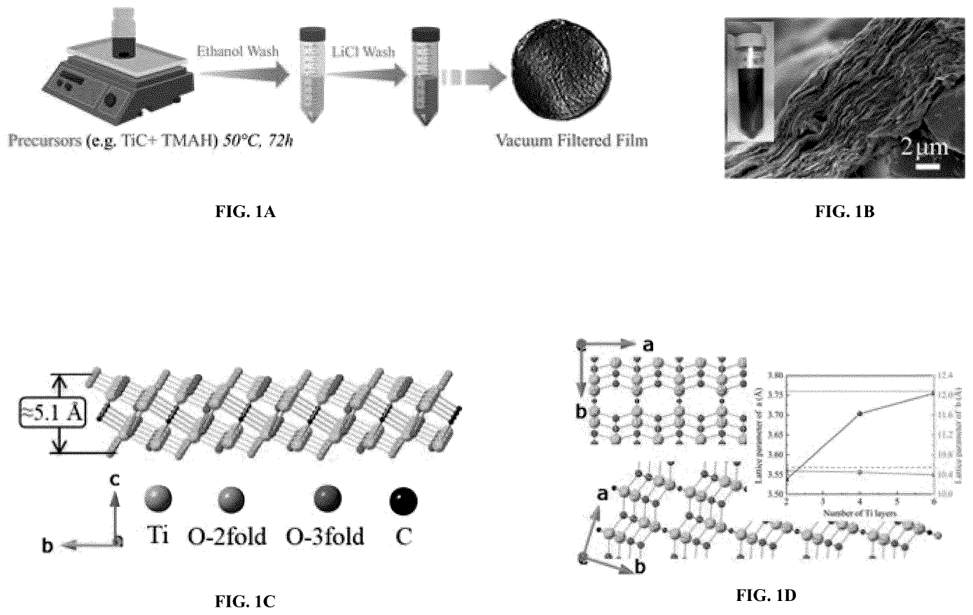

In all cases, except when TiO₂ was the precursor, 2D flakes were obtained. A typical cross-sectional scanning electron microscope (SEM) image of a TiC-derived film (FIG. 1b) clearly showed the 2D nature of the FFs. This micrograph is especially revealing in that it shows both undigested TiC particles (bottom right) and flakes. A colloidal suspension, with concentrations in the 10 g/L range, is shown in inset in FIG. 1b. SEM images of other films are shown in FIG. 5. The FFs varied in color from light to dark gray. The fact that these flakes can be synthesized from non-layered precursors and result in FF that are structurally and chemically similar is strong evidence for a bottom-up approach. In our interpretation, TMAH acts as a near-universal solvent that dissolves the precursor and releases Ti atoms that spontaneously react with C and O in the TMAH/water to form 2D flakes comprised of self-assembled nanofilaments (see below). The TMAH role is thus twofold: solvent and templating agent.

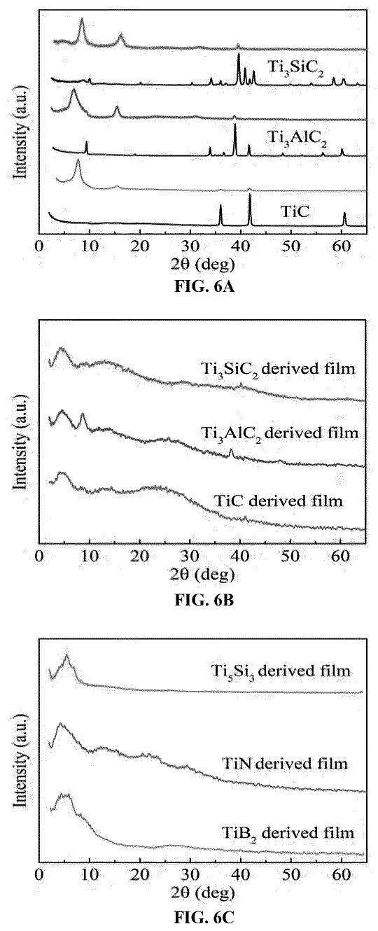

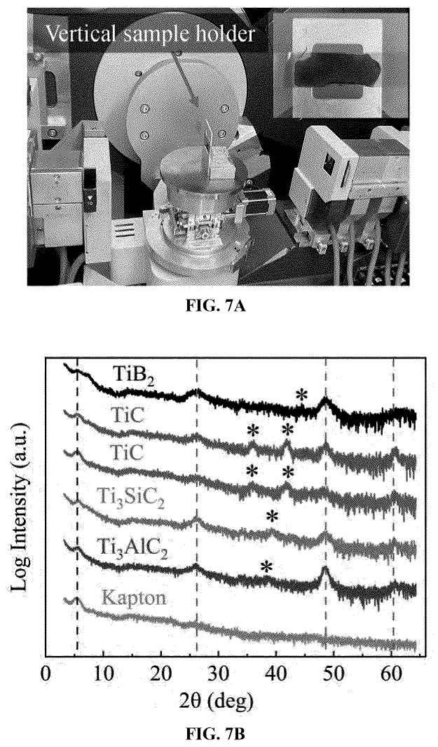

A X-ray diffraction (XRD) pattern of a Ti₃AlC₂-derived film after ethanol washing (inset in FIG. 2a) is typical of 2D materials. XRD patterns of dry FF obtained from other precursors are shown in FIG. 6. The absence, for the most part, of peaks associated with the precursors is noteworthy. To gain insight into the underlying structure we obtained XRD patterns (FIG. 2a) on a vertically oriented FF (see FIG. 7a) that was obtained after heating Ti₃AlC₂ for 3 days at 50° C. then washed with ethanol and water.

The red vertical lines were obtained as follows: First, the c-lattice parameter, LP, was calculated from horizontally oriented film (inset in FIG. 2a). The structure shown in FIG. 1c was then used to calculate the position of all peaks. All planes with non-zero [symbol] indices were eliminated, leaving the red lines. The good agreement between the density functional theory (DFT) generated LPs and the experimental ones (inset in FIG. 1d) lends credence that we are dealing with a 4 Ti-layered 2D material (see below). Patterns for other vertically oriented films, derived from other precursors, are shown in FIG. 7b. In all cases, peaks—with identical angles—were obtained. This demonstrates that precursor chemistry does not alter the structures formed, including their LPs.

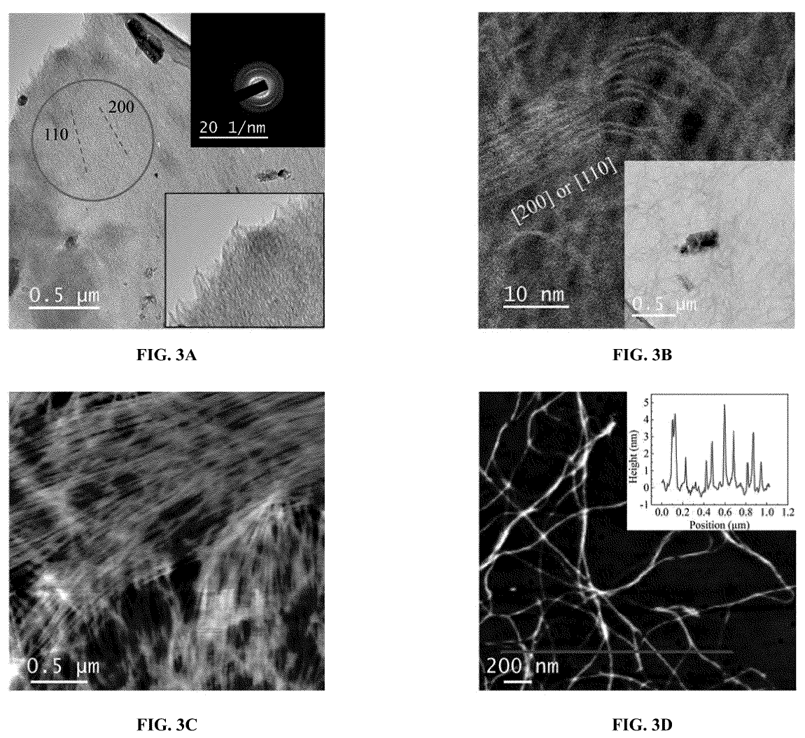

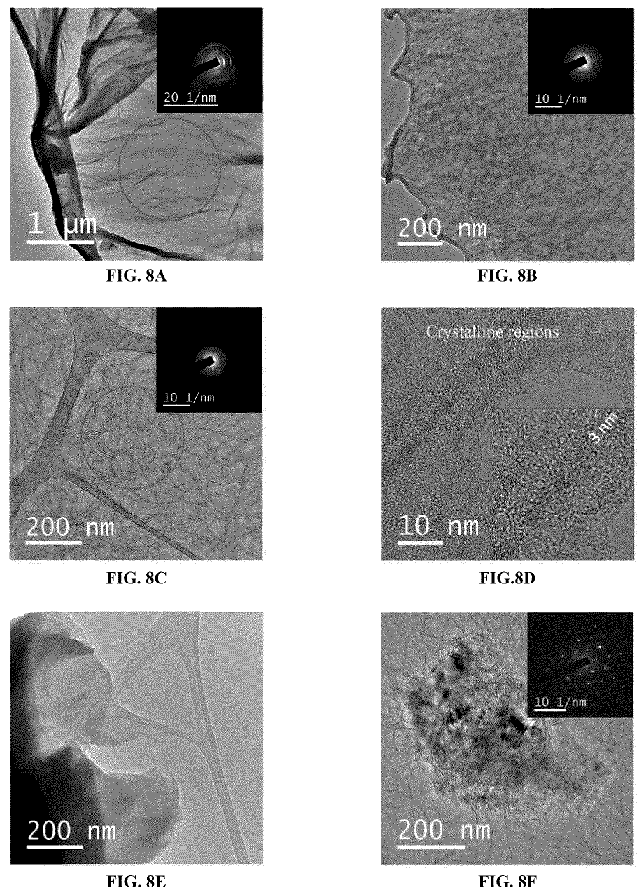

Transmission electron microscope (TEM) images of TiC-, Ti₃SiC₂-, and Ti₃AlC₂-derived flakes revealed the presence of 2D flakes>1 μm in lateral sizes (FIG. 3a; FIG. 8). Selected area diffraction, SAD, of the latter in some regions resulted in 3 main rings (see insets in FIGS. 8b and c). When the ring d-spacings were converted to 2θ values (blue squares in FIG. 2a) good agreement with the XRD peaks was found confirming our SAD patterns are representative (For more results see Table 3). In other regions, two sets of arcs (insets in FIG. 3a and FIG. 8a) were observed. One set of arcs indicated that the long axis of the nanofilaments is in the [110] direction; the other in the [200] direction. The angle between them is shown in both inset and main micrograph. They are in the same directions as the frayed fibers seen at the sheet edges in top left. Note that the locations where arcs were observed were limited. The regions where three rings were observed were much more ubiquitous, which implies the presence of smaller NFs that are pointing in all directions.

The scanning transmission electron microscope (STEM) micrograph (FIG. 3b) clearly shows the fibrous nature of the sample. The width of individual nanofilaments is estimated to be ≈1 nm. Since their thickness is ≈5.9 Å, it follows that we are dealing with nanofilaments roughly 6×10 Å² in cross-section that can be micrometers long (see inset in FIG. 3b and FIG. 8c). Other TEM micrographs are shown in FIG. 8. We note in passing theoretical surface area of these nanofilaments is ≈1500 m²/g.

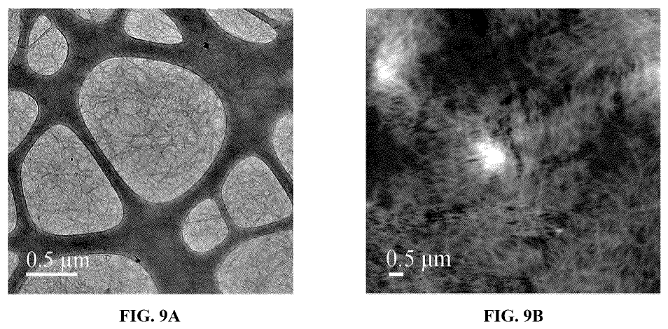

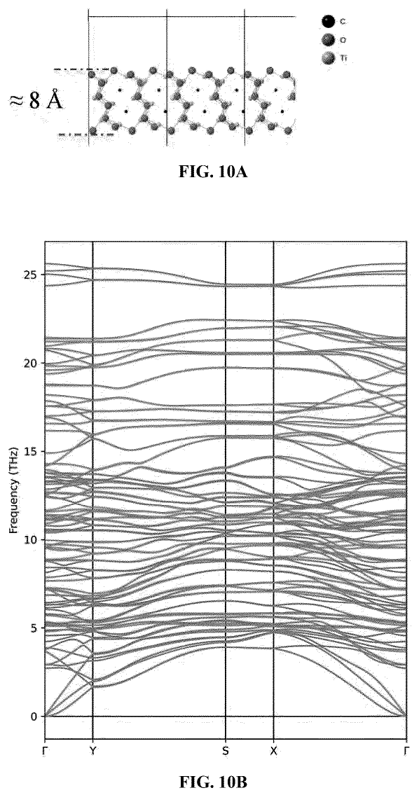

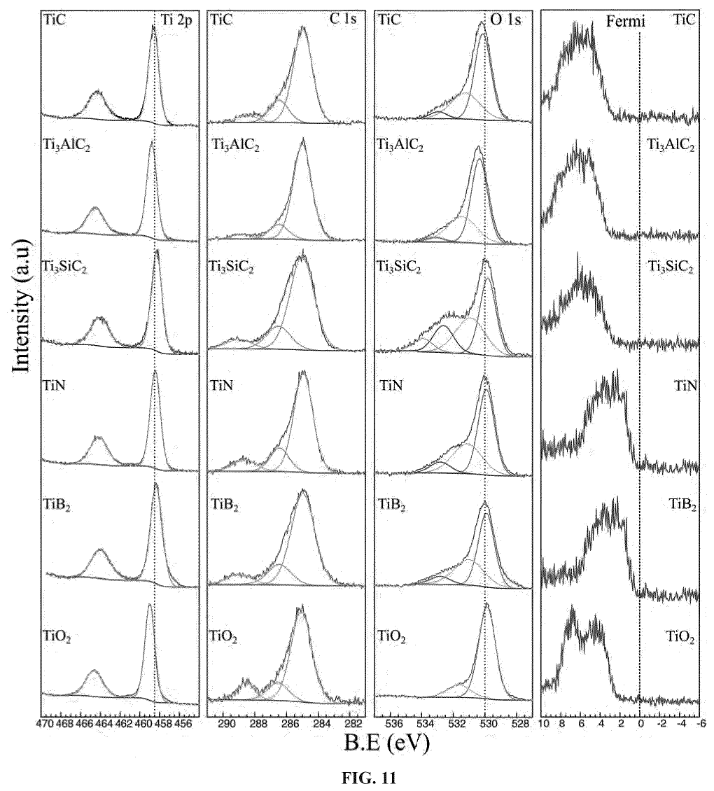

FIG. 3c and FIG. 9 show TEM and atomic force microscope (AFM) maps of a TiC-derived sample (5d at 80° C., water washed), spin coated on glass. The fibrous nature of the product and its tendency for self-alignment are obvious. When the same suspension was diluted 500× and drop cast individual nanofilaments separated (FIG. 3d). An AFM trace along the blue line in FIG. 3d shows that the thicknesses, or heights, of the smallest ribbons were ≈1.5 nm (inset in FIG. 3d).

To determine the number of Ti-layers per filament, we used first-principles calculations to predict the LPs. For this, relaxations were performed for three supercell structures consisting of 2- (not shown), 4- (FIG. 1c), and 6-Ti (FIG. 10a) layers, with the lowest energy (101) surfaces bounding the top and bottom. We then replaced every 2 O atoms by a C atom in the slab centers for an overall chemistry of TiO₂₋₂ₓCₓ where x is 0.25 or Ti₄O₆C. This was done to account for structural C and render the structure dynamically stable (FIG. 10b). All other configurations resulted in dynamic instabilities. As shown in inset in FIG. 1d, the LPs of the b axes of the three structures are in good agreement with experimental values especially given that the DFT calculations were performed at 0 K. However, a large increase in the a-LP is observed—that is closer to the experimental values—when the number of Ti layers increases to 4 or 6 (blue curves in inset in FIG. 1d). The thicknesses of the 4- and 6-layered structures are ≈5.9 Å and ≈8 Å, respectively. The diameter of a TMA cation ranges from 4.5-6 Å. Using the low end, the d-spacing between filaments for the 4- and 6-layered structures would be 10.4 Å and 12.5 Å, respectively. Using the high end, results in a d-spacing (11.9 Å) for the 4-layered structure that agrees quite well with the 11.5 d-spacing obtained from XRD (inset in FIG. 2a and FIG. 6a). Said otherwise, the experimental value is consistent with a 4-layered structure; the 6-layered one is too thick.

Raman Spectroscopy of a Number of FFs (FIG. 2b)

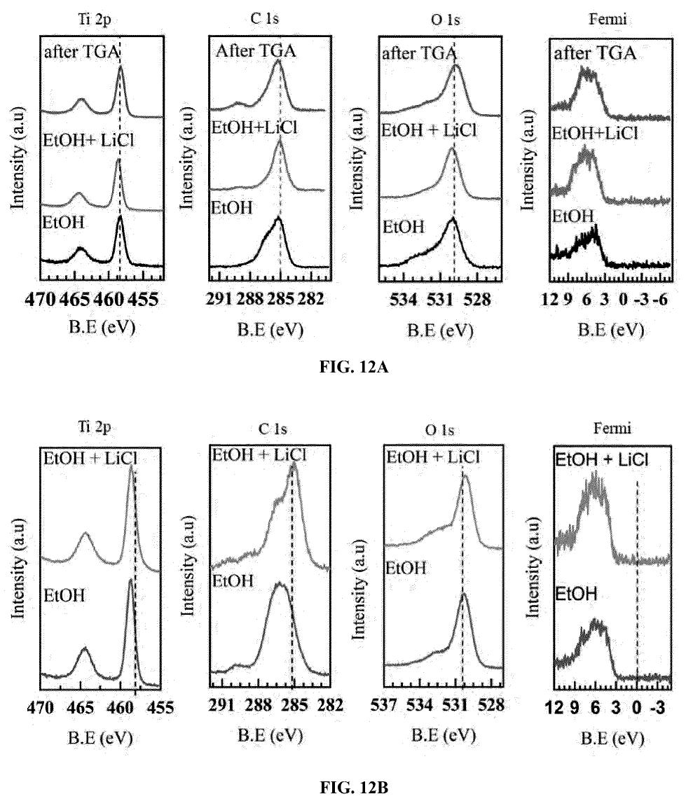

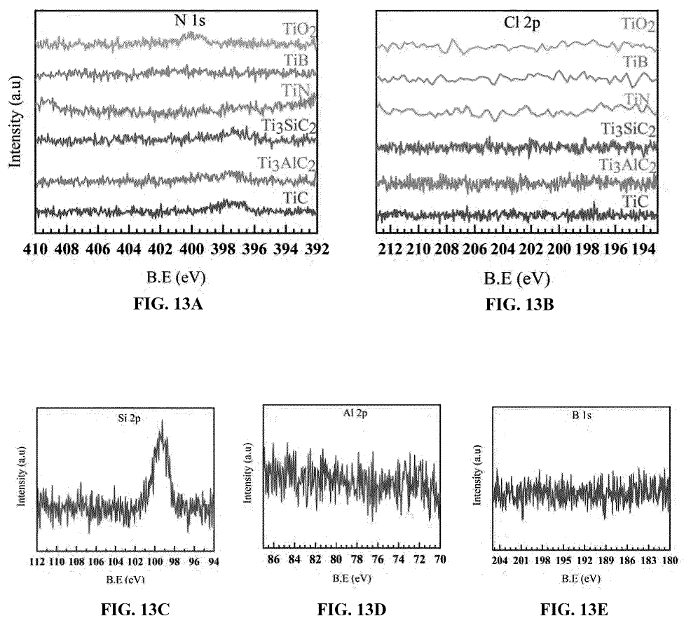

To elucidate the flakes' chemistry a comprehensive X-ray photoelectron spectroscopic (XPS) study (FIGS. 11-13 and Table 4) was carried out. The Ti, O binding energies were found to be weak functions of precursor chemistry (FIG. 11), washing protocol, or even heating to 800° C. in Ar (FIG. 12a). This confirms once again the chemical similarities of all films. Further evidence for a bottom-up approach is that—except for Ti₃SiC₂-derived films, that show a small Si peak—all other XPS spectra were comprised of only three elements—Ti, C and O—regardless of starting precursor (FIG. 13).

As discussed, it was not possible to quantify the C-content in our flakes. EELS, of several TiC-based flakes indicated a Ti:C:O atomic ratio of ≈1:1:1 (FIG. 2c and Table 5). The flakes incorporated small amounts of N that are ignored going forward for simplicity. One can note here that both EDS in the SEM and TEM confirmed a Ti:O ratio of ≈1.0 (Table 6). Based on this ratio, and if no C were in the structure, the Ti-oxidation state would have to be ≈+2, which is belied by X-ray absorption near edge structure (XANES) measurements (FIG. 2d) at the Ti K-edge on TiC-derived films that indicate that the average oxidation state, AOS, is between +3 and +4. In all cases the O:Ti ratio in XPS was closer to 3 than 1 (Table 7).

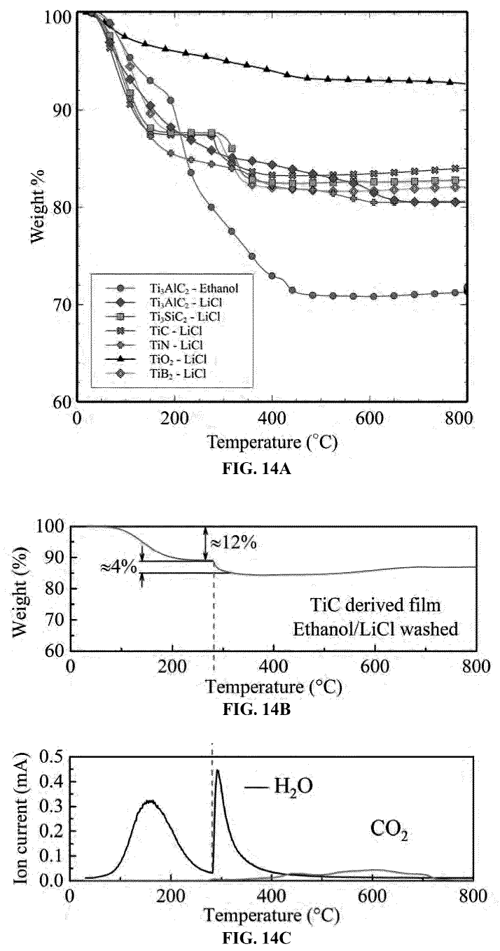

To better understand the chemistry and we carried morphology of our flakes out a thermogravimetric analysis, TGA, in Ar up to 800° C. on select films. The results are shown in FIG. 14a. With the exception of the TiO₂-derived films, in all other cases there were two major weight loss events when LiCl washed films were heated. One before z 200° C. and another at ≈300° C. or higher temperatures. For the TiB₂, TiC and Ti₃SiC₂-derived films, the latter is quite sharp. In most cases the weight loss at ≈300° C. was about 4%. The weight losses at >300° C. for the Ti₃AlC₂- and TiN-derived films are more diffuse, but the total was still ≈4%. The sharpness of the weight loss event at 300° C. is better seen in FIG. 14b, for a TiC-film heated in air to 800° C. In that run, the TGA was equipped with a mass-spectrometer, the results of which shown in FIG. 14c. It follows that the only gas released up to 400° C. is water. The first is most probably weakly bound interlayer water; the second can be water of hydration associated with the Li ions. The lack of higher atomic number species indirectly attests to the fact that the LiCl washing step rids the interlayer space of TMA cations and other reaction products. Not surprisingly the weight losses of films washed with only ethanol were higher (red curve in FIG. 14a).

After the TGA runs, we obtained XRD patterns of the resulting powders (FIG. 15). Rietveld analysis of the XRD pattern resulted in the values listed Table 8. In all cases, two major phases were identified: a Li-titanate, LT, phase—Li_{1.33}Ti_{1.67}O₄—and rutile. In the case of Ti₃AlC₂, Ti₃SiC₂, TiC the molar ratio of the TiO₂/LTA was ≈7:3; for TiB₂ the ratio was closer to 1:1; for TiO₂ there is little LT. Note that the higher the Li content the higher the Ti³⁺ fraction in the films. Our approach can thus be used to tune the Ti³⁺/Ti⁴⁺ ratio, a consideration in many applications.

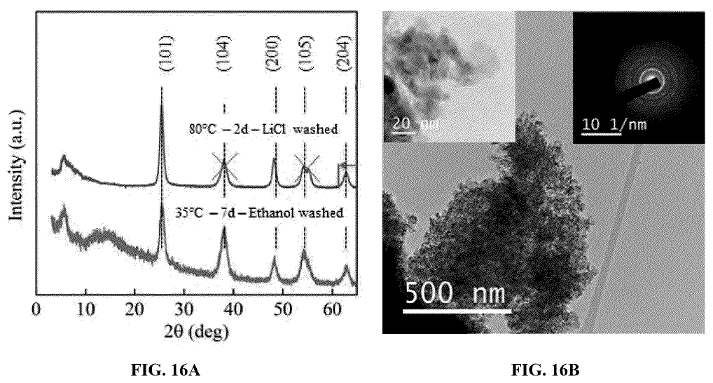

Washing with ethanol alone and heating the films in Ar to 800° C., no Li-containing phases are obtained. The presence of a LT phase thus implies that cations (TMA⁺ and/or protons) between the layers are exchanged by Li during the LiCl washing step. The TiO₂-derived samples were only lightly lithiated, even after washing with LiCl (Table 8), because in this case the material is not layered (see FIG. 16). This sample's TGA (black curve in FIG. 14a) is an outlier for the same reason. Cationic exchange eliminates the possibility we are dealing with layered double hydroxides. The absence of a Cl signal in XPS (see FIG. 13b) also supports this conclusion.

Based on the EELS, XANES, DFT and TGA results it is reasonable to assume that the chemistry of flakes is given by Z_{δ}(Ti⁴⁺)_{1-δ}(Ti³⁺)_{δ}O₂₋₂ₓCₓ, with x<1.0. Z is a cation that accounts for the fact that the Ti-oxidation state is <4+. Said otherwise, the decrease in oxidation state must be balanced by cations. This conclusion is predicated on the nanofilaments having no defects, a very unlikely scenario. The fact that many of the films are dark gray to black strongly suggest the presence of defect states in the band gap.

The overall situation is even more complex. For example, in some regions, the Ti:X ratio, where X=O+C+N approaches 1 (see spots 1 and 5 in Table 5).

One can propose a model where the ammonium helps in assembling Ti octahedra into 2D layers, while simultaneously intercalating the resultant sheets. There is no reason to believe that this mechanism does not apply here as well, except that because we are working at temperatures low enough that the TMA molecules are more stable, our material does not transform to bulk. Here, the TMAH not only caps the low energy (00 [symbol] ) planes, but must also cap a second surface perpendicular to the growth direction. This creates a situation where growth is confined to one dimension. Inset in FIG. 3b and FIG. 8f suggest that the filaments are chemically “drawn” out of the precursor and the polycondensation process may (without being bound to any particular theory) occurs at that interface. Once the nanofilaments are formed they must self-assemble into 2D flakes. FIG. 8d is a snapshot of how, in certain regions, the nanofilaments self-align to form “crystalline” regions.

Films derived from TiC and the MAX phases were conductive, with conductivities in the range of 0.01 to 0.05 S/cm; those made with TiO₂ and TiB₂ are not. These conductivities are roughly 5 to 6 orders of magnitude lower than MXenes, that range from 2,000 to 25,000 S/cm, but orders of magnitude higher than typical oxides, especially the more common version of layered titanates, viz. lepidocrocites. The conductivity is not always present and suggests an unknown variable is at play that is currently being investigated.

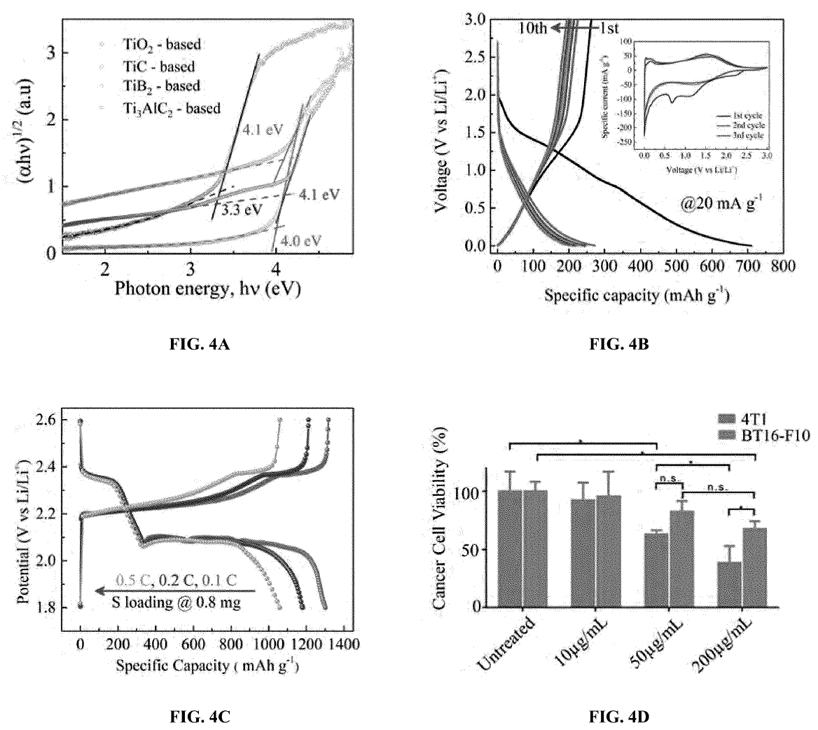

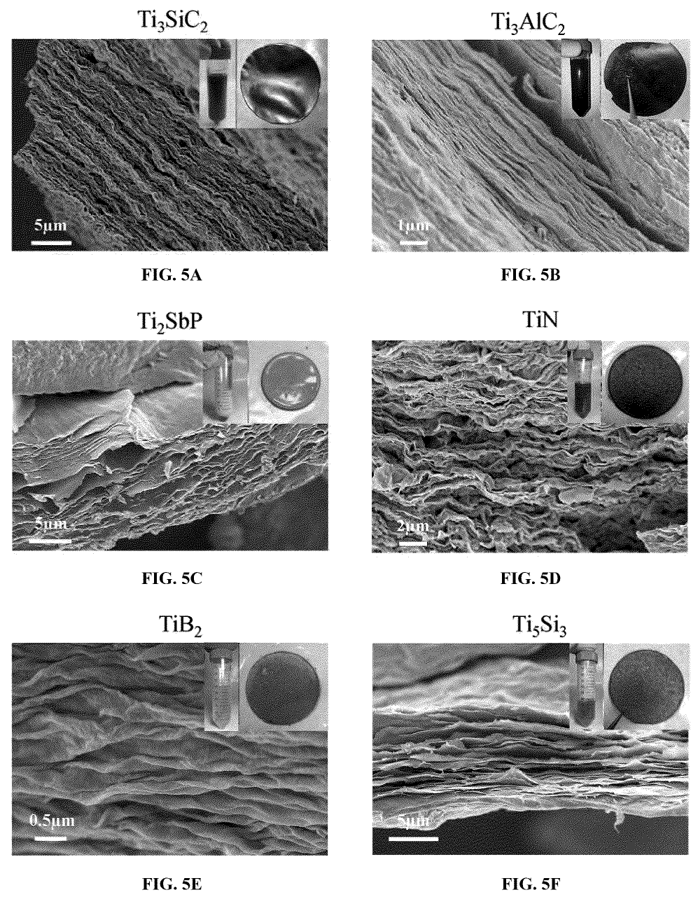

To shed light on the electronic structure, we measured their UV-vis optical absorption spectra from 200 nm to 800 nm. Tauc plots (FIG. 4a) of all films show a clear signature of an indirect band gap, E_{g}, as well as a pronounced Urbach tail due to transitions between sub-gap states. When a modified Tauc method was used to deconvolve the inter-band transitions from the contributions of disorder-related Urbach tail states, we concluded that the indirect band gaps fall in the 4 eV range. Our E_{g} is even higher because our flakes are comprised of ≈6×10 Å² nanofilaments. This record E_{g} value for TiO₂ indirectly confirms the extreme dimensions of our nanofilaments. Note that at 3.3 eV, E_{g} of our TiO₂-based nanoparticles is closer to that expected (FIG. 4a)

Interestingly (and without being bound to any particular theory or embodiment), here there is no correlation between the Ti³⁺ content—as deduced from the Li concentration—and the Urbach tails. One can thus tentatively conclude that the tails, and the conductivity, arise from point defects.

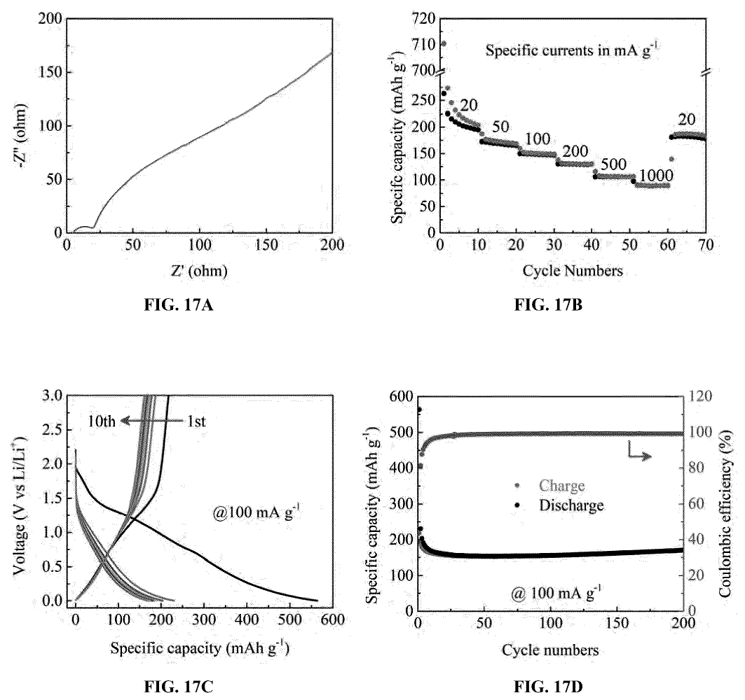

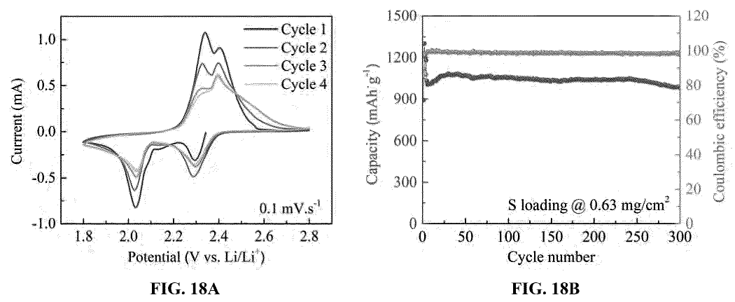

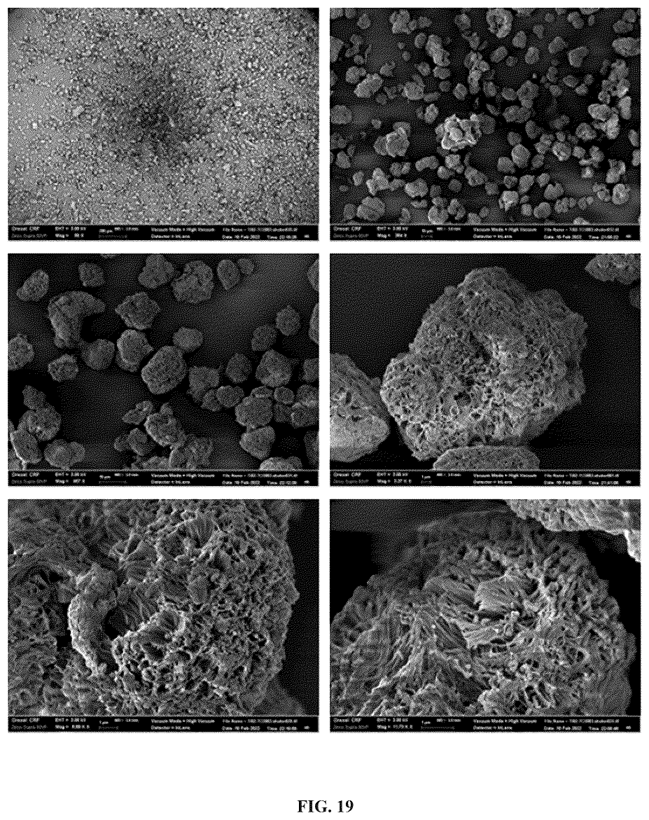

To investigate example applications, we explored the performance of our 2D flakes in lithium-ion batteries, LIBs, and lithium-sulphur, Li—S. The results are shown in FIGS. 4b and c, respectively and in both cases, the results are promising. A detailed discussion can be found in SM (see FIGS. 17 and 18). In the LIB case, the absence of lithiation and delithiation peaks at 1.64 V and 2.1 V, (inset in FIG. 4b) confirm that this electrode is neither TiO₂ nor a layered titanate. Moreover, the Coulombic efficiency of the electrode was ≈99.3% after 200 cycles (FIG. 17d), reflecting a highly efficient electrochemical cycling.

Lithium sulfur (Li—S) coin cells with a Li anode and a TiC-derived TCO cathode were assembled and cycled. Results are shown in FIG. 4c and are discussed in detail in SM. These materials show great promise, especially as Li—S cathodes. For example, as shown in FIG. 18b, the capacity was constant at ≈1000 mAh/g for about 300 cycles before fading.

To further demonstrate the versatility of TCOs we explored their potential for biomedical application and indeed have use in cancer therapy (FIG. 4d). Here mouse 4T1 breast cancer cells and B16-F10 melanoma cells were treated with different concentrations of TiC-derived TCOs for 24 h before a MTT assay was used to measure their viability. At a concentration of 200 μg/ml, the TCO particles could induce cancer cells' death, and were more effective on the 4T1 breast cancer cells than to B16-F10 melanoma cells. Accordingly, one can administer compositions according to the present disclosure to a cancer-containing sample, which administration can induce the cancer cells' death.

### CONCLUSION

We discovered a simple, inexpensive, relatively high-yield, near ambient, fully scalable, one-pot, bottom-up approach to fabricate 2D titanium carbo-oxide films comprised of nanofilaments. By heating 11 different—layered and non-layered Ti-based precursor powders in TMAH at different temperatures (25° to 85° C.) for various times we converted 10 of them to 2D flakes that are in turn comprised of ≈6×10 Å² nanofilaments with substantial C-content. Several of the films were dark in color and some of them were conductive, with conductivities in the 0.01 to 0.05 S/cm range. However, because there was no correlation between the Urbach tails and the fraction of Ti³⁺ as deduced from the overall Li content, we conclude that the source of the conductivity is not the reduced oxidation state but probably point defects. The TCOs performed well as electrodes in LIB and Li—S batteries. They also show potential in biomedical applications.

Materials and Methods

Processing of Films

Our synthesis process entails immersing precursor powders in 25 wt. % TMAH in polyethylene jars that are heated on a hot plate at temperatures that ranged from room temperature (RT) to 85° C. and for durations from 24 h to a week. After reaction with the TMAH, (except for Ti₂SbP, TiB₂ and TiO₂) a dark black sediment was obtained, collected, and rinsed with ethanol, shook, and centrifuged at 3500 rpm for multiple cycles until a clear supernatant was obtained. Once the supernatant was clear, 30 mL of deionized, DI, water was added to the washed products and shook for 5 mins. After centrifugation at 3500 rpm for 0.5 h, without sonication, a stable colloidal suspension was obtained. Any unreacted powders settled down. The colloid was then vacuum filtered to produce FF some of which were characterized.

In some cases, an additional step of washing with LiCl solution was conducted and the produced flakes were characterized. A 5M LiCl solution was added to the black colloidal suspension obtained above. This resulted in deflocculation. The sediment was shaken and rinsed with deionized water through centrifugation at 5000 rpm for three cycles. The LiCl/DI water washing process was repeated until the pH was ≈7. The washed sediment was then sonicated in a cold bath for 1 h under flowing Ar, shaken for 5 min, then centrifuged at 3500 rpm for 10 min. The colloidal suspension was filtered to produce FFs. The FFs were then left to dry in a vacuum chamber overnight before further characterization.

In few cases, the black slurry—produced from the reaction of TMAH and TiC—centrifuged (at 5000 rpm for 5 min) directly without the addition of any solvents, the supernatant decanted, the sediment resuspended in 20 mL DI water, shook for 5 min, then centrifuged at 3500 rpm for 30 min. The produced black colloidal suspension was used for XRD (not shown) and TEM inspection.

The yield was calculated as fraction of the number of moles of Ti in the produced structure (molar mass of TiO₂ is used for simplicity) to those supplied by the precursor. For instance, the yields for TiC and Ti₃AlC₂ are 19% and 28%, respectively. In general, the yield is of the order of ≈20% depending on starting precursor. The solid loading in our colloidal suspensions is of the order of 10 g/L.

X-Ray Diffraction, XRD

XRD patterns on air dried samples were acquired using a powder diffractometer (Rigaku SmartLab) setup in the Bragg-Brentano geometry with Cu Kα radiations in the 2-65° 2θ range using a 0.02° step size and a dwell time of 1 s/step. We also obtained XRD patterns, in transmission mode, on vertically oriented films.

Raman Spectroscopy, RS

Raman scattering spectra were collected at 300 K in air from FF of a number of precursors (FIG. 2b). The samples were probed using a 532-nm laser emitting 3.75 mW of power at the sample and focused to a spot diameter of ˜0.5 μm. Scattered light was collected in a backscattering geometry and was dispersed and detected using a single-axis monochromator equipped with a charge-coupled detector array (Horiba XploRA, Edison NJ)

X-Ray Photoelectron Spectroscopy, XPS

XPS was performed using a spectroscope (VersaProbe 5000, Physical Electronics, Chanhassen, Minnesota). Monochromatic Al-Kα X-rays with a 200 μm spot size were used. A pass energy of 23.5 eV, with an energy step of 0.05 eV and a step time of 0.5 s was used to gather high-resolution spectra. Number of repeats per scan was 10. XPS spectra were calibrated by setting the major C-C peak to 285.0 eV. Peaks were fit using asymmetric Gaussian/Lorentzian line shapes. The background was determined using the Shirley algorithm. All samples were mounted on a XPS stage using carbon tape.

Scanning Electron Microscope, SEM

Micrographs and elemental compositions were obtained using a SEM, (Zeiss Supra 50 VP, Carl Zeiss SMT AG, Oberkochen, Germany), equipped with an energy-dispersive X-ray spectroscope (EDS, Oxford EDS, Oxfordshire, United Kingdom). The EDS values reported represent the average of at least two measurements at low magnifications of randomly selected areas with an accelerating voltage 15 kV and 60 s dwell time.

Atomic Force Microscopy, AFM

Thicknesses of filaments and flakes were obtained with an AFM (Multimode 8 AFM from Bruker Nano Surfaces). A peak force tapping AFM imaging mode was applied to acquire the surface morphology and height profiles. The scanning was conducted with ScanAsyst-Air Silicon Nitride Probes at a scan rate of 0.6 Hz. Topographic images were recorded as the resolution of 256*256 pixels and analyzed by Nano Scope Analysis software.

Transmission Electron Microscope, TEM

TEM imaging and electron diffraction patterns were collected using a JEOL JEM2100F field-emission TEM. The TEM was operated at 200 keV and has an image resolution of 0.2 nm. Images and diffraction patterns were collected on a Gatan USC1000 CCD camera. Scanning transmission electron microscopy, STEM, was carried out in the monochromated and double Cs corrected FEI Titan3 60-300 operated at 300 kV.

Electron Energy Loss Spectroscopy, EELS

STEM-EELS spectra were acquired by averaging 100 spectra, acquired for 1 s each at a 0.25 eV/channel energy dispersion, and collection semi-angle of 55 mrad of employed Gatan GIF Quantum ERS post-column imaging filter. Elemental quantification of present edges was performed using built in functions of Digital Micrograph.

X-Ray Absorption Near Edge Structure, XANES

The Ti K-edge isotropic XANES spectra were recorded at 540 from the normal to the film using circularly polarized x-rays provided by the first harmonic of the HELIOS-II type helical undulator (HU-52). The x-ray beam was monochromatized using a fixed-exit double crystal monochromator equipped with a pair of Si(111) crystals. Total fluorescence yield signal was collected by a Si photodiode mounted in back-scattering geometry. Spectra were corrected for self-absorption effects. The samples were ≈1 mm thick compressed powered pellets. The isotropic XANES spectra were normalized to an edge jump of unity far above the absorption edge. The photon energy scale was calibrated using the pre-peak maximum in the absorption spectrum of a Ti thin foil that was set to 4965.6 eV. Spot size was 0.4×0.3 mm². Experiments were performed at European Synchrotron Radiation Facility (ESRF) ID12 beamline in Grenoble

Electrical Resistivity

Electrical resistivity measurements were performed using a four-point probe device (Loresta-AX MCP-T370, Nittoseiko, Japan) at RT, then converted into electrical conductivity values.

Thermogravimetric Analysis, TGA

A thermobalance (TA Instruments Q50, New Castle DE) was used for the TGA analysis. Small pieces of FF (≈20 mg) were heated in sapphire crucible at 10° C./min, under purging Ar at 10 mL/min, to 800° C. In one experiment we used a thermobalance attached to a mass-spectrometer. In these measurements a thermal analyzer (TA instruments, SDT 650, Discovery Series) coupled with a mass spectrometer (TA instruments Discovery Series) operating at 40 V ionizing potential was used. Samples were held at RT for 0.5 h then heated to 800° C. at 10° C./min under dry compressed air flow at 50 mL/min. The carrier gasses and evolved gas products from the sample were measured by scanning over the 1-100 atomic mass unit range. The ion current for each m/z (mass/charge ratio) was normalized by the initial sample weight.

UV-VIS

UV-VIS spectra were recorded using spectrophotometer (Evolution 300 UV-Visible, Thermo Scientific). Measurements were performed in transmission mode on 1-10 μm thick films coated onto quartz slides.

DFT Calculations

First-principles calculations were carried out using the Vienna ab initio simulation package (VASP). The projector augmented wave method (PAW) was used together with a plane wave basis expanded to a kinetic energy cutoff of 600 eV. Exchange-correlation effects were described within the generalized gradient approximation using the Perdew, Burke, and Ernzerhof (PBE) functional. Brillouin zone integration was performed using the Gaussian smearing method with a smearing width of 0.05 eV. The electronic configurations of the pseudopotentials used were C: [He]2S²2P², O: [He]2s²2p⁴ and Ti_sv: [Ne]3s²3p⁶3d²4s². The calculation supercells were constructed to consist of various (101) atomic layers using a slab model, with periodicity along the a and b axes of the supercell. The supercell geometry and atom positions were relaxed until the force on each atom <5 meV/Å. A vacuum region of 15 Å was added along the c-axis (in new coordinate system) of the supercell to eliminate interactions between periodic images perpendicular to the slabs. For the structural optimization, the first Brillouin zone was sampled by a 16×6×1 k-point sampling, while a 8×3×1 supercell together with a 2×2×1 k-point sampling was used for the phonon calculations.

Electrochemical Measurements

Lithium Ion Battery, LIBs

To evaluate electrochemical performance of TCO as electrode material as LIB material, we tested it in half-cell configuration against Li metal. The TCA working electrodes were fabricated by drop-casting a slurry of active materials with binder and carbon additive on a carbon coated copper foil. The slurry was prepared by mixing 40.0 mg of active materials, 5.0 mg of poly(vinylidene fluoride) (PVDF, Sigma Aldrich, US) binder in N-methyl-2-pyrrolidinone (NMP, 99.5%, Acros Organics, Extra Dry over Molecular Sieve, Germany) solvent, and 5.0 mg of carbon black. The as-prepared electrodes were dried overnight at 60° C. The electrode mass loading was 1.2-1.5 mg/cm². Two-electrode CR2032-type coin cells were assembled in an Ar-filled glovebox with O₂ and H₂O<0.1 ppm. Li metal foil was used as a counter electrode. 1M LiPF₆ in ethylene carbonate (EC)/ethyl methyl carbonate (EMC) with 3:7 (by weight) and glass fibers were used as electrolyte and separator, respectively. CV and galvanostatic charge-discharge testing were performed with a cut-off electrochemical voltage window of 0.001-3.0 V vs Li/Li⁺ using an electrochemical workstation (BioLogic VMP3) and a cycler (Landt CT2001A,). Electrochemical impedance spectroscopy with frequency from 100 kHz to 10 mHz were conducted in a electrochemical workstation (BioLogic VMP3).

Sulphur-Lithium Cells

To evaluate the performance of TCO as sulfur host in Li—S batteries, we prepared TCO/S cathodes using a slurry-based method. Briefly, the slurry was prepared by mixing 35 wt % vacuum-dried TCOs, 35 wt % sulphur, S, with 20 wt % conductive carbon (Alfa Aesar, Super P) and 10 wt. % battery grade PVDF binder (MTI Corp., USA). The materials were hand-ground with a mortar and pestle until the mixture appeared uniform. Later, N-Methyl-2-pyrrolidone (TCI, USA) was slowly added until the required visible consistency and uniformity of the slurry were achieved (˜25 minutes). The slurry was later cast on aluminum foil using a doctor blade (MTI Corp., USA) with a thickness of 20 μm. Once cast, the slurry was kept in a closed fume hood for 2 h before transferring to a vacuum oven where it was dried at 50° C. for 12 h.

The dried TCO/S cathodes were cut using a hole punch (diameter 11 mm) to form disks. The electrodes were then weighed and transferred to an Ar-filled glove box (MBraun Lab star, O₂<1 ppm, and H₂O<1 ppm). The CR2032 (MTI Corporation and Xiamen TMAX Battery Equipment) coin-type Li—S cells were assembled using TCO/S cathodes, a 15.6 mm diameter, 450 μm thick Li disk anode (Xiamen TMAX Battery Equipment) a tri-layer separator (Celgard 2325), and a stainless-steel spring and two spacers along with the electrolyte. The electrolyte, with 1 M LiTFSi with 1 wt % LiNO₃ in a mixture of 1,2-dimethoxyethane and 1,3-dioxolane at a 1:1 volume ratio, was purchased (TMAX Battery Equipment, China) and according to manufacturer contained trace amounts of oxygen and moisture (H₂O<6 ppm and O₂<1 ppm). Assembled coin cells were rested at their open-circuit potential for 10 h before performing the electrochemical experiments at RT. Cyclic voltammetry was performed at a scan rate of 0.1 mV·s⁻¹ between voltages 1.8 and 2.6 V wrt Li/Li⁺ using a potentiostat (Biologic VMP3). Prolonged cyclic stability tests were carried out with a battery cycler (Neware BTS 4000) at different C-rates (where 1 C=1675 mAh·g⁻¹) between voltages of 1.8 and 2.6 V. The Li—S cells were conditioned for 2 cycles at 0.1 C and 0.2 C, before undergoing long cycling at 0.5 C.

Biological Tests

One day before treatment, 4T1 and B16-F10 cells were added into a 96 well plate at a density of 10000 cells/well. The cells were cultured at 37° C./5% CO₂ in RPMI-1640 medium supplemented with 10% fetal bovine serum and 100 IU/mL penicillin/streptomycin for 24 h. The cells were then treated with TiC-based TCOs at concentrations of 10 μg/mL, 50 μg/mL or 200 μg/mL. After 24 h treatment, a thiazolyl blue tetrazolium bromide (MTT) assay was performed according to manufacturer's protocol. The absorbance at 570 nm and 630 nm was measured. Relative cell viability was obtained by comparing to the absorbance of untreated cells. All measurements were performed in triplicate. Data was analyzed using two-way ANOVA with post-hoc Tukey's test.

### REFERENCES

[1] K. S. Novoselov, et al., Science 353 (2016) 461.
[2] D. Deng, K. S. Novoselov, Q. Fu, N. Zheng, Z. Tian, X. Bao, Nat. Nanotechnol. 11 (2016) 218-230.
[3] K. S. Novoselov, Science 306 (2004) 666-669.
[4] K. S. Novoselov, D. Jiang, F. Schedin, T. J. Booth, V. V. Khotkevich, S. V. Morozov, A. K. Geim, PNAS 102 (2005) 10451-10453.
[5] F. Xia, H. Wang, Y. Jia, Nat. Commun. 5 (2014) 4458-4458.
[6] M. Naguib, M. Kurtoglu, V. Presser, J. Lu, J. Niu, M. Heon, L. Hultman, Y. Gogotsi, M. W. Barsoum, Adv. Mater. 23 (2011) 4248-4253.
[7] L. Verger, C. Xu, V. Natu, H.-M. Cheng, W. Ren, M. W. Barsoum, Curr. Opin. Solid State Mater. Sci. 23 (2019) 149-163.
[8] S. L. Swartzen-Allen, E. Matijevic, Chem. Rev. 74 (1974) 385-400.
[9] L. Verger, V. Natu, M. Carey, M. W. Barsoum, Trends Chem. 1 (2019) 656-669.
[10] T. Yang, T. T. Song, M. Callsen, J. Zhou, J. W. Chai, Y. P. Feng, S. J. Wang, M. Yang, Adv. Mater. Interfaces 6 (2019) 1801160.
[11] Z. Sun, T. Liao, Y. Dou, S. M. Hwang, M.-S. Park, L. Jiang, J. H. Kim, S. X. Dou, Nat. Commun. 5 (2014) 3813.
[12] J. Xuan, Z. Wang, Y. Chen, D. Liang, L. Cheng, X. Yang, Z. Liu, R. Ma, T. Sasaki, F. Geng, Angew. Chem. (2016).
[13] D. N. Miller, A. K. Azad, H. Delpouve, L. Quazuguel, J. Zhou, A. Sinha, P. Wormald, J. T. S. Irvine, J. Mater. Chem. A 4 (2016) 5730-5736.
[14] M. Ghidiu, M. W. Barsoum, J. Amer. Ceram. Soc. 100 (2017) 5395-5399.
[15] Yunxia Chen, Xin He, Xiujian Zhao, Qihua Yuan, X. Gu, J. Colloid Interface Sci. 310 (2007) 171-177.
[16] Frédéric Labat, Philippe Baranek, C. Adamo, J. Chem. Theory Comput. 4 (2008) 341-352.
[17] Z. Liu, K. Ooi, H. Kanoh, W. Tang, T. Tomida, Langmuir 16 (2000) 4154-4164.
[18] S. L. Brock, et al., J. Phys. Chem. B 103 (1999) 7416-7428.
[19] Z. Tan, K. Sato, S. Ohara, Adv Powder Technol 26 (2015) 296-302.
[20] M. Ghidiu, J. Halim, S. Kota, D. Bish, Y. Gogotsi, M. W. Barsoum, Chem. Mater. 28 (2016) 3507-3514.
[21] L. Verger, V. Natu, M. Ghidiu, M. W. Barsoum, J. Phys. Chem. C 20044-20050 (2019) 19725-19733.
[22] X. Dong, J. Tao, Y. Li, H. Zhu, Appl. Surf 256 (2010) 2532-2538.
[23] A. D. Dillon, M. J. Ghidiu, A. L. Krick, J. Griggs, S. J. May, Y. Gogotsi, M. W. Barsoum, A. T. Fafarman, Adv. Funct. Mater. 26 (2016) 4162-4168.
[24] M. Ghidiu, M. R. Lukatskaya, M.-Q. Zhao, Y. Gogotsi, M. W. Barsoum, Nature (2014).
[25] C. J. Zhang, B. Anasori, A. Seral-Ascaso, S.-H. Park, N. McEvoy, A. Shmeliov, G. S. Duesberg, J. N. Coleman, Y. Gogotsi, V. Nicolosi, Adv. Mater. 29 (2017) 1702678.
[26] P. Makula, M. Pacia, W. Macyk, J. Phys. Chem. 9 (2018) 6814-6817.
[27] A. S. D. Wang, T. Sasaki, Chem. Rev. 114 (2014) 9455-9486.
[28] T. Liao, Z. Sun, S. X. Dou, ACS Appl. Mater. Interfaces 9 (2017) 8255-8262.
[29] D.-e. Gu, Y. Lu, B.-c. Yang, Y.-d. Hu, Chem. Commun. (2008) 2453-2455.
[30] Y. Dong, M. Yu, Z. Wang, Y. Liu, X. Wang, Z. Zhao, J. Qiu, Adv. Funct. Mater. 26 (2016) 7590-7598.
[31] J. Xu, C. Jia, B. Cao, W. Zhang, Electrochim. Acta 52 (2007) 8044-8047.
[32] G. Kresse, J. Furthmüller, Phys. Rev. B 54 (1996) 11169-11186.
[33] J. P. Perdew, K. Burke, M. Ernzerhof, Phys. Rev. Lett. 77 (1996) 3865-3868.

Supplementary Disclosure

Rationale for LiCl Washing

A LiCl washing step was implemented for the following reasons:

To rid the interlayer space of the TMA cations. This was useful because in some cases, the TMA cations resulted in non-conducting films.

To prove the existence of exchangeable cations between the layers. Had there been no exchangeable cations, the Li⁺ ions would not have intercalated between the layers.

Knowing the fractions of resulting crystalline phases after heating the filtered films, FF, to 800° C. in Ar, allowed us to estimate the Ti³⁺ content.

X-Ray Diffraction

Not surprisingly, X-ray diffraction, XRD of films in the horizontal orientation did not shed much light on the underlying structure. Instead, we obtained patterns of vertically oriented films. To obtain the films 1-3 ml of a colloidal spension was drop-cast, using a pipette, onto a Kapton tape mounted on a glass slide (inset in FIG. 7a). Three layers of colloidal suspension were drop-cast with drying in between applications. Drying was carried out using a fan at room temperature, RT, inside a petri dish. The drop-cast sample was secured to a vertical sample holder using double-sided tape (FIG. 7a). The sample holder was then aligned to maximize the signal through the sample.

Crystallography

Following our recipe, the grown nfs-based 2D flakes are preferentially oriented along (110). In our system, the flakes' stacking direction is along c-axis. Said otherwise, in our coordinate system, this is the (001) plane.

Transmission Electron Microscope, TEM

The TEM images show that the aligned regions are a fraction of the total. In a sizable fraction, the nanofilaments are not aligned, but randomly oriented in the plane of the flakes. This has also been confirmed by selected area diffraction pattern (SAD) that showed diffraction rings for most of the characterized flakes.

Electron Energy Loss Spectroscopy, EELS

The EELS spectra on 5 different particles were measured on TiC-based flakes obtained after heating in TMAOH for 3d at 50° C. and ethanol washed. FIG. 2c includes carbon −K edge at ˜280 eV energy loss, titanium −L3,2 peaks at ˜450 eV energy loss and oxygen −K edge at ˜530 eV energy loss. All spectra are normalized to the Ti edge peak intensity. Thicker particles exhibit a steeper background, which is more easily seen at the low energy of the spectrum. The top and bottom spectra exhibit a pronounced lower intensity compared to the three particles in the middle. Among the 5 particles, the top and bottom spectra contain approximately the same amount of C, while for the three in the middle (2, 3 and 4) the chemistry was consistent a Ti:C:O atomic ratio of ≈1:1:1. All spectra also show a minor amount of N-K (not shown) at ˜400 eV energy loss; this small amount of N will be ignored. The results of these spectra are summarized in Table 5. The C is presumed to be in the backbone of the structure because the intensity of the C-loss peak did not change with time under the electron beam.

Two of the particles contained a significantly higher ratio of Ti. In one case, the Ti atomic fraction is close to 0.5. This suggests that during the process the Ti atoms are chemically reduced to an average oxidation state of +2.

One may note here that the C is presumed to originate from within the structure since the intensity of the various peak did not change with extended illumination under the beam, which could otherwise come from contaminated samples. The Ti/C ratio did not change even after heating to 500° C. in the TEM chamber.

X-ray Absorption Near Edge Structure, XANES,

The XANES experiments were performed at the ESRF beamline ID12 at the Ti K-edge on Ti-derived films. XANES spectra at the K-edge of transition metals are dominated by dipolar transitions to the unoccupied 4p states with usually structured pre-edge peaks that are associated with transitions into 4p-3d hybridized states.[11] The energy position of the absorption edge, and more specifically the pre-edge peaks are commonly related to the oxidation state and coordination of the absorbing atom. A comparison of the XANES spectrum of our TCO film (FIG. 2d) with the those of reference compounds for, inter alia, TiC, Ti₃AlC₂ and Ti³⁺ (TiCl₃) indicate that the average Ti oxidation state in the TCO films is between 3+ and 4+.

Both covalent bonding and the 3d-count could lead to an energy shift of the K-edge XANES spectra of Ti. The former mechanism is mainly manifested at the main edge. However, the energy positions of weak features below the main edge (arising from quadrupolar transitions 1s->3d) are dominated by the effect of the 3d occupation. Comparing the first derivative of the XANES spectra (inset in FIG. 2d) in the energy range from 4964 eV to 4968 eV clearly indicates that the oxidation state of Ti in TiC is close to 3+ as in the reference compound TiCl₃. On the contrary, TiCO contains both Ti³⁺ and Ti⁴⁺ states since there are two peaks in their derivative spectrum and the energy positions of these peaks coincide with the peak of TiCl₃ and the first peak of TiO₂.

X-ray Photoelectron Spectroscopy, XPS

Typical XPS spectra of all films are compared in FIG. 11. The peaks were fit and the results are summarized in Table 4. The Ti:O ratios of the films are summarized in Table 7. The latter were obtained from the areas of the Ti peaks at ≈459 eV peak and the O peaks at ≈530 eV peak. Here the ratio is roughly 1:3.

For the C is spectra (second column in FIG. 11) there are three peaks, the largest of which is centered around a binding energy, BE, of ≈285 eV, the two smaller peaks are centered around ≈286.5 eV and 288.5 eV. These coincide with the C—C, C—OH, and —COOH BEs, respectively. Here there was no peak at 282 eV consistent with the fact that C is not surrounded by 6 Ti atoms. In our structure, the C is bonded to 4 Ti atoms and it thus not surprising that their BEs are higher than 282 eV. After careful consideration we concluded that the C-peak in our TCO overlaps with the adventitious C-C peak.

As shown in FIG. 11 the Ti 2p_{3/2} BE is a weak function of processing. For example, the BEs after ethanol washing, LiCl and even after TGA to 800° C., are all quite comparable indeed and thus the values obtained on these films can be considered representative of all BEs for all processing conditions. When the films were heated in air the XPS spectra shifted (not shown).

FIG. 13 shows that, except in the case of Ti₃SiC₂ for which a Si signal was observed (FIG. 13c), all other films were comprised of only three elements, Ti, O and C. There was also no Cl between the layers confirming that we are not dealing with double layered hydroxides (FIG. 13b).

Thermogravimetric Analysis, TGA

Samples that were ethanol and LiCl washed were placed in a TGA and heated to 800° C. in Ar. The results are shown in FIG. 14. With the exception of the TiO₂ derived films and an ethanol washed film (two outliers in FIG. 14a) the overall weight loss was about 15%. The one run carried out in air on a TiC-derived, LiCl washed film showed identical results to those heated in Ar. In this case, however, the TGA was attached to a mass spectrometer that showed that the only gas evolved up to 400° C. was water (FIGS. 14 b and c). Beyond that temperature, some CO₂ was evolved.

Rietveld Analysis of Samples Heated in TGA to 800° C.

The results of Rietveld analyses, RA, of XRD patterns of FF heated to 800° C. in Ar in a TGA (FIG. 15) were caried out and the fractions of the various phases were quantified. The results are tabulated in Table 8. In most cases, the resulting phases were the Li-titanate, LTA, Li_{1.33}Ti_{1.66}O₄. With most χ² values were <2, the fits were quite good. Note that because the films derived from TiO₂ is not layered, the LTA volume fraction is by far the lowest.

Atomic Force Microscopy, AFM

To better understand the dimensions and make up of our 2D flakes we carried out an AFM study on the 2D flakes and nanoribbons. The results shown in FIGS. 3c and d confirm that the obtained 2D flakes are comprised of self-aligned nanofilaments.

To obtain the nanofilaments we heated TiC powders in TMAH at 80° C. for 5 d. After washing with water, a colloidal suspension was obtained. When the latter was spin coated at 1000 rpm for 10 s on a glass slide the AFM showed an unmistakable fiber structure, where the filaments were all aligned in more or less the same direction (FIG. 3c). The colloidal suspension was then diluted 500 times and drop cast on a substrate. This resulted in the separation of the filaments (FIG. 3d). When the AFM was traced across the blue line shown in FIG. 3d, the resulting profile (inset in FIG. 3d) showed that the thinnest fibers were ≈1.5 nm thick.

Lithium-Ion Battery, LIB

For the LIB work, CR2032-type coin cells were assembled to investigate the electrochemical performance of Ti₃AlC₂-derived electrodes. The cyclic voltammetry, CV, curves obtained at a scan rate of 0.1 mV s⁻¹, in the 0.001-3.0 V vs Li/Li⁺ voltage window (inset in FIG. 4b) are quite similar to those in MXene literature.[14, 15]

FIG. 4b shows the galvanostatic charge/discharge voltage profiles at a specific current of 20 mA g⁻¹, the initial lithiation and delithiation specific capacities are 714 and 265 mAh g⁻¹, respectively. The specific capacity loss in the first lithiation process can be attributed to the solid electrolyte interphase (SEI) layer formation below 0.85 V and other irreversible reactions. The specific capacity stabilizes after two cycles. The stable lithiation and delithiation specific capacities of 210 and 209 mAhg⁻¹, respectively, are maintained after 5 cycles. FIG. 17a, plots the electrochemical impedance spectroscopy of the electrode, showing low system resistance (4Ω) and small charge transfer resistance (18Ω), which support the electrochemical performance observed.

Rate handling capability results are shown in FIG. 17b. At 500 mA g⁻¹ a reversible capacity of ˜110 mAh g⁻¹ can be maintained. Even at 1000 mA g⁻¹, a reversible capacity of ˜80 mAh g⁻¹ can be achieved, and by returning to 20 mA g⁻¹, the capacity recovered to ˜180 mAh g⁻¹. As shown in FIGS. 17c and d, the as-prepared TCO electrode exhibits excellent cycling stability performance at a specific current of 100 mA g⁻¹. The electrode shows a specific capacity of 155 mAhg⁻¹ over 200 cycles. Moreover, the Coulombic efficiency of the electrode is ≈98.9% after 30 cycles, reflecting a highly efficient electrochemical cycling.

Lithium Sulphur, Li—S Electrodes

FIG. 18a, plots typical CV curves in the 1.8-2.6 V (vs. Li/Li⁺) range at a scan rate of 0.1 mV·s⁻¹. The CV curves show two sharp and distinct cathodic and one anodic peak. The first cathodic peak at 2.3 V is ascribed to S reduction to long-chain lithium polysulfides (LiPs), while the second peak is related to a subsequent reduction of LiPs to Li₂6/Li₂S.[17] The peak shifts after the first anodic peak are possibly due to nucleation/reorganization during the redeposition of the LiPs back to 12. FIG. 4c, displays typical discharge plateaus consistent with the CV results. The TCO/S composite electrodes deliver capacities of 1300, 1200, 1050 mAh g⁻¹ at 0.1, 0.2 and 0.5 C rates, respectively. Such high capacity can be associated with the TiCO conductivity, coupled with possible surface-active sites that bind to the LiPs. To evaluate the long-term stability, of the cathodes they were cycled at 0.5 C at a S loading of 0.83 mg cm⁻². FIG. 14b, shows the cell delivers an initial capacity of ˜1300 mAh g⁻¹, which stabilizes to ˜1000 mAh g⁻¹ after the first 5 cycles. This initial drop is associated with the two conditioning cycles at low rate of 0.1 and 0.2 C. The composite delivers a capacity of ˜1000 mAh g¹ after ≈300 cycles with around 100% retention. The capacity drops after 300 cycles. These values are excellent given that the cathode was crudely produced by a slurry blend—using a mortar and pestle—of the TCO flakes and commercially-purchased S powders.

Mesoscopic Materials

We heated 50 g of TiB₂ powder in 500 mL of 25% TMAH solution at 80 C for 3 days in a polyethylene bottle and shaken using a mechanical lab shaker. After 3 days in the shaker, the resulting suspension was allowed to settle and the liquid was decanted. Then 500 mL ethanol was added and the suspension and again allowed to settled and the liquid was decanted. The ethanol washing was repeated for a total of 3 times.

After decantation of the supernatant, the resulting sediment was washed with 500 mL of a 5M LiCl solution at RT for 4 h. This was followed by decantation of the liquid. The process was repeated with water for another 4 h. After a second water washing the supernatant was decantated which resulted in a grey sediment. The resulting sediment was dried in open air at 40 C overnight then hand-ground to produce a fine powder.

XRD pattern of the powder showed low angle peak with d-spacing of 9.4 A, non-basal peaks at 25° and 48°. The (104) and (105) peaks were missing. Some low intensity peaks that belong to unreacted the TiB2 precursor remained. SEM micrographs (FIG. 19) of the resulting powder revealed an even distribution of well separated mesoporous particles roughly 10 μm in size. The mesoporous particles can be made of ligaments that are few-microns long and less than 100 nm in diameter. The mesoporous particles can be used in, for example, drug delivery, energy storage, and devices. As an example a therapeutic can be associated with the mesoporous particles (for example, adsorbed to, intercalated into, etc.), which therapeutic-laden particles can be introduced to a subject and deliver the therapeutic to the subject. A mesoporous particle according to the present disclosure can have a diameter in the range of, for example, from about 0.1 to about 20 μm, from about 0.5 to about 15 μm, or even from about 1 to about 10 μm, and all intermediate values.

### REFERENCES

[1] A. P. Ferris, W. B. Jepson, J. Colloid Interface Sci. 51 (1975) 245-259.
[2] M. Ghidiu, J. Halim, S. Kota, D. Bish, Y. Gogotsi, M. W. Barsoum, Chem. Mater. 28 (2016) 3507-3514.
[3] M. Ghidiu, S. Kota, J. Halim, A. W. Sherwood, N. Nedfors, J. Rosen, V. N. Mochalin, M. W. Barsoum, Chem. Mater. 29 (2017) 1099-1106.
[4] W. G. Lawrence, J. Am. Ceram 41 (1958) 136-140.
[5] L. Verger, V. Natu, M. Ghidiu, M. W. Barsoum, J. Phys. Chem. C 20044-20050 (2019) 19725-19733.
[6] M. M. Gudarzi, Langmuir 32 (2016) 5058-5068.
[7] G. Lagaly, S. Ziesmer, J. Colloid Interface Sci. 100-102 (2003) 105-128.
[8] T. Missana, A. Adell, J. Colloid Interface Sci. 230 (2000) 150-156.
[9] V. Natu, M. Sokol, L. Verger, M. W. Barsoum, J. Phys. Chem. C 122 (2018) 27745-27753.
[10] M. Ghidiu, M. W. Barsoum, J. Amer. Ceram. Soc. 100 (2017) 5395-5399.
[11] A. Rogalev, F. Wilhelm, Phys. Met. Metallogr. 116 (2015) 1285-1336.
[12] T. L. Barr, S. Seal, J. Vac. Sci. Technol 13 (1995) 1239-1246.
[13] V. Natu, M. Benchakar, C. Canaff, A. Habrioux, S. Célérier, M. W. Barsoum, Matter 4 (2021) 1224-1251.
[14] J. Luo, X. Tao, J. Zhang, Y. Xia, H. Huang, L. Zhang, Y. Gan, C. Liang, W. Zhang, ACS Nano 10 (2016) 2491-2499.
[15] B. Ahmed, D. H. Anjum, M. N. Hedhili, Y. Gogotsi, H. N. Alshareef, Nanoscale 8 (2016) 7580-7587.
[16] M. Naguib, J. Come, B. Dyatkin, V. Presser, P.-L. Taberna, P. Simon, M. W. Barsoum, Y. Gogotsi, Electrochem. commun. 16 (2012) 61-64.
[17] A. Manthiram, Y. Fu, S.-H. Chung, C. Zu, Y.-S. Su, Chem. Rev. 114 (2014) 11751-11787.

Additional Disclosure—I

Results and Discussion

All experimental details can be found in Methods Section.

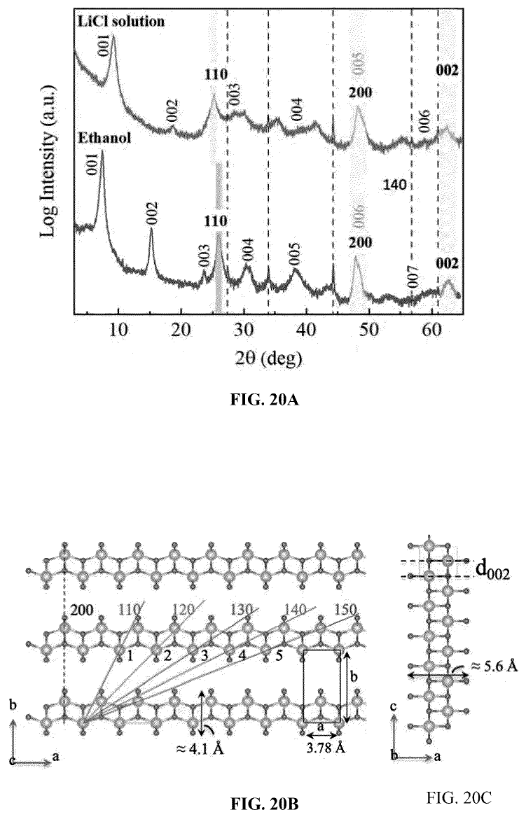

FIG. 20 plots XRD patterns—on log scale—for 2 samples that were synthesized by reacting TiB₂ powders with TMAH at 80° C. for 5 days. After reaction, the resulting powders were washed with ethanol until the pH was ≈7. In one case, the powders were dehydrated straight from ethanol at 50° C. in open air (bottom blue curve in FIG. 20a). In the other case, sediments were further stirred in a LiCl solution then rinsed with DI water before allowing the powders to, again, naturally dry in open air (top red curve in FIG. 20a).

Vertical dashed lines in FIG. 20 designate two low-intensity unreacted TiB₂ peaks that were used as internal standards. When the powders were washed with ethanol, the XRD patterns were characterized by 7 basal reflections with a d-spacing of ≈11.5 Å, due to the stacking of “2D” flakes comprised of in-plane alignment of 1DL (see below). After washing with LiCl (see Methods Section), the d-spacing value dropped to ≈9.5 Å confirming the replacement of TMA⁺ cations with Li⁺. The yellow bands in FIG. 20a denote lepidocrocite non-basal reflections, at 20 values of ≈26°, ≈48° and ≈62° 2θ. These peak positions are in agreement with previous XRD patterns, as well as with rings previously observed in SAD patterns in TEM.

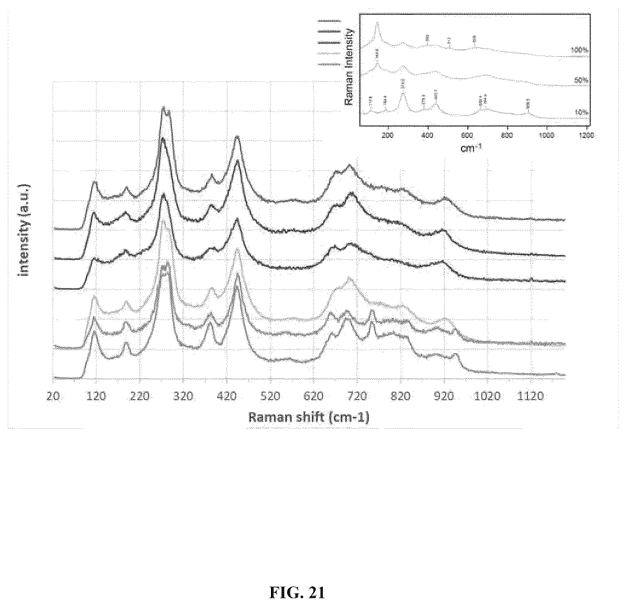

FIG. 21 presents the Raman spectra of 6 samples processed in different ways described herein. In all cases, the spectra obtained were consistent with lepidocrocite. To model our structure, we made use of DFT calculations on lepidocrocite. The latter is comprised of 2 Ti-atom thick ribbons stacked along the b-direction (FIG. 20b). Half the O atoms are 4-fold coordinated; the other half 2-fold. The (200) peak in the XRD patterns is due to vertical plane labelled as such in FIG. 20b. As discussed below, the planes responsible for the peak at 62° 2θ are shown in FIG. 20c and indexed as (002). In our coordinate system (FIG. 1b), the peak at ≈26° 2θ is ascribed to the (110) planes (FIG. 20b). Most of the other peaks are 001 peaks characteristic of 2D materials. Note that in the ethanol washed samples (blue pattern in FIG. 20a) the order along the stacking direction is higher than in their LiCl-washed counterparts.

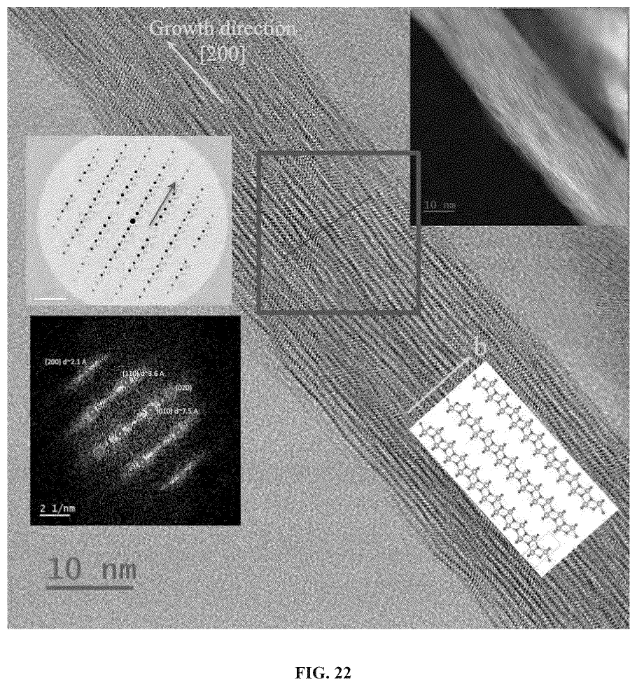

FIG. 22 presents an annular bright field (ABF) TEM image of a TiB₂-derived bundle of NFs, together with a FFT of the center of the micrograph outlined by the blue square. To simulate the FFT, we started with the DFT-generated lepidocrocite structure¹⁶ and tilted it so the c-axis was the zone axis (FIG. 22b). The lepidocrocite layers were stacked along the b-axis (FIG. 1b) such that the growth direction was [100] and coincided with of the bundle axis (lower right inset FIG. 22). The stacking distance between the 2D layers was adjusted to match the (010) and (020) spots on the FFT. The interlayer distance, henceforth referred to as d010, chosen was 7.5 Å. The other spots (top left inset in FIG. 22) were generated by the single-crystal diffraction module of the Crystal Maker software. Said otherwise only one adjustable parameter was used.

The agreement between the FFT spots and our simulated SAD—red circles in lower left inset—is excellent and suggests that the 110 and 200 d-spacings are 3.6 Å and 2.1 Å, respectively. The corresponding distances, derived from the XRD patterns for the (110) and (200) planes—henceforth referred as d110 and d200, respectively—were 3.5±0.8 Å and 1.89±0.01 Å. Such a discrepancy in the d-spacings is not unexpected, especially when a FFT of an atomic-resolution STEM image is used. The position of the “diffraction spots” in the FFT is based on calibration of the underlying STEM image, which is affected by the accuracy of the underlying image calibration, scan distortions and image pixel size. The fact that in the DFT we model 2D lepidocrocite while experimentally we are dealing with 1DL could play a role. Needless to add, the XRD results are more accurate, but the symmetry of the diffraction peaks is consistent. Based on the d200 value, the a lattice parameter is 3.78 Å.

In the bright regions, where Ti-atomic columns presumably stack, it is possible to discern—as shown in FIG. 23—a zig-zag pattern to the Ti-atoms that is consistent with schematic shown in FIG. 20b.

Using the Scherer formula, we estimate the domain sizes along [110] [200] and [002] to be 4.2, 7.3 and 3.4 nm, respectively. These dimensions are small compared to the micrograph shown in FIGS. 22, 23, and 24, and suggest that the order is on a finer scale than the relatively larger macroscopic features—viz. 2D flakes, fiber bundles etc.—observed.

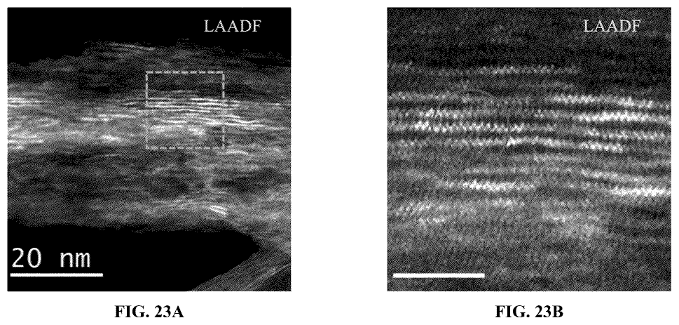

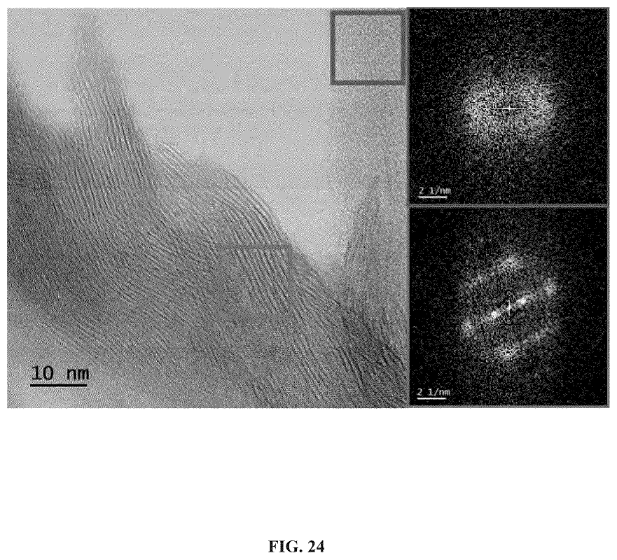

FIG. 24 delineates regions enclosed by a blue and a green square. FFT pattern of the blue region—top left inset in FIG. 24—is clearly amorphous. The corresponding FFT (lower inset) of the green region resulted in a pattern that is the same as that shown in FIG. 22, but significantly less sharp.

Based on DFT calculations, the thickness of the 2-Ti atom ribbons, from outermost O to outermost O, is ≈4.1 Å (FIG. 20b). If the total interlayer distance is 7.5 Å, then the intergallery space is ≈3.4 Å. The origin of other non-basal peaks can be traced to planes where the Ti atoms in one ribbon, or unit cell, are connected to ever increasing number of Ti atoms—numbered in FIG. 20b—in adjacent ribbons as shown in FIG. 20b. In our coordinate system, the first of these inclined planes is (110) with a d-spacing that is consistent with a XRD peak at 26° 2θ.

The DFT c-lattice parameter, LP, is ≈3.01 Å and its (002) d-spacing, d002, would be 1.5 Å, with a 2θ of ≈62.2°. Experimentally in XRD patterns, this peak appears at 61.0±0.4°,¹² corresponding to a c-LP of 3.04±0.06 Å. We thus ascribe this crystallographic peak to (002) reflections. Note there are two (002) reflections. The first is associated with the stacking of the NFs along the c-axis at 2θ<20° (FIG. 20a). The second is crystallographic, and stems from the X-rays reflecting off the top of the ribbons shown in FIG. 20c, and appears at ≈62°2θ

In many of our SAD patterns of NFs self-assembled in various ways, three rings were usually outlined. These rings can now be ascribed to the (110), (200) and (002) planes of lepidocrocite. The d-spacings of these planes are in agreement with corresponding peaks shown in FIG. 20a.

Based on the aforementioned results, we identified 2 of the 3 planes of our 1DL NFs; (100) and (001). From the TEM image shown in FIG. 22, and others, one can tentatively conclude that the thickness of (001) nanoribbons is of the order of ≈6 Å; their DFT width is 5.7 Å (FIG. 20c). Had this dimension been much wider, it is unlikely that the relatively homogenous microstructure shown in FIG. 22 would have been possible.

When 2D lepidocrocite, with strong (101) peaks in XRD, is imaged in a TEM relatively large islands and lattice fringes are not difficult to find. Their absence here strongly suggests they do not exist and what we have instead are 1DL NFs that self-assemble into “2D” flakes. The “2D” flakes can be comprised of 1DL NFs that self-assembled into layers.

FIG. 25 further bolsters the conclusion that we are dealing with NFs. In this TiC-derived sample individual NFs can be readily discerned.

Of the three distances, d200, d002 and d101, only the first two are crystallographic. It is for this reason that for all materials produced to date—over 200 separate runs—the locations of the 200 peaks, at ≈48° 2θ in the XRD patterns was unchanged (FIG. 20a). The same is true of the ≈62° 2θ peaks.¹² The locations of the (110) peaks, on the other hand, are a function of the surrounding media (FIG. 20a) and thus cannot be crystallographic. Another observation consistent with this notion is that the distance between NFs along the red line plotted in FIG. 22 is ≈7 Å, which is comparable to the 7.5 Å used to adjust theory to the FFT pattern.

Compared to 2D materials with one stacking direction, here there are two; one along the (010) direction orb-axis (lower right inset in FIG. 22); the other is out-of-the plane of the page (along the c-axis) that is responsible for the low angle reflections labelled (001) in FIG. 20. Not much information can be gleaned from the STEM images about the c-axis spacing or stacking. Not surprisingly, that spacing is also a function of the nature of the cations surrounding the NFs as shown by peaks labelled (001) in FIG. 20 Note, most of the peaks, and the strongest ones, are (001) peaks. This is especially manifest when the y-axis is plotted linearly and not logarithmically.

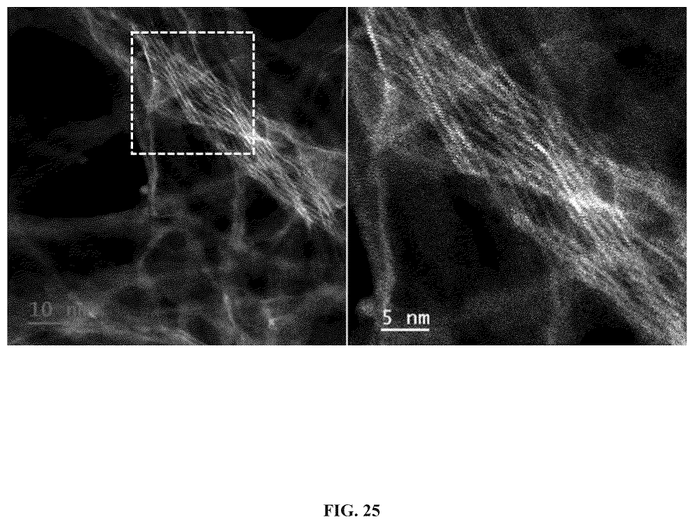

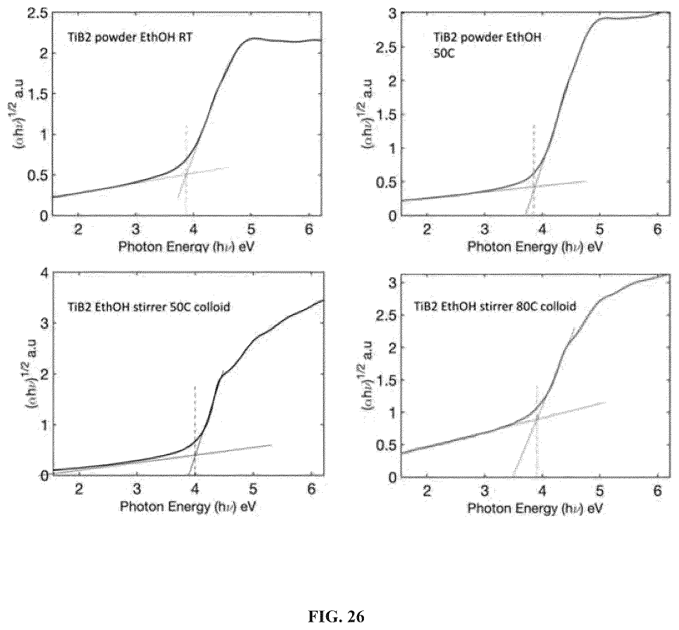

Lastly, and while the washing protocol changes the spacing between NFs, these variations do not affect the band gap. Tauc plots (FIG. 26) confirm the presence of as indirect band gap at ≈4 eV reported on earlier. This band gap energy is a record for a TiO2-based material made via a bottom up approach and is an independent confirmation of a quantum confinement effect.

In conclusion, the 1D NFs produced by reacting TiB₂ and TiC powders in TMAH at 80° C. for 5 days crystalize in the lepidocrocite TiO₂ structure. The NFs grow in the [100] direction and stack along the b-direction in the plane that the NFs self-assemble to either create bundles (FIG. 22) or larger 2D flakes.

Regardless of how well the NFs are self-assembled or not, if we assume them to be 6×5 Å² in cross-section, their theoretical specific surface area would be >1700 m²/g. This is an extraordinary number for a Ti-containing material and partially explains some of the remarkable properties these materials exhibit. The fact that the process to make them is inexpensive, highly scalable—one can routinely make 100 g batches in a laboratory setting—and the precursors powders, such as TiC, TiB₂, Ti-containing MAX phases, are earth abundant, and non-toxic, evidences their large-scale application in myriad fields.

Methods

Materials Synthesis and Processing

Samples of 1DL NFs prepared by shaking TiB₂ (Thermo Scientific, −325) powders with tetramethyl ammonium hydroxide aqueous solution, TMAH (Alfa Aesar, 25 wt. % in DI water, 99.9999%) at 80° C. for 5 days using a temperature-controlled incubator/shaker. In all cases, the Ti:TMAH mole ratio was kept at 0.6. After reaction, the resulting powders were washed with ethanol (Decon Lab Inc., 200 proof) till pH was ≈7. The powders were then dehydrated in open air at 50° C. overnight. To explore any potential effect of the drying temperature, another sample, from the same batch, was dehydrated at room temperature, RT instead.

To assess capability of ion exchange, ethanol-washed sediments were further stirred, while wet, 3 subsequent times each of 6 h in one of the following salt solutions: LiCl 0.5M, LiCl 5M, NaCl 0.5M, or NaCl 5M and then rinsed with DI water 3 times to remove any unreacted salt or reaction products. All salts purchased from Alfa Aesar with >99% purity. The LiCl- and NaCl-washed powders were then air-dried at 50° C., similar to above.

To compare shaker-processed samples to those produced using magnetic stirring, in one case TiB₂ powders were magnetically stirred, at 300 rpm, in a TMAH solution following the abovementioned conditions of mole ratio, temperature, and time. After reaction, the resulting slurry washed 6 times with ethanol till pH was ≈7, redispersed in DI water, shook for 5 min, then centrifuged at 3500 rpm for 30 min. The resulting colloidal suspension was then filtered using vacuum-assisted filtration to produce a filtered film that was dried at 50° C. in open air overnight.

The Raman spectra shown in FIG. 21 were obtained for the following six samples: ethanol washed, LiCl 0.5M, LiCl 5M, NaCl 0.5M, NaCl 5M and the magnetically stirred sample.

X-ray Diffraction

XRD patterns were acquired using a diffractometer (Rigaku MiniFlex) operated with Cu Kα radiation (40 kV and 15 mA) in the 2-65° 2θ range with step size of 0.02° and a dwell time of 1 s. All XRD patterns obtained from powders dried overnight at 50° C. in open air.

Raman Spectroscopy

Two sets of Raman spectra were obtained in two different labs. At Drexel University, Raman spectra were collected at room temperature in air. Measurements were done with an inverted reflection mode Renishaw InVia (Gloucestershire, U. K.) instrument equipped with 63×(NA=0.7) objectives and a diffraction-based room-temperature CCD spectrometer. Ar+ laser (514 nm) was used and the laser power was kept in the ˜0.5-1.5 mW range.

In another set, obtained at Fayetteville University, suspensions of TiB₂-derived material QDN with a concentration of 10 mg/mL were prepared with solvents of deionized (DI) water (Millipore), isopropyl alcohol (>99.7%, Sigma Aldrich) and dimethyl sulfoxide (DMSO, 99.9%, Sigma Aldrich) and were drop-cast onto a microscope slide and allowed to air dry at room temperature, RT, for 24 hours. Raman spectra were collected at room temperature using an XploRA PLUS confocal Raman microscope (Horiba Scientific, Piscataway, NJ, USA) with a 250 mm focal length spectrometer in a backscatter geometric configuration. The spectrometer was first calibrated using a silicon chip with excitation by an air-cooled 532 nm solid state laser (100 mW) and using a 100× (NA=0.9 and WD=0.21 mm) objective to obtain a 1 μm spot size. A 1200 gr/mm grating was used and the scattered light was collected with a thermoelectrically (TE) air-cooled charge-coupled device (CCD) detector with 1024×256 pixels for a spectral resolution of 1 cm⁻¹. A neutral density (ND) filter wheel was used to attenuate the laser power to 10%, 25%, 50%, or 100%, and spectra were acquired at a lower power (10%) or higher. Raman spectra were collected in the 75-1200 cm⁻¹ range with 2 s integration time and 64 accumulations. The LabSpec 6 software was used to fit the collected Raman spectrum according to the Gaussian-Lorentzian function to obtain the peak positions and their intensities.

Transmission Electron Microscopy

Atomic scale characterization was conducted using an aberration-corrected, cold-field emission TEM (JEOL ARM200CF) operated at 200 kV primary electron energy.²¹ Imaging was conducted with the emission current at 15 μA and an electron probe semi-convergence angle of 24 mrad resulting in an electron probe size of approximately 80 pm. Annular bright field (ABF) imaging, which is a coherent imaging technique, was conducted using an outer angle of 23 mrad and an inner angle of 11 mrad. For low angle annular dark field (LAADF) imaging the inner and outer angles were 30 mrad and 120 mrad, respectively. HAADF images were collected with 68 mrad and 280 mrad inner and outer detector angles, respectively. The primary contrast mechanism for HAADF imaging is related to the square of the average atomic number and the total thickness of the atomic columns.

The TEM samples were prepared by dispersing nanofilament powders in 5 ml of methanol. The solution was drop casted onto a 3 mm copper mesh coated with a lacey carbon film and allowed to dry for an hour. The TEM grid was then loaded onto a plasma cleaned double tilt holder and inserted into the microscope column.

### REFERENCES

Kumar, S. G.; Devi, L. G., Review on Modified TiO₂ Photocatalysis under UV/Visible Light: Selected Results and Related Mechanisms on Interfacial Charge Carrier Transfer Dynamics. The Journal of Physical Chemistry A 2011, 115 (46), 13211-13241.
Schaub, R.; Thostrup, P.; Lopez, N.; Lægsgaard, E.; Stensgaard, I.; Nørskov, J. K.; Besenbacher, F., Oxygen vacancies as active sites for water dissociation on rutile TiO 2 (110). Physical Review Letters 2001, 87 (26), 266104.
Wang, A. S. D.; Sasaki, T., Titanium Oxide Nanosheets: Graphene Analogues with Versatile Functionalities. Chem. Rev. 2014, 114, 9455-9486.
Bourikas, K.; Kordulis, C.; Lycourghiotis, A., Titanium Dioxide (Anatase and Rutile): Surface Chemistry, Liquid-Solid Interface Chemistry, and Scientific Synthesis of Supported Catalysts. Chemical Reviews 2014, 114 (19), 9754-9823.
Wang, X.; Li, Z.; Shi, J.; Yu, Y., One-dimensional titanium dioxide nanomaterials: nanowires, nanorods, and nanobelts. Chemical reviews 2014, 114 (19), 9346-9384.
Ramos-Delgado, N. A.; Gracia-Pinilla, M. Á.; Mangalaraja, R. V.; O'Shea, K.; Dionysiou, D. D., Industrial synthesis and characterization of nanophotocatalysts materials: titania. Nanotechnology Reviews 2016, 5 (5), 467-479.
Fang, W.; Xing, M.; Zhang, J., Modifications on Reduced Titanium Dioxide Photocatalysts: A review. J. Photochem. Photobiolog C: Photochem. Rev. 32 2017, 21-39.
Saeed, M.; Muneer, M.; Akram, N., Photocatalysis: an effective tool for photodegradation of dyes—a review. Environmental Science and Pollution Research 2021, 1-19.
Sasaki, T.; Watanabe, M.; Michiue, Y.; Komatsu, Y.; Izumi, F.; Takenouchi, S., Preparation and Acid-Base Properties of a Protonated Titanate with the Lepidocrocite-like Layer. Chem. Mater. 1995, 7, 1001.
Sasaki, T.; Watanabe, M., Semiconductor nanosheet crystallites of quasi-TiO2 and their optical properties. J. Phys. Chem. B. 1997, 101 (49), 10159-10161.
Zhou, W.; Umezawa, N.; Ma, R.; Sakai, N.; Ebina, Y.; Sano, K.; Liu, M.; Ishida, Y.; Aida, T.; Sasaki, T., Spontaneous Direct Band Gap, High Hole Mobility, and Huge Exciton Energy in Atomic-Thin TiO2 Nanosheet. Chemistry of Materials 2018, 30 (18), 6449-6457.
Badr, H.; El-Melegy, T.; Carey, M.; Natu, V.; Hassig, M. Q.; Johnson, C.; Qian, Q.; Li,
C. Y.; Kushnir, K.; Ulloa, E. C.; Titova, L. V.; Martin, J.; Grimm, R. L.; Pai, R.; Kalra, V.;
Karmakar, A.; Liang, K.; Naguib, M.; Wilson, O.; Magenau, A. J. D.; Montazeri, K.; Zhu, Y.; Cheng, H.; Torita, T.; Koyanagi, M.; Yanagimachi, A.; Ouisse, T.; Barbier, M.; Wihlem, F.; Rogalev, A.; Persson, P.; Rosen, J.; Hu, Y.-J.; Barsoum, M. W., Bottom-up, scalable synthesis of anatase nanofilament-based two-dimensional titanium carbo-oxide flakes. Mater. Today 2022, 54, 8-17.
Hu, W.; Li, L.; Li, G.; Liu, Y.; Withers, R. L., Atomic-scale control of TiO6 octahedra through solution chemistry towards giant dielectric response. Scientific reports 2014, 4 (1), 1-9.
Esmat, M.; Farghali, A. A.; El-Dek, S. I.; Khedr, M. H.; Yamauchi, Y.; Bando, Y.; Fukata, N.; Ide, Y., Conversion of a 2D Lepidocrocite-Type Layered Titanate into Its 1D Nanowire Form with Enhancement of Cation Exchange and Photocatalytic Performance. Inorganic Chemistry 2019, 58 (12), 7989-7996.
Ma, J.; Reeves, K. G.; Porras Gutierrez, A.-G.; Body, M.; Legein, C.; Kakinuma, K.; Borkiewicz, O. J.; Chapman, K. W.; Groult, H.; Salanne, M.; Dambournet, D., Layered
Lepidocrocite Type Structure Isolated by Revisiting the Sol-Gel Chemistry of Anatase TiO2: A New Anode Material for Batteries. Chemistry of Materials 2017, 29 (19), 8313-8324.
Reeves, K. G.; Ma, J.; Fukunishi, M.; Salanne, M.; Komaba, S.; Dambournet, D., Insights into Li+, Na+, and K+ Intercalation in Lepidocrocite-Type Layered TiO2 Structures. ACS Applied Energy Materials 2018, 1 (5), 2078-2086.
Tominaka, S.; Yamada, H.; Hiroi, S.; Kawaguchi, S. I.; Ohara, K., Lepidocrocite-type titanate formation from isostructural prestructures under hydrothermal reactions: observation by synchrotron X-ray total scattering analyses. ACS omega 2018, 3 (8), 8874-8881.
Naguib, M.; Kurtoglu, M.; Presser, V.; Lu, J.; Niu, J.; Heon, M.; Hultman, L.; Gogotsi, Y.; Barsoum, M. W., Two Dimensional Nanocrystals Produced by Exfoliation of Ti₃AlC₂. Advan. Mater. 2011, 23, 4248-4253.
Coleman, J. N.; Lotya, M.; Arlene O'Neill; Bergin, S. D.; King, P. J.; Khan, U.; Young, K.; Gaucher, A.; De, S.; Smith, R. J.; Shvets, I. V.; Arora, S. K.; Stanton, G.; Kim, H.-Y.; Lee,
K.; Kim, G. T.; Duesberg, G. S.; Hallam, T.; Boland, J. J.; Wang, J. J.; Donegan, J. F.; Grunlan,
J. C.; Moriarty, G.; Shmeliov, A.; Nicholls, R. J.; Perkins, J. M.; Grieveson, E. M.; Theuwissen,
K.; McComb, D. W.; Nellist, P. D.; Nicolosi, V., Two-Dimensional Nanosheets Produced by Liquid Exfoliation of Layered Materials. Science 2011, 331, 568
Badr, H. O.; El-Melegy, T.; Carey, M.; Natu, V.; Hassig, M. Q.; Johnson, C.; Qian, Q.;
Li, C. Y.; Kushnir, K.; Colin-Ulloa, E.; Titova, L. V.; Martin, J. L.; Grimm, R. L.; Pai, R.; Kalra,
V.; Karmakar, A.; Ruffino, A.; Masiuk, S.; Liang, K.; Naguib, M.; Wilson, O.; Magenau, A.; Montazeri, K.; Zhu, Y.; Cheng, H.; Torita, T.; Koyanagi, M.; Yanagimachi, A.; Ouisse, T.; Barbier, M.; Wilhelm, F.; Rogalev, A.; Björk, J.; Persson, P. O. Å.; Rosen, J.; Hu, Y.-J.; Barsoum, M. W., Bottom-up, scalable synthesis of anatase nanofilament-based two-dimensional titanium carbo-oxide flakes. Mat. Today 2022, 54, 8-17.
Klie, R. F.; Gulec, A.; Guo, Z.; Paulauskas, T.; Qiao, Q.; Tao, R.; Wang, C.; Low, K. B.; Nicholls, A. W.; Phillips, P. J., The new JEOL JEM-ARM200CF at the University of Illinois at Chicago. Crystal Research and Technology 2014, 49 (9), 653-662.
Phillips, P. J.; Klie, R. F., On the visibility of very thin specimens in annular bright field scanning transmission electron microscopy. Applied Physics Letters 2013, 103 (3).
Findlay, S. D.; Shibata, N.; Sawada, H.; Okunishi, E.; Kondo, Y.; Yamamoto, T.; Ikuhara, Y., Robust atomic resolution imaging of light elements using scanning transmission electron microscopy. Applied Physics Letters 2009, 95 (19), 191913-3.
Pennycook, S. J.; Boatner, L. A., Chemically Sensitive Structure-Imaging With A Scanning-Transmission Electron-Microscope. Nature 1988, 336 (6199), 565-567.
Nellist, P. D.; Pennycook, S. J., Incoherent imaging using dynamically scattered coherent electrons. Ultramicroscopy 1999, 78 (1-4), 111-124.

Here, we report on the large-scale synthesis of TiO₂-based one-dimensional (1D) nanofilaments (NFs) using a facile, bottom-up, one pot, solution-processing synthesis protocol. Our method entails mixing TiB₂ commercial powders with tetramethylammonium hydroxide in plastic bottles at 80° C. for a few days under ambient pressure. The resulting lepidocrocite titania-based 1D NFs, with cross sections ˜5×7 Å² self-assemble in a plethora of nanostructures, viz. pseudo-two-dimensional flakes, nanobundles, or mesoporous particles, when dispersed in different solvents. The mesoporous particles are free-flowing and near-spherical with diameters in the ≈13 μm range. The formation of the NFs occurs from the precursors' surfaces inwards, allowing for the formation of core-shell configurations. The intercalating TMA⁺ cations between the NFs can be readily exchanged with H₃O, Li⁺, Na⁺, Mg²⁺, Mn²⁺, Fe²⁺, Co²⁺, Ni²⁺ or Zn²⁺ cations. With zeta-potentials values of ≈−50 mV, the resulting materials form quite stable colloids in water.

Additional Disclosure—II

Titania (TiO₂) nanostructures have been, and remain, of significant research interest due to their unique physical and chemical properties as well as their potential application in a wide range of fields including paint pigment, catalysis, photocatalysis, photoluminescence, gas sensors, solar and fuel cells among many others. Amongst commercially available nanostructured titania, Evonik's Aeroxide TiO₂ P25 (formerly sold by Degussa), and hereafter referred to as P25, is used. P25 synthesized via flame pyrolysis of TiCl₄, is attractive because of its high photocatalytic activity.

In many ways, P25 has been, and is still considered the gold standard for TiO₂-based catalytic and photocatalytic applications. Its major drawback, however, is its cost; flame pyrolysis is a relatively expensive process. Arguably, had P25 been cheaper it would have found many more applications. Thus, we developed a significantly cheaper process to make one dimensional (1D) titania, that we have shown performs better than P25 in a number of applications.

The recipe entails reacting precursor powders with tetramethylammonium hydroxide (TMAH) aqueous solutions—in polyethylene bottles—in the 50° C. to 85° C. temperature range for a few days. In one case, we reacted 5 different Mn-containing powders, such as Mn₃O₄, Mn₂O₃, MnB, etc., in TMAH aqueous solutions for a few days and converted them into birnessite-based two-dimensional (2D) sheets with thicknesses of 2±0.4 nm that were ≈200 nm across. These 2D birnessite sheets were remarkably crystalline. They, in turn, demonstrated enhanced electrochemical reactivity for both reversible O₂ electrocatalysis and supercapacitor applications.

Following the same protocol, immersing FeB powders in alkaline aqueous solutions (TMAH; tetramethylammonium hydroxide, TBAH; or potassium hydroxide, KOH) produced ferromagnetic Fe₃O₄ nanoparticles with an average particle size of ˜15 nm.

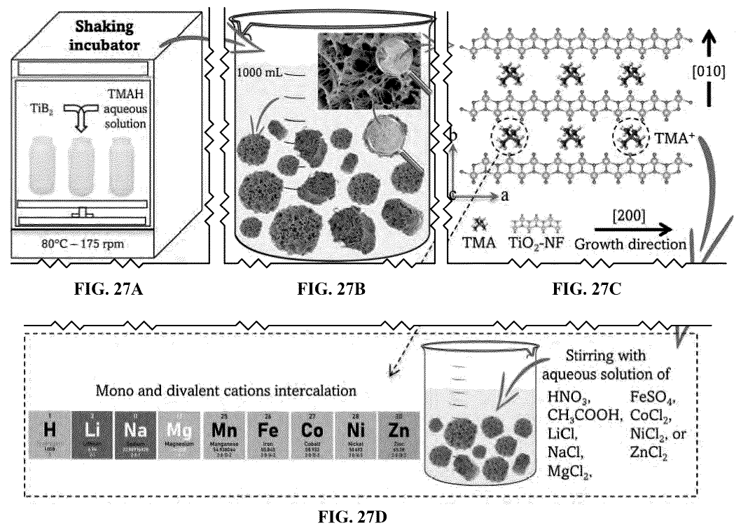

In another example, we converted, cheap, earth abundant, water-insoluble Ti-bearing precursors including TiC, TiN, TiB₂, among others, into 1D nanofilaments, NFs. The recipe entails reacting Ti-bearing precursor powders with, again, TMAH aqueous solutions—in polyethylene bottles—in the 50° C. to 85° C. temperature range for a few days. We concluded that the 1D NFs crystallize in a lepidocrocite-type TiO₂-based structure (FIG. 27c).²⁷ Henceforth, these lepidocrocite 1D NFs will be referred to 1DL. The cross-sections of our 1DL NFs are ≈5×7 Å². It is the extreme size led us to conclude that a quantum size effect was responsible for the record band gap energy, E_{g}≈4 eV, for a bottom-up processed, titania-based material.

We concluded several studies of our 1DLs showing them to be unique and better performing than P25. We showed that the photochemical hydrogen production rates when exposed to the equivalence of one sun, were about an order of magnitude higher than P25 tested under identical conditions. In the field of water purification, we showed that our 1DLs can adsorb record values of uranium (U⁴⁺) rendering water contaminated by this actinide potable. Lastly, composites of our 1DLs with a repairable, dynamic covalent thiolyne network resulted in a 500 times increase in the modulus at 60 wt % filler when compared to pristine polymer.

After reaction and washing with ethanol, EtOH, to ˜ pH 7 and then washing with water, pseudo-two-dimensional, p-2D were produced upon filtration. The reason we refer to them as ‘pseudo’ is because the flakes—comprised of 1DL NFs—are only apparently 2D. We showed that these p-2D flakes are present in the colloid, even at short reaction times. It follows that water exerts a strong driving force aligning the 1DLs normal to their [200] growth direction. This self-alignment first leads to the formation of nano-bundles and μ-fibers that in turn self-align into p-2D flakes. Regardless of the experimental conditions or final morphologies, the 1DL NFs remain the essential building blocks.

Here, we show that if the 1DL NFs are dried while in ethanol (i.e. without dispersing in water) they form spherical, mesoporous particles, henceforth referred to as MPPs, with diameters that are comparable to those of the precursor powder. In this work we: i) Report on large scale synthesis (100 g batches) of MPPs that are comprised of 1DL NFs; ii) Shed light on the mechanisms that lead to MPPs formation; iii) Show that, like in other layered titanates, the space between the NFs is eminently ion exchangeable. To that effect, we can readily replace the TMA⁺ cations present after the reaction stage by H⁺, Li⁺, Na⁺, Mg²⁺, Mn²⁺, Fe²⁺, Ni²⁺, Co²⁺, or Zn²⁺ cations (see schematic in FIG. 27d). iv) Measure the surface charges, and hydrodynamic radii of MPPs intercalated with TMA⁺ or Li⁺ ions.

The starting precursor chosen is TiB₂ because, compared to TiC and TiN, it is the most reactive. A large batch of TiB₂ powders can be almost fully converted to 1DLs in ≈3 d at 80° C.

Results and Discussion

Precursors were reacted with TMAH using hot plates and magnetic stirrers. To prepare batches as large as 100 g at once we used a temperature-controlled shaking incubator. The experimental details can be found in the experimental procedures section. In brief, we shake 100 g of TiB₂ commercial powders with ˜1 L of a 25 wt. % TMAH aqueous solution at 80° C. for 1 to 5 days, d, in a temperature-controlled shaking incubator (FIG. 27a). In one set of experiments, the resulting powders were washed with EtOH multiple times using an overhead mixer till the pH was ˜7 (FIG. 27b), before they are left to dry at 50° C. in open air.

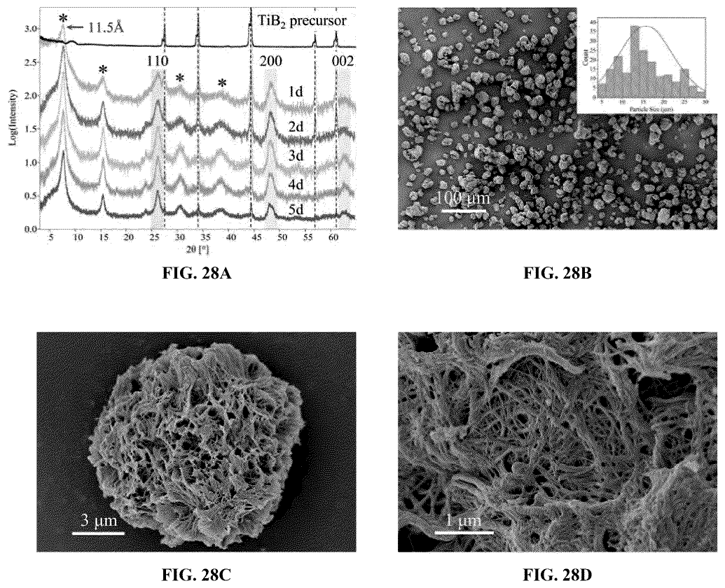

Preliminary results indicated that when the EtOH washed samples were placed in water the MPPs did not retain their morphology. If, however, the TMA⁺ cations were replaced with Li⁺ they did. To explore this idea, in one set of experiments, EtOH washed powders were stirred—while wet—in aqueous salt solutions of 0.5 M LiCl, 5 M LiCl, 0.5 M NaCl or 5 M NaCl (FIG. 28d). The powders were then rinsed with DI water a few times to remove any residual salts before drying at 50° C. in open air.

To assess the capability of intercalating various mono- and divalent cations between the NFs, both the EtOH and the EtOH/LiCl washed powders were further treated in one of the following aqueous solutions (FIG. 27d): i) 0.1 M nitric acid, HNO₃, 0.5 M acetic acid or, ii) 0.02 M aqueous solution of one of the following salts: MgCl₂, MnCl₂, FeSO₄, CoCl₂, NiCl₂ or ZnCl₂. In all cases, after being immersed in the salt solutions the powders were washed a few times with DI water and dried at 50° C. in open air for 24 h.

Characterization of 1DL NFs

Before proceeding further, one can review the X-ray diffraction (XRD) signature of our 1DL NFs. The reaction time dependencies of the XRD patterns—on a log scale—are shown in FIG. 28a. In a typical 1DL XRD patterns (FIG. 28a), three types of peaks exist. The first are due to unreacted precursor—TiB₂ in this case—denoted by dashed black lines in FIG. 28a. These are useful in that they can be used as internal standards. The second, 010 peak at low 2q angles—and its higher, 0k0 reflections denoted by asterisks—reflect the d-spacing values between NFs stacked along the b-direction. Like in other 2D materials, these peak locations are strong functions of what cations are intercalated between them. Crucially, here the distance is not between flakes but between NFs. Based on the results shown in FIG. 28a, it clear that after the first day, the d-spacings are no longer functions of reaction time.

The (110) peak located, around ˜26° 2q (denoted by grey band in FIG. 28a) is a weak function of the cations between the NFs. The last, and most fundamental peaks, are those at 2q values of ˜48° and 62°—denoted by red bands in FIG. 28a—indexed as 200 and 002 of the lepidocrocite structure, respectively. These peaks are useful because they are crystallographic in nature and should—as confirmed herein—be totally independent of what cations are in the system. It is from these 2q values that we obtain the a- and c-lattice parameters of lepidocrocite, viz. 3.7 Å and 2.9 Å.

As just noted, FIG. 28a shows the time dependencies of the XRD patterns of the TiB₂ precursor powder (top pattern in FIG. 28a) as well as those reacted at 80° C. for 1 d to 5 d, shown from top to bottom in FIG. 28a. As the reaction times increased from 1 to 3 d the intensity of the TiB₂ diffraction peaks gradually decreased, whereas the 1DL ones became dominant. The latter is again recognized by the two red bands in FIG. 28a, and the low angle 010 peak at 9° 2q (and its higher order peaks). From the latter, the distance between the 1DL NFs is calculated to be 11.5 Å. These results suggest that after 3 d, the conversion of the precursors into 1DL powders is complete. However, to minimize the fraction of unreacted precursor we ran the reaction for 5 d. All characterizations were carried out on powders reacted for 5 d (blue curve in FIG. 28a).

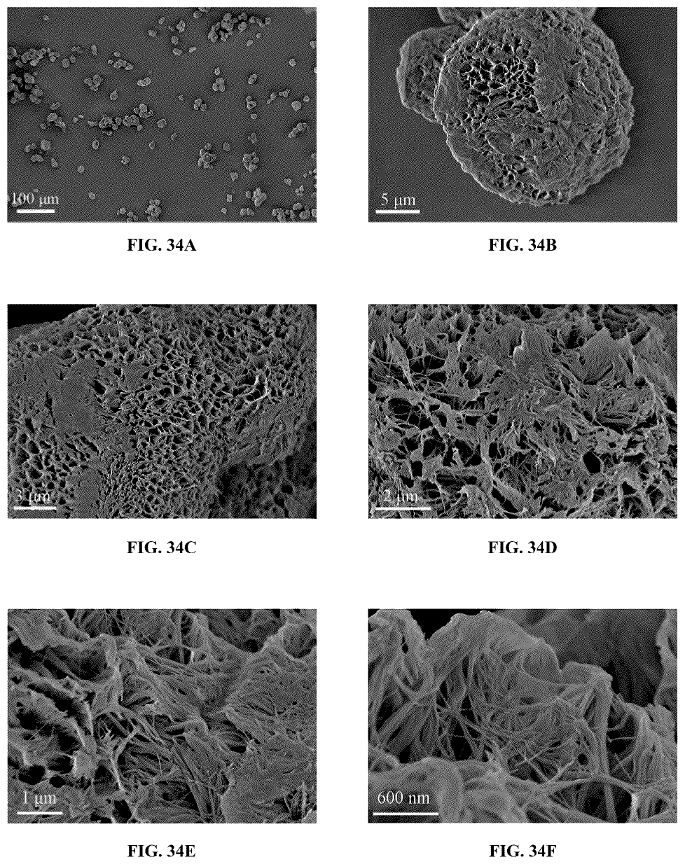

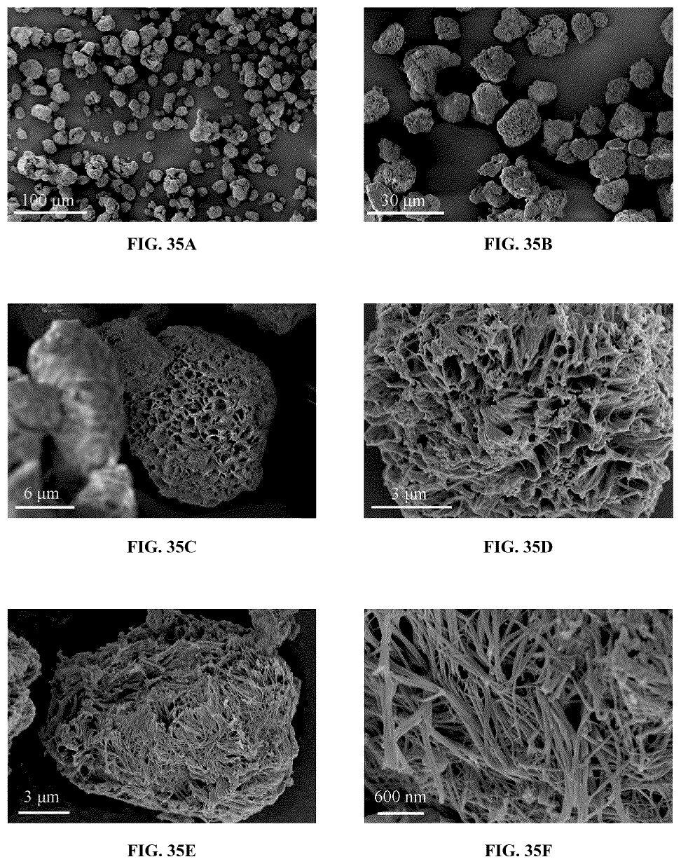

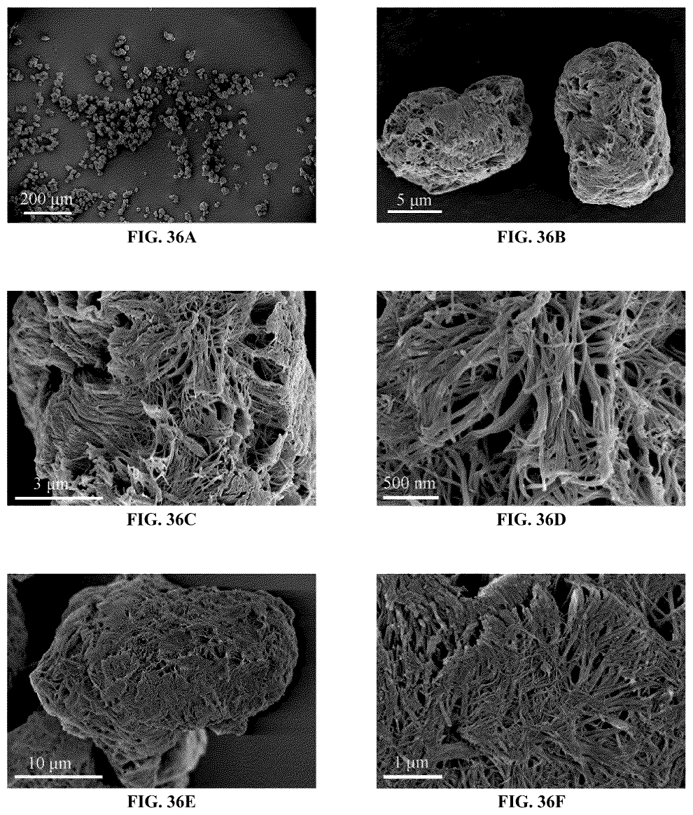

Scanning electron microscope (SEM) micrographs of typical MPPs after EtOH washing to pH 7, are shown in FIGS. 28b-d. At the millimeter scale, the powders appeared to be well dispersed with little to no aggregation observed (FIG. 28b). At higher magnification, the MPPs are porous, mostly spherical, with an average size of ˜13 μm (inset in FIG. 28b) and comprised of entangled 1DL NF bundles (FIGS. 28c and d). The shape and size of the MPPs are quite consistent over 50 different batches prepared and characterized to date. Other micrographs are shown in FIGS. 34-36. To summarize this section: After washing with EtOH, the 1DL NFs self-assemble into separate, non-agglomerated, free-flowing MPPs, in the 5 to 30 μm particle size range (FIG. 2b and inset).

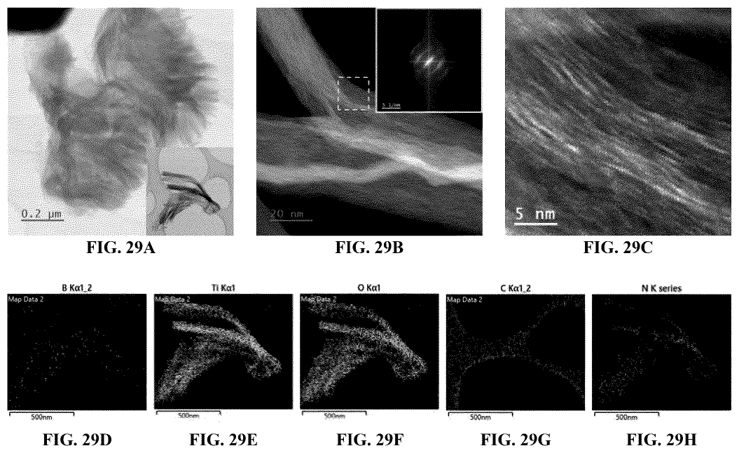

To better understand the MPP structure, we imaged them in a HR-STEM (FIGS. 29a-c). If one assumes that the fiber bundle shown in FIG. 29a is a single MPP, then its diameter is about 1 μm. At higher magnifications, it is obvious that the bundle is, in turn, comprised of a multitude of 1DL NFs (FIGS. 29b and c). A low angle annular dark field (LAADF) image (FIG. 29c) shows that the building unit remains NFs, 2 Ti-atoms wide, with a zigzag pattern. Fast Fourier transforms (FFT) pattern of the bundles (inset in FIG. 29b) resulted in 2 main arcs—confirming the 1D nature of our NFs—with d-spacings corresponding to XRD peaks at 2θ values of ˜26° and ˜48° (grey and red dashed bands in FIG. 28a). Also, the arcs bisect the [100] growth direction.

Turning to the composition of the 1DL bundles, we obtained STEM-EDS maps of the MPP shown in inset in FIG. 29a. Only trace amounts of B (<1%) were detected (FIG. 29d) which is consistent with the almost complete conversion of TiB₂ into 1DL NFs and the effectiveness of our process in washing out any B-containing reaction products. From a scaling point of view, these powders were neither centrifuged nor filtered. Note the uniform distribution of Ti and O atoms (FIGS. 29e-f). The calculated atomic percent ratios of Ti and O are 24.5% and 49.5% respectively, consistent with a TiO₂ stoichiometry. The lacey carbon support is visible in the C map (FIG. 29g) and overshadows the C in the 1DL. The uniform distribution of N on the MPPs supports the fact that TMA⁺ ions are intercalated between the NFs (FIG. 29h). It is difficult to quantify the N amount present because of the large overlap between the N K- and the Ti L-edges.

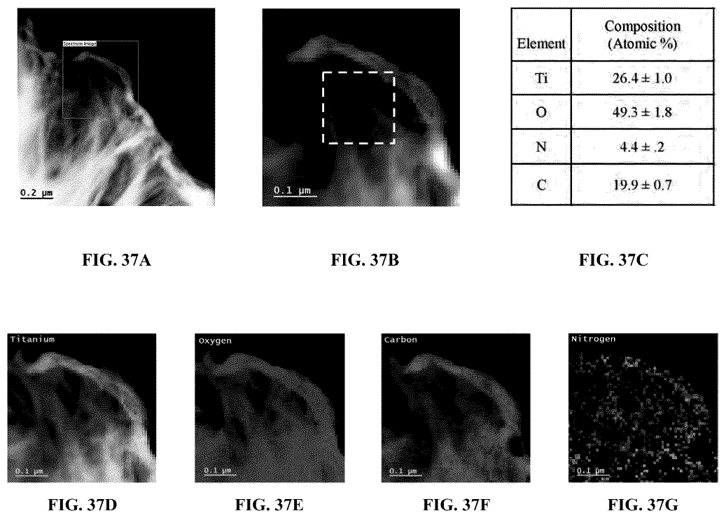

To solve this problem, and obtain a better handle on the C-content, we acquired electron energy loss spectroscopy (EELS) spectra where the Ti and N peaks are easily distinguishable, and the elemental compositions can be calculated using Hartree-Slater cross section models. To further reduce the contribution of surface hydrocarbons, we in situ cooled the sample using a liquid nitrogen, N₂, cold stage. The elemental maps derived from core loss spectra (FIG. 37) show Ti and O concentrations, again, consistent with a TiO₂ stoichiometry. The C to N ratio is 4.5, which is consistent with the expected ratio of 4 for TMA cations.

Chemical Stability and Cationic Exchange of 1DL NFs

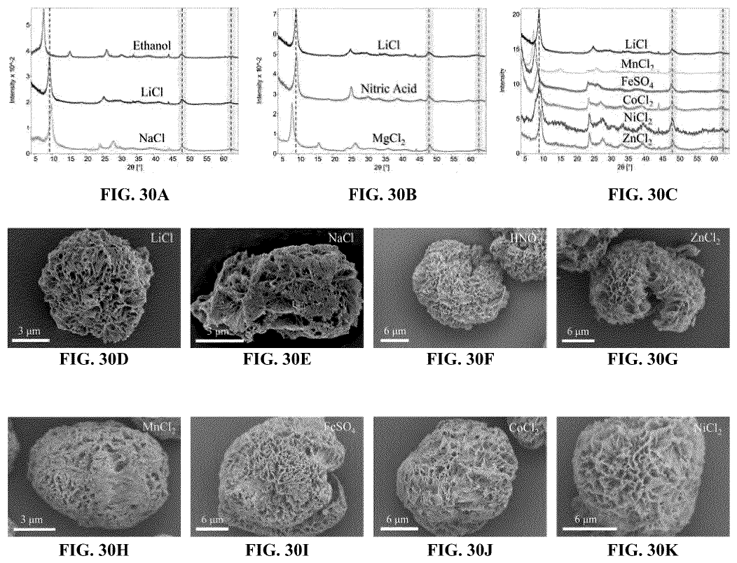

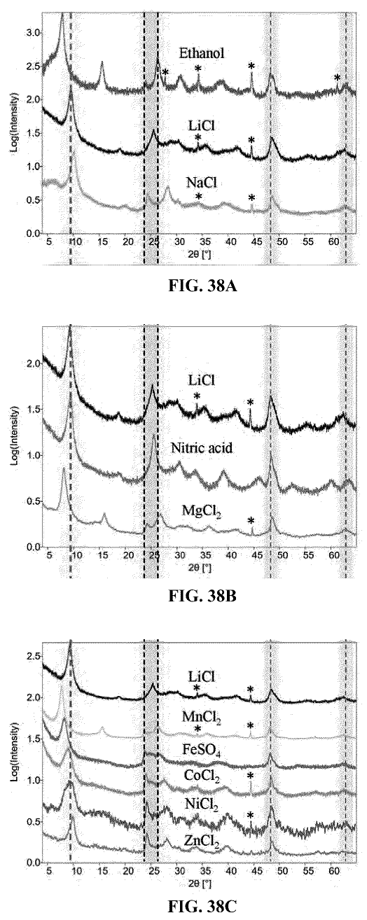

We established that we could readily ion exchange the TMA⁺ cations—present after EtOH washing to pH≈7—with Li⁺. Here we show that the Li⁺ cations can, in turn, be replaced by the following cations: H⁺, Na⁺, Mg²⁺, Mn²⁺, Fe²⁺, Co²⁺, Ni²⁺, and Zn²⁺. The XRD patterns after ion exchange are plotted in FIGS. 30a-c. Typical SEM micrographs of the MPPs are shown in FIGS. 30d-k. FIGS. 38a-c plot the same data shown in FIG. 30a-c, respectively, but on a log scale.

As noted in the experimental section, after ion exchange all powders were rinsed with DI water multiple times and allowed to dry at 50° C. in open air before any further characterization. In all cases, the absence of all but 1DL XRD peaks (FIGS. 30a-c and 38a-c) confirm that we successfully eliminated most of the unreacted salts and unwanted reaction products. This also implies that the unwanted reaction products are water soluble.

After EtOH washing (blue patterns in FIGS. 30c and 38a), the first peak at ˜7.5° 2θ, corresponds to a 010 basal reflection for which the d˜11.5 Å. This d-spacing is a measure of the thicknesses of the NFs along the b-direction together with any intercalated ions and/or water. Because we know from DFT calculations that the thickness of one NF along the b-direction is ≈7 Å, it follows that the TMA⁺ and H₂O thickness is 4.5 Å, which is reasonable.

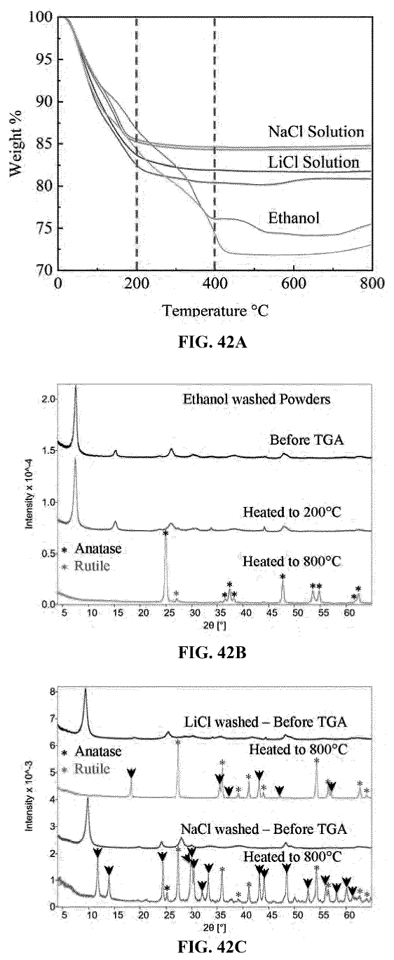

After washing with LiCl or NaCl solutions (black and green patterns, respectively, in FIGS. 30a and 38a), the d-spacing shrinks to 9.5 Å and 9.0 Å, confirming that the TMA⁺ ions were successfully exchanged with Li⁺ or Na⁺ ions, respectively. The slightly higher d-spacing associated with Li⁺-intercalated powders, as compared to Na⁺, probably reflects the former's slightly larger hydration shell (see TGA results in FIG. 42). Again, assuming the thickness of one NF along the b-direction is ˜7 Å, it follows that the Li⁺+H₂O and Na⁺+H₂O thicknesses are 2.5 Å and 2.0 Å, respectively.

FIG. 30b shows XRD patterns for powders that were first washed with LiCl solution then treated in HNO₃ or MgCl₂ aqueous solutions. The XRD patterns for the remaining cations are plotted in FIG. 30c. The initial d-spacing was ≈9.5 Å (top black pattern in FIGS. 30b and c) for Li⁺-intercalated NFs. When stirred in 0.1 M nitric acid, the 9.5 Å-peak slightly shifted to ≈9.3 Å (red pattern in FIG. 30b) suggesting the successful intercalation of hydronium ions between the NFs. Likewise, stirring the Li⁺-intercalated NFs in a 0.02 M MgCl₂ solution (green pattern in FIG. 30b), resulted in a d-spacing expansion from 9.5 Å to 10.8 Å which we take as evidence for the exchange of Li⁺ ions with Mg²⁺.

The situation is quite similar for other divalent cations (Mn²⁺, Fe²⁺, etc.). Cationic exchange between Li⁺, on one hand, and Mn²⁺, Fe²⁺, Co²⁺, Ni²⁺, and Zn²⁺, on the other hand, occurs when LiCl washed powders were further treated in 0.02 M aqueous solutions of the targeted cations. As shown in FIG. 30c, the resulting d-spacings after cationic exchange are 11.4 Å, 10.7 Å, 9.8 Å, 9.4 Å, and 8.9 Å for Mn²⁺, Fe²⁺, Co²⁺, Ni²⁺ and Zn²⁺-intercalated 1DL NFs, respectively.

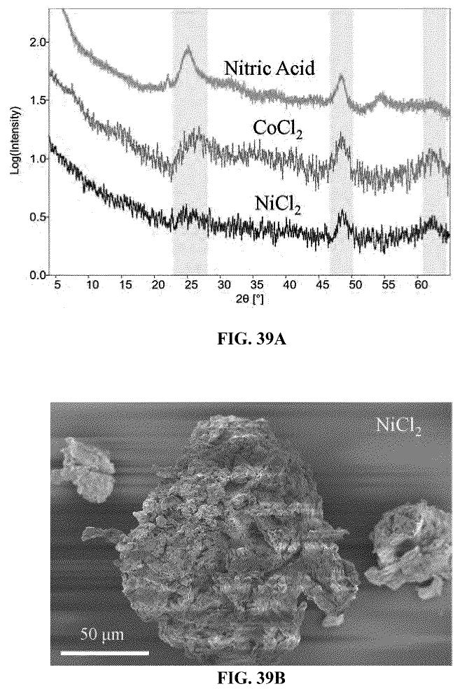

Interestingly, when EtOH washed powders were directly—i.e. without first exchanging the TMA⁺ with Li⁺—immersed in HNO₃, CoCl₂ or NiCl₂ aqueous solutions for 24 h or longer, the low angle peaks vanished (FIG. 39a) implying that any order along the b-stacking direction was destroyed. The only remaining peaks were the three non-basal reflections at 2θ values of ≈26°, ≈48° and ≈62° (red bands in FIG. 39a). A SEM micrograph of a NiCl₂-washed sample (FIG. 39b) confirms a change in the MPPs morphology into nanometer-sized, slightly porous agglomerates.

To summarize this section, the interfilamentous space between the 1DL NFs is quite readily exchangeable with monovalent (H₃O, Li⁺, and Na⁺) and divalent cations (Mg²⁺, Mn²⁺, Fe²⁺, Co²⁺, Ni²⁺, and Zn²⁺). The corresponding XRD patterns clearly demonstrated the successful intercalation of these cations by the slight shifting of low angle (<10°) 2θ, peaks. One can note here that the non-basal peaks located at ˜48° and 62° 2θ (red dashed lines/bands in FIGS. 30a-c and 38a-c) perfectly lined up in all cases regardless to the nature of the intercalants. This result indirectly confirms the correctness of assigning these peaks to the 1DL backbone (see below).

Surface Charge and Hydrodynamic Size of NFs Agglomerates

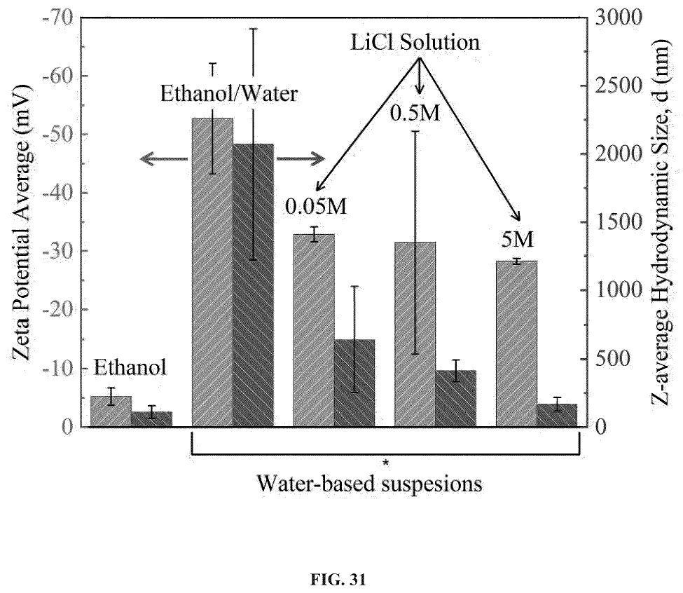

One objective of this work was to investigate the surface charge and aggregation behavior of the prepared NFs and NFs-based MPPs intercalated with TMA⁺ or Li⁺ cations. To that effect, we measured the zeta potentials, ζ, and hydrodynamic diameters, d_{H}, for powders, once after EtOH washing and another after washing with LiCl aqueous solutions. Note that apart from the first sample (top row in Table 1) that was washed and measured in EtOH, all other samples were washed with solvents/solution mentioned in first column in Table 1, then dispersed in DI water for ζ-potential and d_{H} measurements. All measurements were repeated 3 times; results were averaged (see FIG. 31) and summarized in Table 1 below.

TABLE 1
Summary of ζ-potentials and Z-average hydrodynamic size,
d_{H}, values measured as a function of
washing media shown in left-hand column.

| | | Zeta Potential | | | |
|---|---|---|---|---|---|
| | | Average (mV) | | d_{H} (nm) | |
| Washing solution | | Average | Std. D | Average | Std. D |
| EtOH | | −5 | 1.5 | 111 | 45 |
| EtOH [symbol] H₂O | | −53 | 9.5 | 2071 | 850 |
| EtOH [symbol] | 0.05M LiCl | −33 | 1.3 | 640 | 390 |
| LiCl [symbol] H₂O | 0.5M LiCl | −31 | 19 | 414 | 80 |
| | 5.0M LiCl | −28 | 0.5 | 168 | 50 |

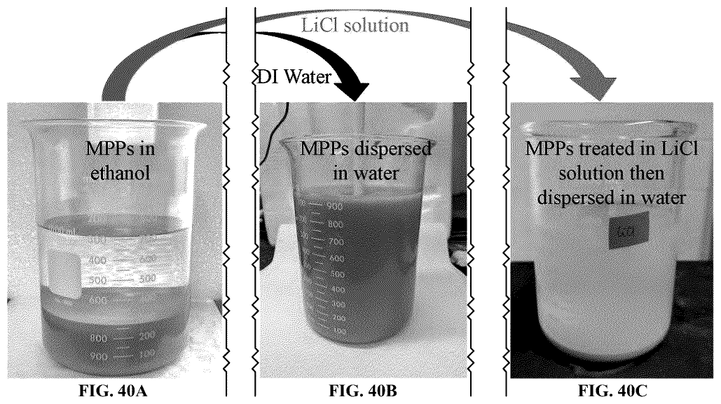

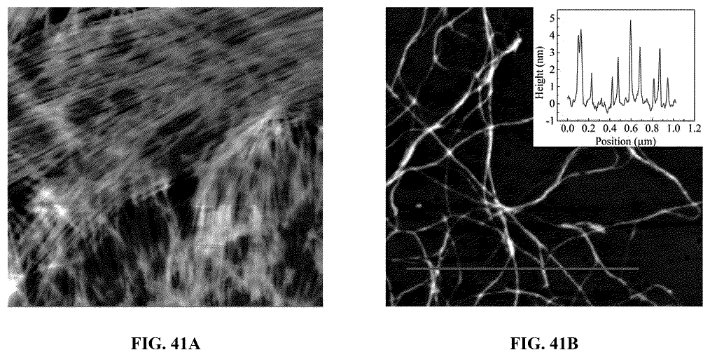

When the solvent was EtOH, the ζ-potential of the MPPs was −5±1.5 mV, which explains colloid instability in this solvent; the MPPs settled to the bottom of the container (FIG. 40a) and only particles/entities with d_{H} of ˜0.1 μm remained suspended (right axis in FIG. 31). When the MPPs were dispersed in DI water, a ζ-potential of ˜−53±10 mV is recorded which, in turn, resulted in highly stable colloidal suspensions (see FIG. 40b). The high surface charge stabilized agglomerates of 1DL NFs as large as 2±0.8 μm (right axis in FIG. 31). The size of these aggregates is a function of colloidal concentration. Upon washing the MPPs—right after EtOH washing—with LiCl aqueous solutions, the ζ-potential values were reduced from −53±10 mV in DI water to −33±1.3 mV in 0.05 M LiCl solution (FIG. 31 and Table 1). As the molarity of the LiCl solution increased to 0.5 M and to 5 M, the ζ-potentials changed slightly to ≈−28±0.5 mV (FIG. 31 and Table 1 above).

When the MPPs (after washing with ethanol to neutral) were dried at 50° C. then redispersed in DI water there was a noticeable increase in the pH up to values of ˜10. That can be caused by the uptake of protons by O⁻ and/or OH⁻ surface terminations. In our case, however, we did not observed any changes in the low angle peaks suggesting that the surface oxygen atoms are hydroxylated through protonation.

To summarize, after neutralization in EtOH, the ζ-potential was slightly negative and most of MPPs settled (FIG. 40c). Only aggregates <1.4 μm in size were suspended in the EtOH (FIG. 31). Upon washing with water, at ≈−50±10 mV, the ζ-potential was quite negative which explains the colloidal stability in water.

The major drop in surface charge from DI water to 0.05M LiCl solution basically corresponds to Li⁺ ions electrostatic adsorption on the NFs negatively charged surfaces. Which in turn resulted in a decrease in the electrical double layer and a consequent drop in the repulsive electrostatic interaction between the NFs. The subsequent drop in surface charge as the molarity increased from 0.05 M to 5 M (FIG. 31 and Table 1) is further evidence for the decrease in the thickness of the diffuse layer of the 1DL NFs as the ionic strength increased.

Thermal Stability of 1DL NFs

The thermal stabilities of our MPPs were explored using thermogravimetric analysis (TGA) in Ar up to 800° C. of NFs intercalated with TMA⁺, Li⁺ or Na⁺. All powders were dried at 50° C. in open air for 24 h prior to the TGA experiments. The TGA results were different for EtOH and salt washed samples. FIG. 42a. The latter lose weight until ≈250° C., before levelling off. The weight change at that temperature is predominantly due to loss of H₂O.²⁶ Washing with LiCl results in a slightly higher (18%) weight loss than washing with NaCl (15%) (FIG. 42a).

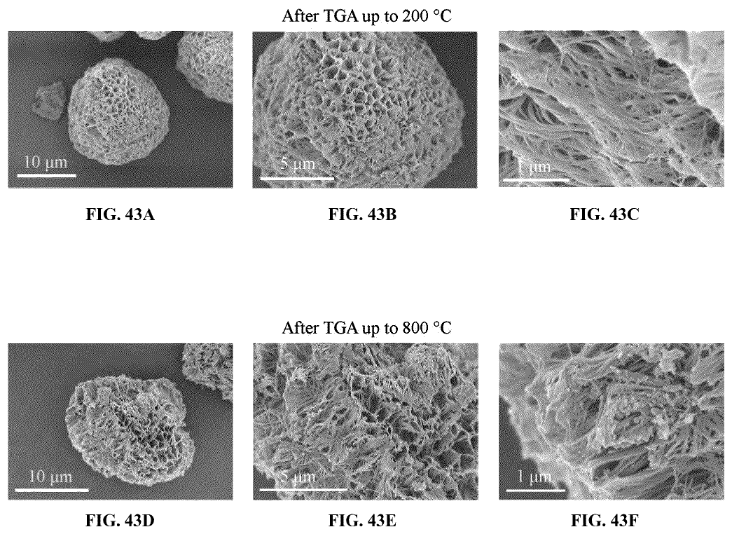

Heating EtOH-washed, TMA⁺-intercalated, NFs to 200° C., resulted in a ≈15% mass loss mostly probably due to residual EtOH solvent from washing (FIG. 42a). Upon further heating, at ≈350° C., there was another mass drop of ≈15% which is most probably due to the loss of hydration layers and intercalated TMA cations between the NFs (FIG. 42a). Heating to 200° C. does not change the XRD patterns (FIG. 42b). At higher magnifications (FIG. 43f) some of the NFs started spheroidizing/coarsening.

Heating the LiCl-washed MPPs led to one mass loss event of ≈17 wt. % up to ≈200° C. (FIG. 42a), that most likely corresponds to the loss of hydration layers associated with Li cations and/or dehydroxylation. The case for the NaCl-washed MPPs is quite similar, in that, the observed the mass loss, up to ≈200° C., was about 14 wt. % (FIG. 42a). The higher mass loss for the LiCl washed samples (17%) suggests that the number of water molecules associated with the Li ions are slightly higher than those of Na one, where weight loss is ≈15%. When the powders were further heated to 800° C., no further weight loss was observed.

XRD patterns, however, show that the Li⁺-intercalated NFs transformed to a mixture of rutile and lithium titanate, Li₂Ti₂O₄ (green pattern in FIG. 42c). After calcination at 800° C., the Na⁺-intercalated NFs converted to a mixture of rutile and sodium titanate, Na²Ti₆O₁₃.

1DL NFs Morphologies, Formation Mechanism and Self-Assembly

Where the reaction occurs and its nature

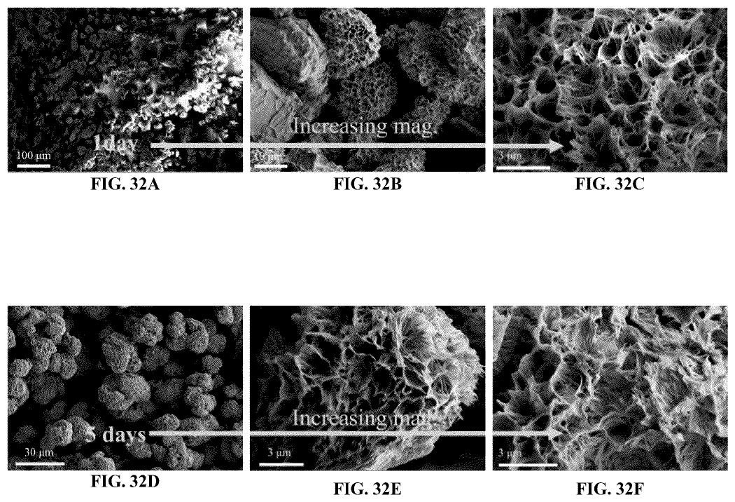

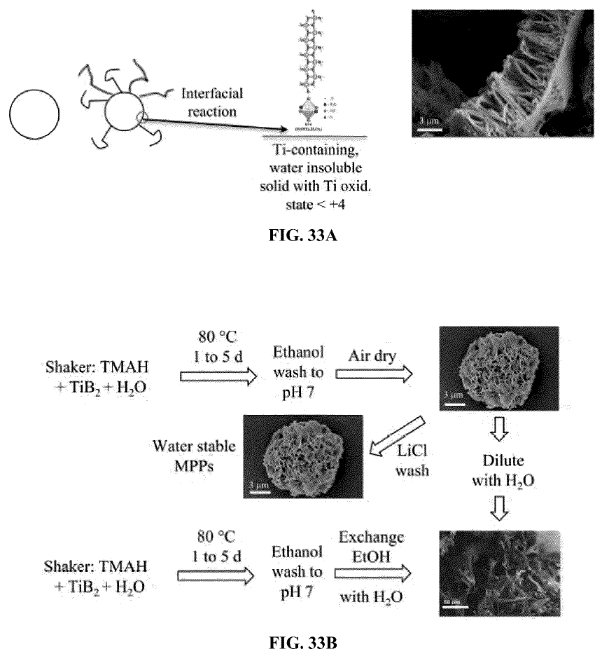

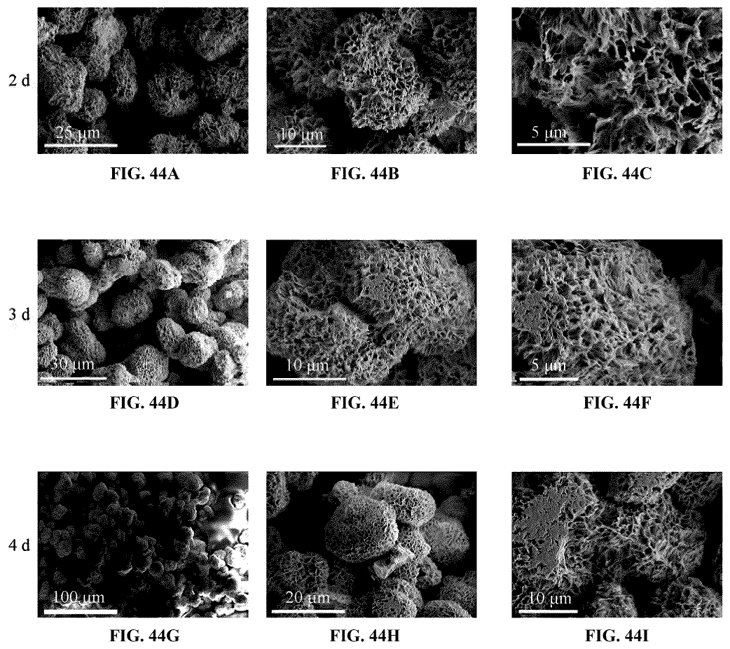

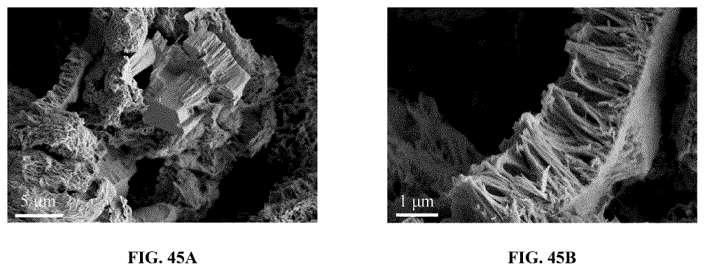

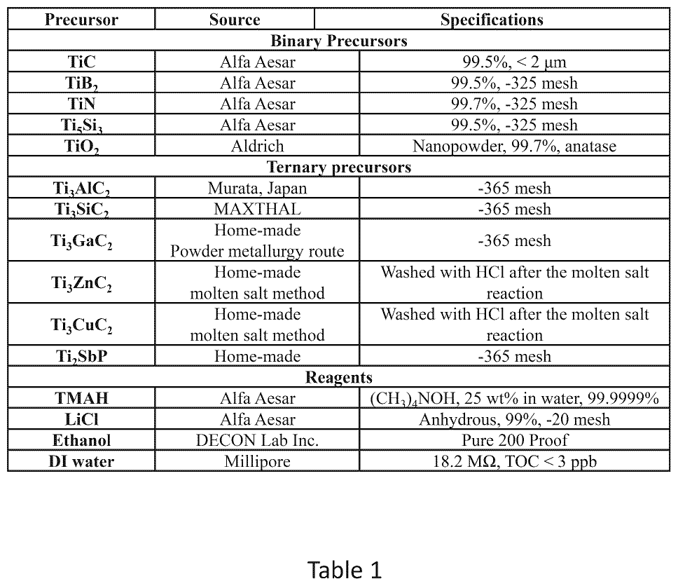

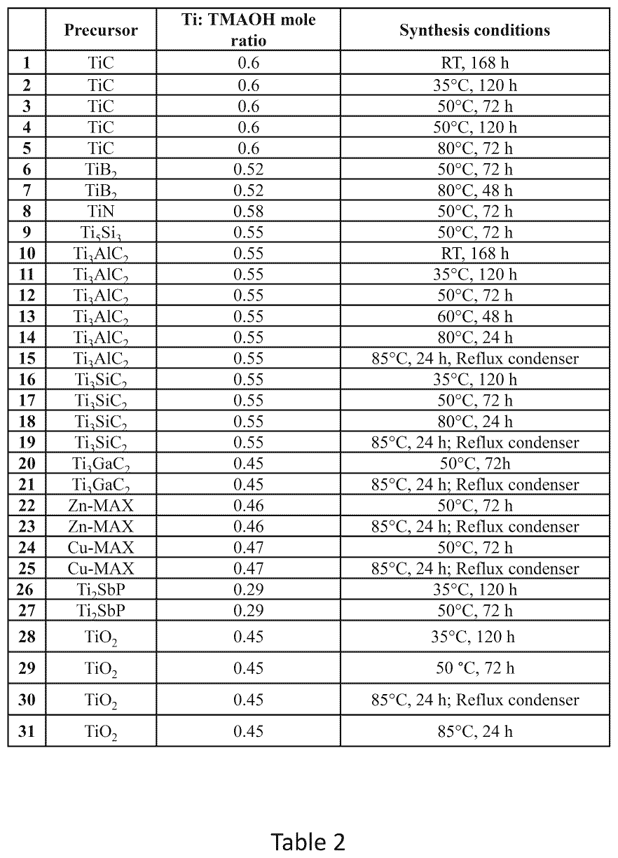

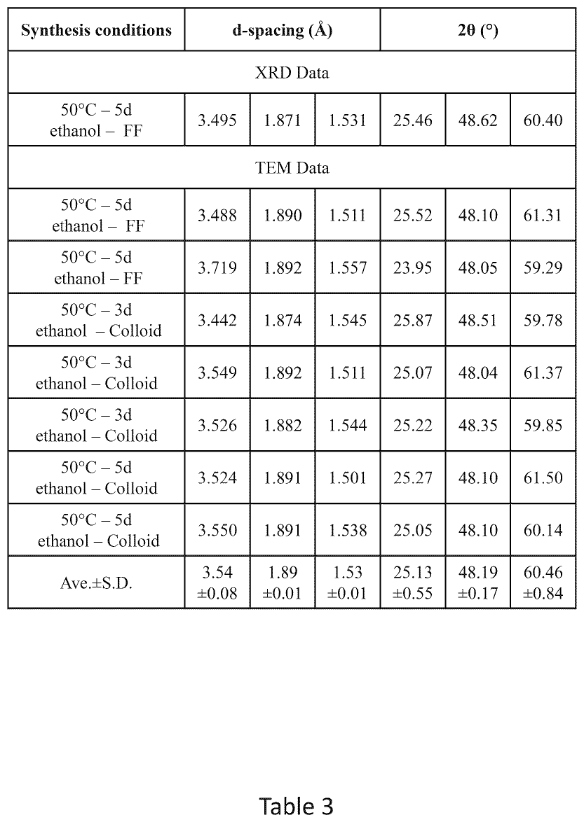

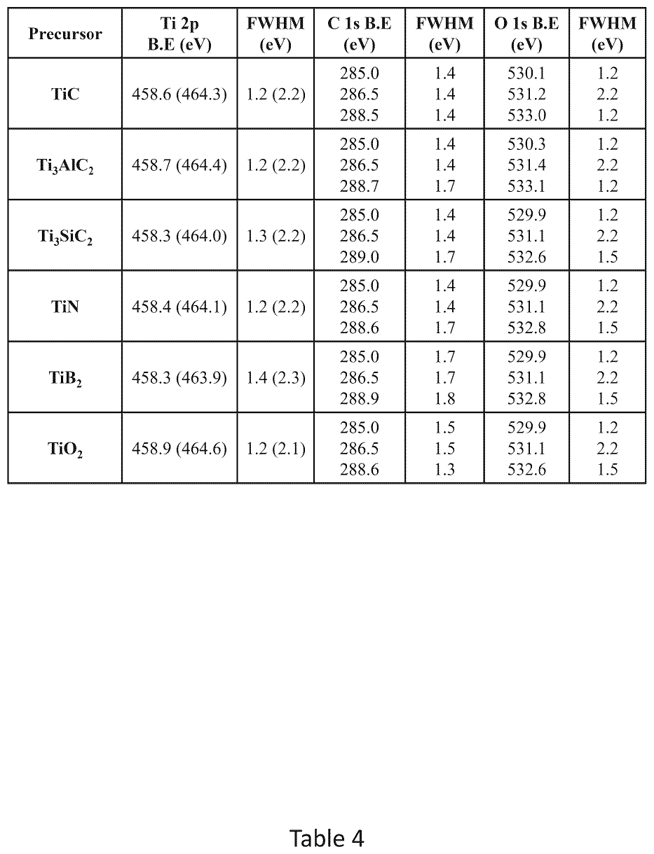

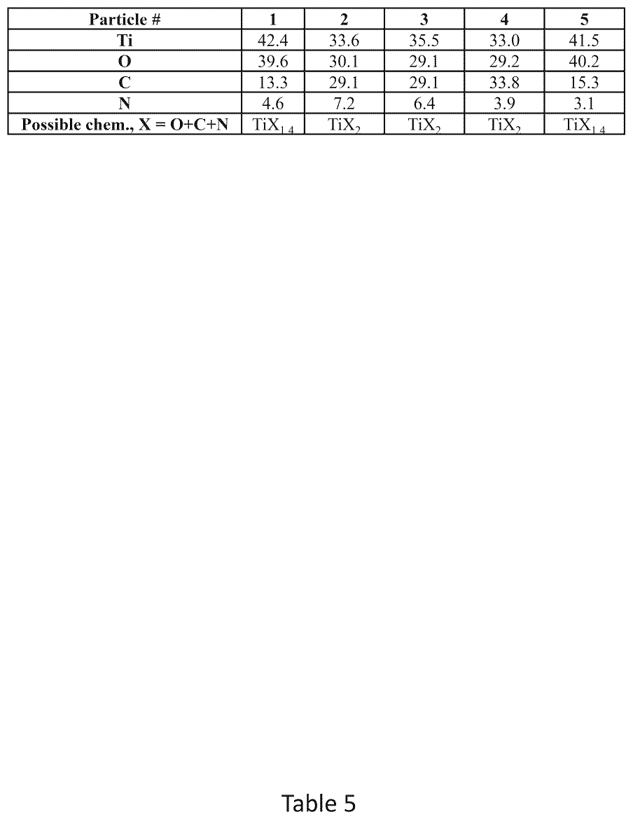

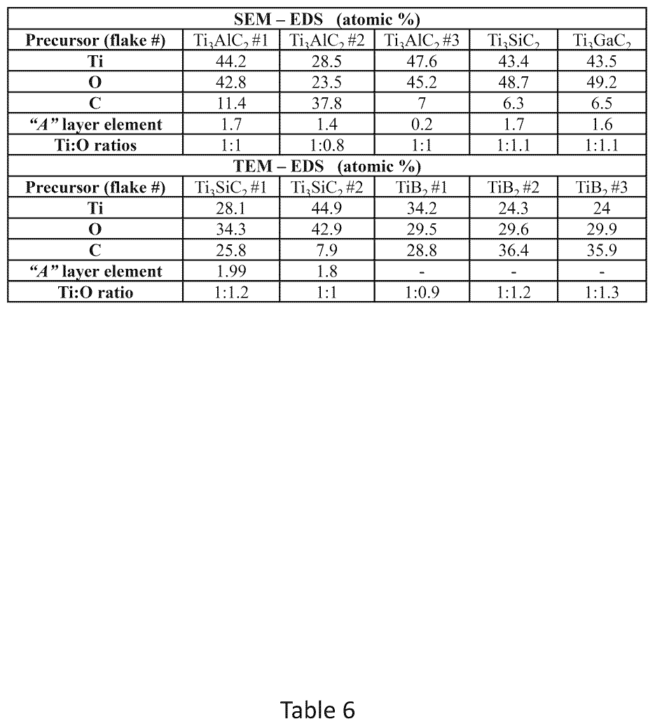

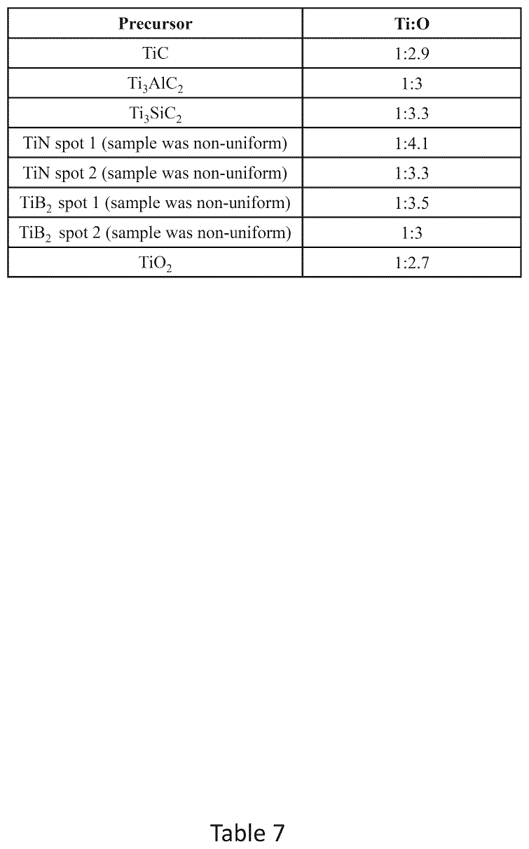

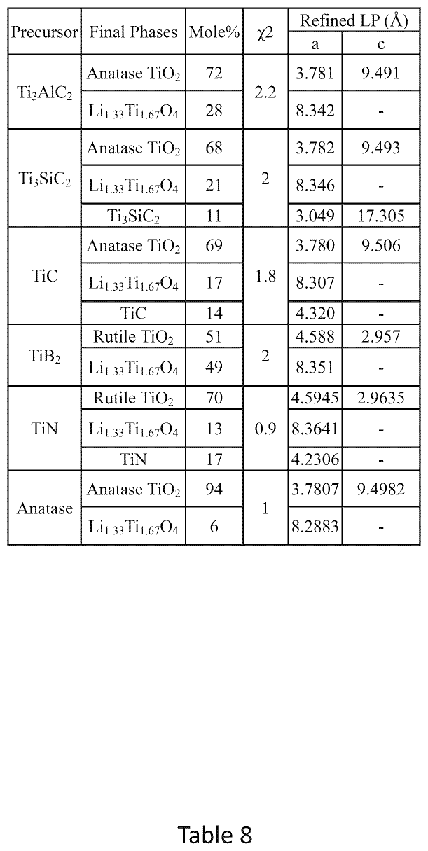

Herein, the XRD patterns of samples reacted for 1 to 5 d, shown in FIG. 28a make it clear that at early times strong TiB₂ peaks (dashed black lines in FIG. 28a) are present. The corresponding SEM micrographs (FIG. 32 and FIG. 44) clearly show that regardless of reaction times and at all magnifications, the MPPs surfaces appear to be identical. This is a useful observation because it indicates the TiB₂ to 1DL transformation starts at the surface and moves inwards into a central core with time. This also suggests that, at least initially, the reaction must be surface reaction rate controlled (see FIG. 45). FIG. 33a is a schematic of what we imagine is happening at the interface. First, Ti atoms are released into the reaction medium at which time they convert to TiO₆ octahedra. The latter then inserts itself between the receding substrate and the 1DL growing away from it. The implications of this conclusion are useful, because in principle it allows for the formation of core-shell configurations.

One of the major disadvantages of working with nanomaterials, in general, and nanoparticles in particular, is that after, typically, considerable effort goes into making them, they aggregate, and more processing is needed to disaggregate them, which in turn can introduce unwanted chemical and contaminants. It follows that the fact that our MPPs are free-flowing could be paradigm shifting in that we can now both have many of the advantages of reduced dimensions without their downside.

Lastly, the fact that the NFs nucleate on the surface of our precursors may also explain why these 1DL NFs have not been discovered earlier. In most sol-gel work to date, the starting point is a water-soluble Ti-source. We speculate that having the reaction nucleate on a solid surface allows the NFs to only grow in one dimension. More work is needed here. What is unmistakable, however, is that form of Ostwald-ripening is occurring in our microstructures. The primary particle size of our initial TiB₂ is in the 5 μm range, with few particles over 10 μm in size. As shown in inset in FIG. 28b, the final sizes of the MPPs are higher. This result not only confirms Ostwald-ripening as a mechanism, but demonstrates that our final product, 1DL NFs, can dissolve and re-principate in our reaction medium.

In summary, we report on a truly large-scale synthesis of TiO₂-based sub-nanostructures following a facile solution-precipitation method at ambient pressures and at temperatures of <100° C. Our method entails shaking water insoluble, cheap and commercial Ti-containing powder (for example, TiB₂) in TMAH aqueous solutions in plastic bottles at 80° C. for 1-5 days. The resulting powders, washed with EtOH and water using an overhead mixer and a beaker before they were let to dehydrate at 50° C. in open air. No centrifugation or filtration is needed in processing these nanomaterials which reduces their production cost at the industrial level. Low magnification SEM imaging revealed that each particle has sponge-like morphology with an average size of ˜13 μm. It has been further elaborated using HR-STEM and SAD patterns that the building unit of the MPPs are lepidocrocite-type titanate NFs that are 5×7 Å² in cross section and several microns long. According to out TGA results, the mesoporous morphology is stable up to 800° C. However, the lepidocrocite structure transforms into rutile, anatase, and Li- or Na-titanate at temperatures>≈200° C.

We further investigated the capability of intercalating various cations in the interfilamentous gallery. Herein, we show that the NFs are readily ion exchangeable with various monovalent (H₃O⁺, Li⁺, and Na⁺) and divalent cations (Mg²⁺, Mn²⁺, Fe²⁺, Co²⁺, Ni²⁺ and Zn²⁺).

Lastly, we investigated the surface charge and hydrodynamic size of the self-assembled NFs and showed that the ζ-potentials can be >−60 mV in DI water resulting in a highly-stable colloidal suspensions.

Experimental Procedures

Materials Synthesis and Processing

Sample Preparation of 1DL

Our scalable synthesis protocol entails mixing commercial TiB₂ (−325 mesh Thermo Scientific, PA, U.S.) powders with a TMAH aqueous solution (Alfa Aesar, 25 wt. % in DI water, 99.9999%) in polyethylene bottles. The Ti:TMAH mole ratio was kept constant at 0.6. In a typical batch, we immersed 100 g TiB₂ powder in 900 mL TMAH solution in 5 different polyethylene bottles, each 250 mL in volume. The bottles were then transferred to a temperature-controlled incubator/shaker (21 IDS 49 L Shaking Incubator, Labnet International Inc., NC) and shook at 175 rpm at 80° C. for 1 to 5 d.

Washing Protocol

After reaction, all the resulting sediment combined in a 1 L beaker, and the powders were allowed to settle after which the supernatant was decanted and discarded. To wash away any unreacted TMAH, the 1 L beaker was again filled with EtOH (Decon Lab Inc., 200 proof), stirred at RT for 1 to 2 h using an overhead mixer (OSC-10 L-200 rpm, LabFish, China) after which the powders were again allowed to settle before the EtOH supernatant, comprised of excess TMA⁺ cations and other unwanted reaction products, was again dumped to waste. This procedure was repeated multiple times till the pH was a ≈7, after which the powders were allowed to dry in open air at 50° C. overnight.

Synthesis of Ions-Intercalated 1DL NFs

To assess capability of ion exchange, some powders, while wet, were further stirred on a stir plate, 3 subsequent times each of 6 h in one of the following salt solutions: LiCl 0.5M, LiCl 5M, NaCl 0.5M, or NaCl 5M and then rinsed with DI water 3 times to remove any unreacted salts and/or reaction products. All salts were purchased from Alfa Aesar with >99% purity. The LiCl- and NaCl-treated powders were then air-dried at 50° C. overnight.

X-ray Diffraction, XRD

A diffractometer (Rigaku MiniFlex, Tokyo, Japan) operated with Cu Ku radiation (40 kV and 15 mA) was used to obtained XRD patterns. The powders were scanned in the 2-65° 2θ range with a step size of 0.02° and a dwell time of 1 s. Unless otherwise noted, all powders were dried overnight at 50° C. in open air before any XRD scans.

Scanning Electron Microscopy

A scanning electron microscope, SEM (Zeiss Supra 50 VP, Carl Zeiss SMT AG, Oberkochen, Germany) was used to obtain micrographs of our materials. The SEM settings were set to an in-lens detector, a 30 mm aperture, and an accelerating voltage of 3-5 kV.

Particle Size Distribution

Particle size distribution was carried out by measuring both minimum and maximum lengths of each particle for a total of 100 particles using ImageJ software.

Scanning Transmission Electron Microscopy

A scanning transmission electron microscope, STEM, using an aberration-corrected cold field emission JEOL ARM200CF operated at 200 kV primary electron energy. Imaging and spectroscopic measurements were conducted with the emission current at 15 μA, an electron probe semi-convergence angle of 24 mrad, as well as inner and outer detector angles of 68 mrad and 280 mrad for high angle annular dark field (HAADF) imaging. For low angle annular dark field (LAADF) imaging the inner and outer angles were 30 mrad and 120 mrad respectively. Annular bright field (ABF) imaging was conducted using an outer angle of 23 mrad and an inner angle of 11 mrad.

To conduct nanoscale elemental identification and quantification, the ARM200CF is equipped with an Oxford XMX100TLE X-ray windowless silicon drift detector (SDD) with a 100 mm² detector area.

STEM samples were prepared by drop casting a 5 ml suspension of TiB₂-derived powders (5d, 80° C.) in mEtOH on a 3 mm lacey carbon copper grid. The sample was then allowed to dry for an hour before insertion into the microscope column.

Electron Energy-loss Spectroscopy (EELS)

EELS measurements were conducted using a post-columns Gatan Continuum GIF ER spectrometer, with an electron probe semi-convergence angle of 17.8 mrad and a collection angle of 53.4 mrad. In situ cooling was conducted using a Gatan 636 liquid nitrogen, N₂, cold stage. To reduce the presence of latent water, the samples were heated to 100° C. for an hour inside the microscope column.

Zetapotential and Particle Size Measurements

A Zetasizer (Nano-ZS, Malvern Panalytical, Malvern, U. K.) was used for the electrophoretic mobility measurements. The electrophoretic mobility values converted to zeta potentials, ζ, using the Smoluchowski model. The hydrodynamic diameter, dH, was also measured, on the same machine, using dynamic light scattering DLS. Average hydrodynamic diameter was calculated from the diffusion coefficient using the Strokes-Einstein equation. All measurements were carried out at ambient conditions with a holding equilibrium time of 120 s.

Thermogravimetric Analysis, TGA

A thermobalance (TA Instruments Q50, New Castle, DE, USA) was used for the TGA analysis. Dry powders (˜40 mg) were loaded in sapphire crucible, heated at 10° C./min, under Ar flow at 10 mL/min, to 800° C., then system was let to cool down naturally.

### REFERENCES

1. Kumar, S. G., and Devi, L. G. (2011). Review on Modified TiO2 Photocatalysis under UV/Visible Light: Selected Results and Related Mechanisms on Interfacial Charge Carrier Transfer Dynamics. J. Phys. Chem. A 115, 13211-13241. /10.1021/jp204364a.
2. Schaub, R., Thostrup, P., Lopez, N., Lægsgaard, E., Stensgaard, I., Norskov, J. K., and Besenbacher, F. (2001). Oxygen vacancies as active sites for water dissociation on rutile TiO₂ (110). PRL 87, 266104. /10.1103/PhysRevLett.87.266104.
3. Wang, A. S. D., and Sasaki, T. (2014). Titanium Oxide Nanosheets: Graphene Analogues with Versatile Functionalities. Chem. Rev. 114, 9455-9486.
4. Bourikas, K., Kordulis, C., and Lycourghiotis, A. (2014). Titanium Dioxide (Anatase and Rutile): Surface Chemistry, Liquid-Solid Interface Chemistry, and Scientific Synthesis of Supported Catalysts. Chem. Rev. 114, 9754-9823. /10.1021/cr300230q.
5. Wang, X., Li, Z., Shi, J., and Yu, Y. (2014). One-dimensional titanium dioxide nanomaterials: nanowires, nanorods, and nanobelts. Chem. Rev. 114, 9346-9384./10.1021/cr400633s.
6. Ramos-Delgado, N. A., Gracia-Pinilla, M.Á., Mangalaraja, R. V., O'Shea, K., and Dionysiou, D. D. (2016). Industrial synthesis and characterization of nanophotocatalysts materials: titania. Nanotechnol. Rev. 5, 467-479. doi:10.1515/ntrev-2016-0007.
7. Fang, W., Xing, M., and Zhang, J. (2017). Modifications on Reduced Titanium Dioxide Photocatalysts: A review. J. Photochem. Photobiolog C: Photochem. Rev. 32, 21-39./10.1016/j.jphotochemrev.2017.05.003.
8. Saeed, M., Muneer, M., and Akram, N. (2021). Photocatalysis: an effective tool for photodegradation of dyes—a review. Environ. Sci. Pollut. Res., 1-19./10.1007/s11356-021-16389-7.
9. Sasaki, T., Watanabe, M., Michiue, Y., Komatsu, Y., Izumi, F., and Takenouchi, S. (1995). Preparation and Acid—Base Properties of a Protonated Titanate with the Lepidocrocite-like Layer. Chem. Mater. 7, 1001.
10. Sasaki, T., and Watanabe, M. (1997). Semiconductor nanosheet crystallites of quasi-TiO2 and their optical properties. J. Phys. Chem. B. 101, 10159-10161./10.1021/jp9727658.
11. Zhou, W., Umezawa, N., Ma, R., Sakai, N., Ebina, Y., Sano, K., Liu, M., Ishida, Y., Aida, T., and Sasaki, T. (2018). Spontaneous Direct Band Gap, High Hole Mobility, and Huge Exciton Energy in Atomic-Thin TiO2 Nanosheet. Chem. Mater. 30, 6449-6457. 10.1021/acs.chemmater.8b02792.
12. Lai, Y., Lin, L., Pan, F., Huang, J., Song, R., Huang, Y., Lin, C., Fuchs, H., and Chi, L. (2013). Bioinspired Patterning with Extreme Wettability Contrast on TiO2 Nanotube Array Surface: A Versatile Platform for Biomedical Applications. Small 9, 2945-2953./10.1002/smll.201300187.
13. Hurum, D. C., Agrios, A. G., Gray, K. A., Rajh, T., and Thurnauer, M. C. (2003). Explaining the enhanced photocatalytic activity of Degussa P25 mixed-phase TiO2 using EPR. The Journal of Physical Chemistry B 107, 4545-4549.
14. Ohtani, B., Prieto-Mahaney, O., Li, D., and Abe, R. (2010). What is Degussa (Evonik) P25? Crystalline composition analysis, reconstruction from isolated pure particles and photocatalytic activity test. J. Photochemi. Photobiology A: Chemistry 216, 179-182.
15. Wang, X., Pehkonen, S. O., Rämö, J., Väänänen, M., Highfield, J. G., and Laasonen, K. (2012). Experimental and computational studies of nitrogen doped Degussa P25 TiO 2: application to visible-light driven photo-oxidation of As (iii). Catalysis Science & Technology 2, 784-793.
16. Tobaldi, D. M., Pullar, R. C., Seabra, M. P., and Labrincha, J. A. (2014). Fully quantitative X-ray characterisation of Evonik Aeroxide TiO2 P25. Mater. Lett. 122, 345-347.
17. Sheng, L., Liao, T., Kou, L., and Sun, Z. (2017). Single-crystalline ultrathin 2D TiO₂ nanosheets: A bridge towards superior photovoltaic devices. Mater. Today Energy 3, 32-39. 10.1016/j.mtener.2016.12.004.
18. Esmat, M., Farghali, A. A., El-Dek, S. I., Khedr, M. H., Yamauchi, Y., Bando, Y., Fukata, N., and Ide, Y. (2019). Conversion of a 2D Lepidocrocite-Type Layered Titanate into Its 1D Nanowire Form with Enhancement of Cation Exchange and Photocatalytic Performance. Inorg. Chem. 58, 7989-7996./10.1021/acs.inorgchem.9b00722.
19. Badr, H., Natu, V., Neatu, S., Neatu, F., Kuncser, A., Rostas, A., Barsoum, M. W., and Florea, M. (2023). Ultra-stable, 1D TiO2 Lepidocrocite for Photocatalytic Hydrogen Production in Water-Methanol Mixtures. Matter. https://doi.org/10.1016/j.matt.2023.05.026.
20. Badr, H. O., Montazer, K., El-Melegy, T., Natu, V., Carey, M., Gawas, R., Phan, P., Qian Qian, Li, C. Y., Wiedwald, U., et al. (2022). Scalable, inexpensive, one-pot, facile synthesis of crystalline two-dimensional birnessite flakes. Matter 5, 2365-2381. https://doi.org/10.1016/j.matt.2022.05.038.
21. Kai., K., et al. (2008). Room-Temperature Synthesis of Manganese Oxide Monosheets. J. Am. Chem. Soc. 130, 15938-15943./10.1021/ja804503f.
22. Kai, K., Yoshida, Y., Kobayashi, Y., Kageyama, H., and Saito, G. (2012). Preparation and formation mechanism of a n-butylammonium/MnO2 layered hybrid via a one-pot synthesis under moderate conditions. Dalton Trans. 41, 825.
23. Zhang, A., Zhao, R., Hu, L., et al. (2021). Adjusting the Coordination Environment of Mn Enhances Supercapacitor Performance of MnO2. Adv. Energy Mater., 2101412./10.1002/aenm.202101412.
24. Zheng, W., Halim, J., Yang, L., Badr, H. O., Sun, Z., Persson, P. O.Å., Rosen, J., and Barsoum, M. W. (2022). MXene//MnO2 Asymmetric Supercapacitors with High Voltages and High Energy Densities. Batteries & Supercaps https://doi.org/10.1002/batt.202200151.
25. Sudhakar, K., Kono, T., El-Melegy, T., Badr, H. O., Laxmeesha, P. M., Montazeri, K., Semisalova, A., Farle, M., Wiedwald, U., and Barsoum, M. W. (2023). One pot, scalable synthesis of hydroxide derived ferrite magnetic nanoparticles. J. Magn. Magn. Mater. 582, 170986. https://doi.org/10.1016/j.jmmm.2023.170986.
26. Badr, H. O., El-Melegy, T., Carey, M., Natu, V., Hassig, M. Q., Johnson, C., Qian, Q., Li, C. Y., Kushnir, K., Ulloa, E. C., et al. (2022). Bottom-up, scalable synthesis of anatase nanofilament-based two-dimensional titanium carbo-oxide flakes. Mater. Today 54, 8-17. https://doi.org/10.1016/j.mattod.2021.10.033.
27. Badr, H. O., Lagunas, F., Autrey, D. E., Cope, J., Kono, T., Torita, T., Klie, R. F., Hu, Y.-J., and Barsoum, M. W. (2023). On the Structure of One-Dimensional TiO₂ Lepidocrocite. Matter 6, 128-141. https://doi.org/10.1016/j.matt.2022.10.015.
28. Colin-Ulloa, E., Martin, J. L., Hanna, R. J., Frasch, M. H., Ramthun, R. R., Badr, H. O., Uzarski, J. R., Barsoum, M. W., Grimm, R. L., and Titova, L. V. (2023). Electronic Structure of 1D Lepidocrocite TiO₂ as Revealed by Optical Absorption and Photoelectron Spectroscopy. J. Phys. Chem. C. 10.1021/acs.jpcc.2c06719.
29. Wang, L., Badr, H. O., Yanga, Y., Cope, J., Ma, E., Yuan, L., Li, Z., Barsoum, M. W., Chai, Z., and Shi, W. (2023). Unique Hierarchical Structures of One Dimensional Lepidocrocite Titanate with Cation-Exchangeable Sites for Extraordinary Selective Actinide Capture for Water Purification. JACS.
30. Wilson, OR., Carey, M. S., Cope, J. H., Badr, H. O., Nantz, J. M., ElMelegy, T. A., Barsoum, M. W., and Magenau, A. J. D. (2023). Repairable reinforced composites of 1D TiO₂ lepidocrocite mesoparticles and thiol-yne click networks via alkylborane-initiated in situ polymerization. Cell Rep. 4, 101434. https://doi.org/10.1016/j.xcrp.2023.101434.
31. Sudhakar, K., Karmakar, A., Badr, H., El-Melegy, T., Hassig, M. Q., Carey, M., Masiuk, S., Wu, L., Qian, Q., Kono, T., et al. (2023). One-dimensional, Lepidocrocite-based Nanofilaments and Their Self-Assembly. Matter. https://doi.org/10.1016/j.matt.2023.06.006.
32. Ma, R., and Sasaki, T. (2010). Nanosheets of Oxides and Hydroxides: Ultimate 2D Charge-Bearing Functional Crystallites. Adv. Mater. 22, 5082-5104./10.1002/adma.201001722.
33. Verger, L., Natu, V., Ghidiu, M., and Barsoum, M. W. (2019). Effect of Cationic Exchange on the Hydration and Swelling Behavior of Ti3C2Tz MXene. J. Phys. Chem. C 20044-20050, 19725-19733.
34. Varun Natu, Rahul Pai, Olivia Wilson, Edward Gadasu, Hussein Badr, Avishek Karmakar, Andrew J. D. Magenau, Vibha Kalra, a., and Barsoum*, M. W. (2022). Effect of Base/Nucleophile Treatment on Interlayer Ion Intercalation, Surface Terminations, and Osmotic Swelling of Ti₃C2Tz MXene Multilayers. Chem. Mater. 34, 678-693.
35. Ma, R., Bando, Y., and Sasaki, T. (2003). Nanotubes of lepidocrocite titanates. Chem. Phys. Lett. 380, 577-582./10.1016/j.cplett.2003.09.069.
36. Sasaki, T., Watanabe, M., Hashizume, H., Yamada, H., and Nakazawa, H. (1996). Macromolecule-like Aspects for a Colloidal Suspension of an Exfoliated Titanate. Pairwise Association of Nanosheets and Dynamic Reassembling Process Initiated from It. J. Am. Chem. Soc. 118, 8329-8335./10.1021/ja960073b.
37. Yunxia Chen, Xin He, Xiujian Zhao, Qihua Yuan, and Gu, X. (2007). Preparation, characterization, and growth mechanism of a novel aligned nanosquare anatase in large quantities in the presence of TMAOH. J. Colloid Interface Sci. 310, 171-177. 10.1016/j.jcis.2007.01.046.
38. Tan, Z., Sato, K., and Ohara, S. (2015). Synthesis of layered nanostructured TiO₂ by hydrothermal method. Adv Powder Technol 26, 296-302./10.1016/j.apt.2014.10.011.
39. Yuan, H., Besselink, R., Liao Z., and Elshof, J. E. (2014). The swelling transition of lepidocrocite-type protonated layered titanates into anatase under hydrothermal treatment. Sci. Rep. 4, 4584/10.1038/srep04584.
40. Liu, Z., Ooi, K., Kanoh, H., Tang, W., and Tomida, T. (2000). Swelling and Delamination Behaviors of Bimessite-Type Manganese Oxide by Intercalation of Tetraalkylammonium Ions. Langmuir 16, 4154-4164. 10.1021/la9913755.
41. Brock, S. L., et al. (1999). Particle Size Control and Self-Assembly Processes in Novel Colloids of Nanocrystalline Manganese Oxide. J. Phys. Chem. B 103, 7416-7428. 10.1021/jp991009u.
42. Sun, X., and Li, Y. (2003). Synthesis and Characterization of Ion-Exchangeable Titanate Nanotubes. Chem. Eur. J. 9, 2229-2238./10.1002/chem.200204394.
43. Mao, Y., and Wong, S. S. (2066). Size- and Shape-Dependent Transformation of Nanosized Titanate into Analogous Anatase Titania Nanostructures. J. AM. CHEM. SOC. 128, 8217-8226./10.1021/ja0607483.
44. Liua, W., Sun, W., Borthwick, A. G. L., and Ni, J. (2013). Comparison on aggregation and sedimentation of titanium dioxide, titanate nanotubes and titanate nanotubes-TiO2: Influence of pH, ionic strength and natural organic matter. Colloids Surf, A Physicochem Eng Asp 434, 319-328./10.1016/j.colsurfa.2013.05.010.
45. Bavykin, D. V., Friedrich, J. M., and Walsh, F. C. (2006). Protonated Titanates and TiO2 Nanostructured Materials: Synthesis, Properties, and Applications. Adv. Mater. 18, 2807-2824./10.1002/adma.200502696.
46. Yang, J., Jin, Z., Wang, X., Li, W., Zhang, J., Zhang, S., Guo, X., and Zhang, Z. (2003). Study on composition, structure and formation process of nanotube Na2Ti2O4(OH)2. Dalton Trans., 3898-3901./10.1039/B305585J.
47. Phillips, P. J., Paulauskas, T., Rowlands, N., Nicholls, A. W., Low, K. B., Bhadare, S., and Klie, R. F. (2014). A New Silicon Drift Detector for High Spatial Resolution STEM-XEDS: Performance and Applications. Microsc. Microanal. 20, 1046-1052. 10.1017/S1431927614001639.

Aspects

The following Aspects are illustrative only and do not limit the scope of the present disclosure or the appended claims.

Aspect 1. A composition, comprising: a plurality of oxide-based nanofilaments and/or subnanofilaments, and optionally an amount of carbon. (As described herein, the nanofilaments can comprise titanium.) The composition can be present as, for example, a mesoporous powder in which the powder particulates comprise the oxide-based nanofilaments and/or subnanofilaments.

Aspect 2. The composition of Aspect 1, wherein at least some of the nanofilaments and/or subnanofilaments have a width in the range of from about 3 to about 50 Å. The width can be, for example, from about 3 to about 50 Å, from about 5 to about 45 Å, from about 7 to about 40 Å, from about 9 to about 35 Å, from about 12 to about 30 Å, from about 15 to about 20 Å, and all intermediate values and combinations.

The composition can be comprised in a suspension, for example, in a solution or an ink, which ink can be printable. With specific regard to inks, inks can be sprayed, printed, or otherwise applied to a substrate. An ink can include solvents, binders, and the like. Nanofilaments and/or subnanofilaments according to the present disclosure can be stable in water; as one example, the nanofilaments and/or subnanofilaments can remain essentially undegraded after 1, 5, 10, 15, 20, 25, 30, 35, 40, 45, or even 50 days of immersion in water.

Aspect 3. The composition of Aspect 2, wherein at least some of the nanofilaments and/or subnanofilaments have an average width in the range of from about 7 to about 20 Å.

Aspect 4. The composition of any one of Aspects 1-3, wherein the nanofilaments and/or subnanofilaments define a non-circular cross-section.

Aspect 5. The composition of Aspect 4, wherein the nanofilaments and/or subnanofilaments define a cross-sectional aspect ratio of from greater than 1 to about 10. For example, the cross-sectional aspect ratio can be from 1.1 to 10, from 1.5 to 9, from 1.8 to 8, from 2.2 to 7, from 2.5 to 6, from 2.8 to 5, or even from 3.2 to 4.

Aspect 6. The composition of Aspect 5, wherein the nanofilaments and/or subnanofilaments define a cross-sectional aspect ratio of from about 2 to about 5.

Aspect 7. The composition of any one of Aspects 1-6, wherein the nanofilaments and/or subnanofilaments have an average cross-sectional area in the range of from about 10 to about 100 Å². For example, the average cross-sectional area can be the range of from about 10 to about 100 Å², from about 15 to about 90 Å², from about 20 to about 80 Å², from about 30 to about 70 Å², from about 40 to about 60 Å², or even about 50 Å².

Aspect 8. The composition of any one of Aspects 1-7, wherein at least some of the nanofilaments and/or subnanofilaments have a length in the range of from 1 nm to about 25 μm. The length can be, for example, from about 1 nm to about 25 μm, from about 10 nm to about 20 m, from about 50 nm to about 10 m, from about 100 nm to about 5 μm, or from about 250 nm to about 2 μm.

Aspect 9. The composition of Aspect 8, wherein at least some of the nanofilaments and/or subnanofilaments have a length in the range of from 1 nm to about 1 μm.

Aspect 10. The composition of any one of Aspects 1-9, wherein the nanofilaments and/or subnanofilaments are comprised in a plurality of flakes; the nanofilaments and/or subnanofilaments can self-assemble into the flakes. Without being bound to any particular theory or embodiments, the nanofilaments and/or subnanofilaments can be aligned in a plane; and a flake can include two or more layers of aligned nanofilaments and/or subnanofilaments, which can in turn provide a flake that is a well-ordered stack of nanofilament and/or subnanofilament layers. The nanofilaments can be self-aligning.

Aspect 11. The composition of Aspect 7, wherein at least some of the plurality of flakes lie in a common plane. The flakes can be well-stacked along the stacking direction. The nanofilaments and/or subnanofilaments can result in in XRD patterns that are typical of 2D materials, i.e., only one family of planes diffract. Without being bound to any particular theory or embodiment, the nanofilaments and/or subnanofilaments can self-assemble into 2D flakes.

Aspect 12. The composition of any one of Aspects 1-11, further comprising a pharmaceutically acceptable carrier.

Aspect 13. The composition of any one of Aspects 1-12, further comprising one or more materials that are fatal to cancer cells.

Aspect 14. The composition of any one of Aspects 1-13, further comprising a binder. Such a binder can be, for example, a glue, an adhesive, or other matrix material.

Aspect 15. The composition of Aspect 14, wherein the binder comprises a polymer.

Aspect 16. The composition of any one of Aspects 1-15, wherein the nanofilaments and/or subnanofilaments exhibit a XRD pattern that exhibit reduced (104) and (105) peaks at around 38° and about 55° two theta (2θ).

Aspect 17. A device, the device comprising a composition according to any one of Aspects 1-16.

Aspect 18. The device of Aspect 17, wherein the device comprises an electrode.

Aspect 19. The device of Aspect 17, wherein the device is characterized as an energy storage device. Such a device can be, for example, a battery, a supercapacitor, and the like. A device can be rechargeable, but can also be disposable. Such a device can be comprised in a mobile computing device, a mobile communications device, a computing device, an illumination device, a signal transmitted, a signal receiver,

Aspect 20. The device of Aspect 18, wherein the electrode comprises a composition according to any one of Aspects 1-16.

Aspect 21. The device of Aspect 17, wherein the device comprises a dispenser, the dispenser having disposed therein the composition according to any one of Aspects 1-16. A dispenser can be, for example, a syringe, a nozzle, and the like. Such a dispenser can be used to deliver the composition (for example, according to any one of Aspects 1-16) to a subject (for example, a human patient) and/or to a sample obtained from a patient. Such a sample can be, for example, a blood sample.

Aspect 22. A method, comprising operating a device according to Aspect 17.

Aspect 23. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting being performed under conditions sufficient to give rise to a nanofilamentous (and/or subnanofilamentous) product. The product can self-assemble into 2D flakes.

Example carbides include, for example, titanium carbide, zirconium carbide, hafnium carbide, vanadium carbide, niobium carbide, tantalum carbide, chromium carbide, molybdenum carbide, tungsten carbide, iron carbide, and the like. Example nitrides include, for example, aluminum nitride, boron nitride, calcium nitride, cerium nitride, europium nitride, gallium nitride, indium nitride, lanthanum nitride, lithium nitride, magnesium nitride, niobium nitride, silicon nitride, strontium nitride, tantalum nitride, titanium nitride, vanadium nitride, zinc nitride, zirconium nitride, and the like.

Example borides include, for example, aluminium diboride, aluminium dodecaboride, aluminium magnesium boride, barium boride, calcium hexaboride, cerium hexaboride, chromium(III) boride, cobalt boride, dinickel boride, erbium hexaboride, erbium tetraboride, hafnium diboride, iron boride, iron tetraboride, lanthanum hexaboride, magnesium diboride, nickel boride, niobium diboride, osmium boride, plutonium borides, rhenium diboride, ruthenium boride, samarium hexaboride, scandium dodecaboride, silicon boride, strontium hexaboride, tantalum boride, titanium diboride, trinickel boride, tungsten boride, uranium diboride, yttrium boride, zirconium diboride, and the like.

Example phosphides include, for example, alminium gallium indium phosphide, aluminium gallium phosphide, aluminium phosphide, bismuth phosphide, boron phosphide, cadmium phosphide, calcium monophosphide, calcium phosphide, carbon monophosphide, cobalt(II) phosphide, copper(I) phosphide, dysprosium phosphide, erbium phosphide, europium(III) phosphide, ferrophosphorus, gadolinium phosphide, gallium arsenide phosphide, gallium indium arsenide antimonide phosphide, gallium phosphide, holmium phosphide, indium arsenide antimonide phosphide, indium gallium arsenide phosphide, indium gallium phosphide, indium phosphide, iron phosphide, lanthanum phosphide, lithium phosphide, lutetium phosphide, neodymium phosphide, niobium phosphide, phosphide carbide, phosphide chloride, phosphide silicide, -plutonium phosphide, praseodymium phosphide, samarium phosphide, scandium phosphide, sodium phosphide, strontium phosphide, telluride phosphide, terbium phosphide, thulium phosphide, titanium(III) phosphide, uranium monophosphide, ytterbium phosphide, yttrium phosphide, zinc diphosphide, zinc cadmium phosphide arsenide, and zinc phosphide.

Example aluminides include, for example, magnesium aluminide, titanium aluminide, iron aluminide, and nickel aluminide.

Example silicides include, for example, nickel silicide, sodium silicide, magnesium silicide, platinum silicide, titanium silicide, tungsten silicide, and molybdenum silicide.

Without being bound to any particular theory or embodiment, mono-, binary, or ternary, or higher carbides, nitrides, borides, phosphides, aluminides, or silicides that comprise titanium are particularly suitable. Similarly, titanium sponge is considered a particularly suitable form of titanium metal for use with the disclosed technology. For example, one can contact titanium sponge with a quaternary ammonium salt as described herein so as to give rise to a nanofilamentous (or subnanofilamentous) product, as described herein.

Aspect 24. The method of Aspect 23, wherein the conditions comprise a temperature of from 0 to 100° C., to 200° C., or even to 300° C. for from about 0.5 hours to about 1, 2, 3, 4, or 5 weeks. The temperature can be constant during the time of exposure, but can also be varied, for example, increased and/or decreased. The temperature can be, for example, from about 0 to about 300° C., from about 5 to about 95° C., from about 10 to about 90° C., from about 15 to about 85° C., from about 20 to about 80° C., from about 25 to about 75° C., from about 30 to about 70° C., from about 35 to about 65° C., from about 40 to about 60° C., from about 45 to about 55° C., or even about 50° C. Temperatures from 100 to 200° C. are also suitable. The temperature can be varied during the exposure (for example, exposure to a first temperature and then a second temperature), but this is not a requirement. The exposure can be, for example, according to a preprogrammed schedule that sets temperatures and/or durations of exposure. The exposure temperature can be, for example, about 25, about 30, about 35, about 40, about 45, about 50, about 55, about 60, about 65, about 70, about 75, about 80, about 90, about 95, or even about 100° C.

The conditions can, in some embodiments, comprise a temperature of from about 20 to about 300° C. and an exposure of from about 0.5 hours to about 2, 3, 4, or even 5 weeks. The conditions can comprise a temperature of about 100 to about 200° C. and an exposure of from about 1 hours to about 1 week. The temperature can be constant during the time of exposure, but can also be varied, for example, increased and/or decreased. The temperature can be, for example, from about 100 to about 200° C., from about 105 to about 195° C., from about 100 to about 190° C., from about 115 to about 185° C., from about 120 to about 180° C., from about 25 to about 175° C., from about 130 to about 170° C., from about 135 to about 165° C., from about 140 to about 160° C., from about 145 to about 155° C., or even about 150° C. The temperature can be varied during the exposure (for example, exposure to a first temperature and then a second temperature), but this is not a requirement. The exposure can be, for example, according to a preprogrammed schedule that sets temperatures and/or durations of exposure. The exposure temperature can be, for example, about 125, about 130, about 135, about 140, about 145, about 150, about 155, about 160, about 165, about 170, about 175, about 180, about 190, about 195. The method can be performed in a closed system, for example, in a pressure vessel. The pressure can be atmospheric, but can also be less than atmospheric pressure or even can be greater than atmospheric pressure, for example, a pressure of greater than 1 atmosphere (101.325 kPa) to about 10 atmospheres (1013.250 kPa).

The period of exposure (which can be termed a “reaction time”) can be, for example, from about 1 hours to about 7 days, from about 5 hours to about 6 days, from about 15 hours to about 5 days, from about 20 hours to about 4 days, from about 24 hours to about 3 days, or even about 2 days. As but some example, the exposure can be for from 12 hours to about 72 hours, about 15 hours to about 70 hours, about 18 hours to about 64 hours, about 24 hours to about 60 hours, about 30 hours to about 55 hours, about 33 hours to about 52 hours, about 37 hours to about 48 hours, about 40 hours to about 45 hours, and all intermediate values and sub-combinations of ranges.

Aspect 25. The method of Aspect 23, comprising contacting a mono-, binary, ternary, or higher boride (which can comprise Ti) with a quaternary ammonium salt and/or base so as to give rise to a product, which product can be nanofilamentous and/or subnanofilamentous.

Aspect 26. The method of Aspect 25, wherein the binary boride comprises one or more titanium borides.

Aspect 27. The method of any one of Aspects 23-26, wherein the quaternary ammonium salt and/or base comprises an ammonium hydroxide, an ammonium halide, or any combination thereof.

Aspect 28. The method of Aspect 27, wherein the quaternary ammonium hydroxide comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

Aspect 29. The method of Aspect 27, wherein the quaternary ammonium salt comprises a quaternary ammonium chloride, a quaternary ammonium bromide, a quaternary ammonium iodide, a quaternary ammonium fluoride, or any combination thereof. It should be understood that one can use either or both of a quaternary ammonium salt and a quaternary ammonium base.

Aspect 30. The method of any one of Aspects 23-29, further comprising filtering the product.

Aspect 31. The method of any one of Aspects 23-30, further comprising washing the product with a metal salt and/or other water-soluble metal compound.

The metal salt can be a metal halide salt, for example, a Li halide, a Na halide, a K halide, an Rb halide, a Cs halide, a Fr halide, a Be halide, a Mg halide, a Ca halide, a Sr halide, a Ba halide, a Ra halide, a Mn halide, a Fe halide, a Ni halide, a Co halide, a Cu halide, a Zn halide, a Mo halide, a Nb halide, a W halide, or any combination thereof.

Aspect 32. The method of any one of Aspects 23-31, further comprising washing the product with a metal salt and/or water-soluble metal compounds. The metal salt can optionally comprise metal sulfate, nitrate, chromate, acetate, carbonate, permanganate, or metal hydroxide, or any combination of thereof.

Aspect 33. The method of Aspect 32, wherein the metal in the salt can be essentially any metal from the periodic table. As but some non-limiting examples, the metal in the metal salt can be Li, Na, K, Cs, Mg, Ca, Cr, Mn, Fe, Co, Ni, Cu, Zn, Nb, Mo, Cd, Ta, or W, or any combination of thereof. A metal salt can be, for example, LiCl, KCl, NaCl, LiF, KF, NaF, LiOH, KOH, NaOH, or any combination thereof.

Aspect 34. The method of any one of Aspects 32-33, wherein the metal salt is LiCl, KCl, NaCl, LiF, CsCl, KF, NaF, LiOH, KOH, NaOH, or any combination thereof.

Aspect 35. The method of any one of Aspects 32-33, wherein the metal salt comprises CrCl₃, MnCl₂, FeCl₂, FeCl₃, CoCl₂, NiCl₂, MoCl₅, FeSO₄, (NH₄)₂Fe(SO₄)₂, CuCl₂, CuCl, ZnCl₂ or any combination thereof.

Aspect 36. The method of any one of Aspects 23-35, wherein the product is a composition according to any one of Aspects 1-16.

Aspect 37. The method of any one of Aspects 23-36, wherein the nanofilamentous (and/or subnanofilamentous) product exhibits a XRD pattern that exhibit reduced (104) and (105) peaks at around 38° and about 55° two theta (2θ).

Aspect 38. A method, comprising:
contacting particulate TiO₂ with a quaternary ammonium salt and/or base,
the contacting being performed under conditions sufficient to give rise to a nanoparticulate product,
the nanoparticulate product optionally at least some nanoparticles having a diameter of from about 2 nm to about 1000 nm, optionally from about 10 to about 100 nm.

The nanoparticulate product can be further processed, for example, by heating, by further reaction, and the like. The further processing can be performed to coarsen the product, for example, to give rise to larger-size particles, for example, from about 0.1 to about 0.7 μm, or from about 0.2 to about 0.5 μm.

The disclosed methods for making a product of the present disclosure provide a substitute for TiO₂ (including pigment-grade TiO₂) and also provide an improvement over existing processes for making such TiO₂, in particular pigment-grade TiO₂.

More specifically, to make pigment-grade TiO₂ at present, one begins with low-grade TiO₂ and then chlorinates that low-grade TiO₂ at a high temperature to convert the TiO₂ to TiCl₄ and then oxidize the latter. The disclosed methods provide an improvement over this cumbersome existing process.

The contacting can be at from about 20 to about 80° C., or from about 25 to about 75° C., or from about 30 to about 70° C., or from about 35 to about 65° C., or from about 40 to about 60° C., or from about 45 to about 55° C., even about 50° C. The contacting can be from, for example, about 5 minutes to about 5 hours, from about 10 minutes to about 4.5 hours, from about 15 minutes to about 4 hours, from about 20 minutes to about 3.5 hours, from about 30 minutes to about 3 hours, from about 45 minutes to about 2 hours, or any combination or subrange thereof.

Aspect 39. The method of Aspect 38, wherein the quaternary ammonium salt and/or base comprises an ammonium hydroxide, an ammonium halide, or any combination thereof.

Aspect 40. The method of Aspect 38, wherein the quaternary ammonium base comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

Aspect 41. The method of Aspect 38, wherein the quaternary ammonium salt comprises a quaternary ammonium chloride, a quaternary ammonium bromide, a quaternary ammonium iodide, a quaternary ammonium fluoride, or any combination thereof. As described elsewhere herein, one can use either or both of a quaternary ammonium salt and a quaternary ammonium base.

Aspect 42. The method of any one of Aspects 38-41, further comprising filtering the product.

Aspect 43. A composition, comprising a population of nanoparticles made according to any one of Aspects 38-42. Such nanoparticles can be in the size range of from about 200 nm to about 600 nm, for example, from about 200 nm to about 600 nm, from about 225 to about 575 nm, from about 250 to about 550 nm, from about 275 nm to about 525 nm, from about 300 to about 500 nm, from about 325 to about 475 nm, from about 350 to about 450 nm, from about 375 to about 425 nm, or even about 400 nm.

Aspect 44. A method, comprising replacing TiO₂ with a population of nanoparticles made according to any one of Aspects 38-42. As an example, one can formulate a pigment normally made with traditional TiO₂ by replacing the traditional TiO₂ with nanoparticles according to the present disclosure, for example, according to any one of Aspects 38-42.

Aspect 45. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, and the contacting being performed under conditions sufficient to give rise to mesoporous particles.

Aspect 46. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, the contacting being followed by washing with at least one salt and performed under conditions sufficient to give rise to mesoporous particles.

Aspect 47. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting performed while shaking and at a temperature of from about 50 to about 95° C., followed by washing with LiCl to give rise to mesoporous particles.

Aspect 48. A composition comprising mesoporous particles made according to any one of claims 45-47.

The mesoporous particles can exhibit a XRD pattern that can exhibit reduced (104) and (105) peaks at around 38° and about 55° two theta (2θ).

Aspect 49. A composition, comprising mesoporous particles.

Aspect 50. The composition according to any one of claims 48-49, further comprising a therapeutic.

Aspect 51. A method, comprising effecting delivery of a therapeutic to a subject, the therapeutic being comprised in a composition according to any one of claims 48-49.

Aspect 52. An electrode, the electrode comprising a composition according to any one of claims 48-49.

Aspect 53. A device, the device comprising a composition according to any one of claims 48-49.

Aspect 54. The device of claim 52, wherein the device is an energy storage device.

Aspect 55. A method, the method comprising operating the device of any one of claims 52-53.

Aspect 56. A composition, comprising: a plurality of metal oxide subnanofilaments and/or nanofilaments, the subnanofilaments and/or nanofilaments optionally comprising a lepidocrocitic region, the plurality of metal oxide subnanofilaments and/or nanofilaments optionally comprising an amount of carbon, the plurality of metal oxide subnanofilaments and/or nanofilaments optionally being comprised in a bundle, in a flake, or in both a flake and a bundle.

Aspect 57. The composition of claim 56, wherein at least some of the nanofilaments and/or subnanofilaments have a width in the range of from about 3 to about 50 Å.

Aspect 58. The composition of Aspect 57, wherein at least some of the nanofilaments and/or subnanofilaments have an average width in the range of from about 7 to about 20 Å.

Aspect 59. The composition of Aspect 56, wherein the nanofilaments and/or subnanofilaments define a non-circular cross-section.

Aspect 60. The composition of Aspect 59, wherein the nanofilaments and/or subnanofilaments define a cross-sectional aspect ratio of from greater than 1 to about 10.

Aspect 61. The composition of Aspect 60, wherein the nanofilaments and/or subnanofilaments define a cross-sectional aspect ratio of from about 2 to about 5.

Aspect 62. The composition of Aspect 56, wherein the nanofilaments and/or subnanofilaments have an average cross-sectional area in the range of from about 10 to about 100 Å².

Aspect 63. The composition of Aspect 56, wherein at least some of the nanofilaments and/or subnanofilaments have a length in the range of from 1 nm to about 25 μm.

Aspect 64. The composition of Aspect 63, wherein at least some of the nanofilaments and/or subnanofilaments have a length in the range of from 1 nm to about 1 μm.

Aspect 65. The composition of Aspect 56, wherein the nanofilaments and/or subnanofilaments are comprised in a plurality of flakes.

Aspect 66. The composition of Aspect 56, wherein at least some of the plurality of the nanofilaments and/or subnanofilaments lie in a common plane.

Aspect 67. The composition of any one of Aspects 56-66, further comprising a pharmaceutically acceptable carrier.

Aspect 68. The composition of Aspect 56, further comprising a binder.

Aspect 69. The composition of Aspect 68, wherein the binder comprises a polymer.

Aspect 70. A device, the device comprising a composition according to Aspect 1.

Aspect 71. The device of Aspect 70, wherein the device is characterized as an energy storage device.

Aspect 72. The device of Aspect 70, wherein the device comprises an electrode.

Aspect 73. The device of Aspect 72, wherein the electrode comprises the composition according to Aspect 1.

Aspect 74. The device of Aspect 70, wherein the device comprises a dispenser, the dispenser having disposed therein the composition according to Aspect 1.

Aspect 75. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting being performed under conditions sufficient to give rise to a nanofilamentous product.

Aspect 76. The method of Aspect 75, wherein the conditions comprise a temperature of from 0 to 100° C. for from about 5 hours to about 1 week.

Aspect 77. The method of Aspect 75, comprising contacting a binary, ternary, or higher boride with a quaternary ammonium salt and/or base so as to give rise to a nanofilamentous product.

Aspect 78. The method of Aspect 77, wherein the binary boride comprises one or more titanium borides.

Aspect 79. The method of Aspect 77, wherein the quaternary ammonium salt and/or base comprises an ammonium hydroxide, an ammonium halide, or any combination thereof.

Aspect 80. The method of Aspect 79, wherein the ammonium hydroxide comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

Aspect 81. The method of Aspect 79, wherein the quaternary ammonium salt comprises a quaternary ammonium chloride, a quaternary ammonium bromide, a quaternary ammonium iodide, a quaternary ammonium fluoride, or any combination thereof.

Aspect 82. The method of Aspect 75, further comprising filtering the product.

Aspect 83. The method of Aspect 75, further comprising washing the product with a metal salt and/or other water-soluble metal compounds.

Aspect 84. The method of Aspect 75, further comprising washing the product with a metal salt and/or water-soluble metal compounds, the metal salt optionally comprising metal sulfate, nitrate, chromate, acetate, carbonate, permanganate, or metal hydroxide, or any combination of thereof.

Aspect 85. The method of Aspect 84, wherein a metal in the metal salt comprises Li, Na, K, Cs, Mg, Ca, Cr, Mn, Fe, Co, Ni, Cu, Zn, Nb, Mo, Cd, Ta, or W, or any combination of thereof.

Aspect 86. The method of Aspect 84, wherein the metal salt comprises LiCl, KCl, NaCl, CsCl, LiF, KF, NaF, LiOH, KOH, NaOH, or any combination thereof.

Aspect 87. The method of Aspect 84, wherein the metal salt comprises CrCl₃, MnCl₂, FeCl₂, FeCl₃, CoCl₂, NiCl₂, MoCl₅, FeSO₄, (NH₄)₂Fe(SO₄)₂, CuCl₂, CuCl, ZnCl₂ or any combination thereof.

Aspect 88. The method of Aspect 75, wherein the product is a composition according to Aspect 1.

Aspect 89. A method, comprising: contacting particulate TiO₂ with a quaternary ammonium salt and/or base, the contacting being performed under conditions sufficient to give rise to a nanoparticulate product, the nanoparticulate product optionally at least some nanoparticles having a diameter of from about 2 nm to about 1000 nm, optionally from about 10 to about 100 nm.

Aspect 90. The method of Aspect 89, wherein the quaternary ammonium salt and/or base comprise an ammonium hydroxide, an ammonium halide, or any combination thereof.

Aspect 91. The method of Aspect 89, wherein the quaternary ammonium base comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

Aspect 92. The method of Aspect 89, wherein the quaternary ammonium salt comprises a quaternary ammonium chloride, a quaternary ammonium bromide, a quaternary ammonium iodide, a quaternary ammonium fluoride, or any combination thereof together with a base.

Aspect 93. The method of Aspect 89, further comprising filtering the product.

Aspect 94. A composition, comprising a population of nanoparticles made according to Aspect 89.

Aspect 95. A method, comprising replacing TiO₂ with a population of nanoparticles made according to Aspect 89.

Aspect 96. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, and the contacting being performed under conditions sufficient to give rise to mesoporous particles.

Aspect 97. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, the contacting being followed by washing with at least one salt and performed under conditions sufficient to give rise to mesoporous particles.

Aspect 98. A method, comprising: contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting performed while shaking and at a temperature of from about 50 to about 95° C., followed by washing with LiCl to give rise to mesoporous particles.

Aspect 99. A composition comprising mesoporous particles made according to any one of Aspects 96-98.

Aspect 100. A composition according to Aspect 99, further comprising a therapeutic.

Aspect 101. An electrode, the electrode comprising a composition according to Aspect 99.

Aspect 102. A device, the device comprising a composition according to Aspect 99.

Aspect 103. The device of Aspect 102, wherein the device is an energy storage device.

Aspect 104. A method, the method comprising operating the device of Aspect 102.

What is claimed:

1. A composition, comprising:
a plurality of metal oxide subnanofilaments and/or nanofilaments,
the subnanofilaments and/or nanofilaments optionally comprising a lepidocrocitic region,
the plurality of metal oxide subnanofilaments and/or nanofilaments optionally comprising an amount of carbon,
the plurality of metal oxide subnanofilaments and/or nanofilaments optionally being comprised in a bundle, in a flake, or in both a flake and a bundle.

2. The composition of claim 1, wherein at least some of the nanofilaments and/or subnanofilaments have a width in the range of from about 3 to about 50 Å.

3. The composition of claim 1, wherein the nanofilaments and/or subnanofilaments define a cross-sectional aspect ratio of from greater than 1 to about 10.

4. The composition of claim 1, wherein the nanofilaments and/or subnanofilaments have an average cross-sectional area in the range of from about 10 to about 100 Å².

5. The composition of claim 1, wherein at least some of the nanofilaments and/or subnanofilaments have a length in the range of from 1 nm to about 25 μm.

6. The composition of claim 1, further comprising a pharmaceutically acceptable carrier.

7. The composition of claim 1, further comprising a binder.

8. A device, the device comprising a composition according to claim 1.

9. The device of claim 8, wherein the device comprises an electrode.

10. The device of claim 8, wherein the device is characterized as an energy storage device.

11. A method, comprising:
contacting a mono-, binary, ternary, or higher carbide, nitride, boride, phosphide, aluminide, or silicide, or titanium metal with a quaternary ammonium salt and/or base,
the mono-, binary, ternary, or higher carbide, nitride, boride, phosphide, aluminide, or silicide, or titanium metal optionally being non-water-soluble,
the non-water soluble binary, or ternary, or higher carbide, nitride, boride, phosphide, aluminide, or silicide optionally comprising a transition metal, the transition metal optionally comprising titanium,
the contacting being performed under conditions sufficient to give rise to a nanofilamentous product.

12. The method of claim 11, wherein the conditions comprise a temperature of from 0 to 100° C. for from about 5 hours to about 1 week.

13. The method of claim 11, comprising contacting a binary, ternary, or higher boride with a quaternary ammonium salt and/or base so as to give rise to a nanofilamentous product.

14. The method of claim 11, wherein the binary boride comprises one or more titanium borides.

15. The method of claim 11, wherein the quaternary ammonium salt and/or base comprises an ammonium hydroxide, an ammonium halide, or any combination thereof.

16. The method of claim 15, wherein the ammonium hydroxide comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

17. The method of claim 15, wherein the quaternary ammonium salt comprises a quaternary ammonium chloride, a quaternary ammonium bromide, a quaternary ammonium iodide, a quaternary ammonium fluoride, or any combination thereof.

18. The method of claim 11, further comprising filtering the product.

19. The method of claim 11, further comprising washing the product with a metal salt and/or other water-soluble metal compounds.

20. A method, comprising:
contacting particulate TiO₂ with a quaternary ammonium salt and/or base,
the contacting being performed under conditions sufficient to give rise to a nanoparticulate product,
the nanoparticulate product optionally at least some nanoparticles having a diameter of from about 2 nm to about 1000 nm, optionally from about 10 to about 100 nm.

21. The method of claim 20, wherein the quaternary ammonium salt and/or base comprise an ammonium hydroxide, an ammonium halide, or any combination thereof.

22. The method of claim 21, wherein the quaternary ammonium base comprises tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof.

23. The method of claim 21, wherein the quaternary ammonium salt comprises a quaternary ammonium chloride, a quaternary ammonium bromide, a quaternary ammonium iodide, a quaternary ammonium fluoride, or any combination thereof together with a base.

24. A composition, comprising a population of nanoparticles made according to claim 21.

25. A method, comprising replacing TiO₂ with a population of nanoparticles made according to claim 24.
